(19) United States
(12) Patent Application Publication
(10) Pub. No.: US 2011/0238555 A1
(43) Pub. Date: Sep. 29, 2011

(54) METHOD AND SYSTEM FOR ELECTRONIC TRADING FROM SMART PHONES AND TABLET COMPUTERS

(75) Inventor: Leslie ROSENTHAL, Chicago, IL (US)

(73) Assignee: Rosenthal Collins Group, LLC, Chicago, IL (US)

(21) Appl. No.: 13/032,812

(22) Filed: Feb. 23, 2011

Related U.S. Application Data
(63) Continuation-in-part of application No. 11/180,330, filed on Jul. 12, 2005.
(60) Provisional application No. 60/587,243, filed on Jul. 12, 2004.

(51) Int. Cl. G06Q 40/00

(52) U.S. Cl. 705/37

(57) ABSTRACT

A method and system for electronic trading from smart phones and tablet computers. A selection input (e.g., a bar code, alphanumeric form, etc.) is received from a camera component on a smart network device application on the smart phone or tablet including one or more trading orders to execute one or more electronic trades. The one or more trading orders are extracted from the selection input on the smart network device application. The one or more electronic trades are automatically executed using one or more electronic trading orders extracted from the selection input from an Ask Bid Volume/Aggregated Book View (ABV) window with a dynamic price column.

### CROSS REFERENCES TO RELATED APPLICATIONS

This application is a Continuation-In-Part (CIP) of U.S. patent application Ser. No. 11/180,330 filed Jul. 12, 2005, that claims priority to U.S. Provisional Patent Application 60/587,243, filed Jul. 12, 2004, the contents of all of which are incorporated by reference.

### FIELD OF THE INVENTION

This invention relates to providing electronic information via a graphical user interface over a computer network. More specifically, it relates to a method and system for electronic trading from smart phones and tablet computers.

### BACKGROUND OF THE INVENTION

The trading of stocks, bonds and other financial instruments over computer networks such as the Internet has become a very common activity. In many countries of the world, such stocks, bonds and other financial instruments are traded exclusively over computer networks, completely replacing prior trading systems such as “open outcry” trading in trading pits.

Trading of stocks, bonds, etc. typically requires multiple types of associated electronic information. For example, to trade stocks electronically an electronic trader typically would like to know an asking price for a stock, a current bid price for a stock, a bid quantity, an asking quantity, current information about the company the trader is trading such as profit/loss information, a current corporate forecast, current corporate earnings, etc.

For an electronic trader to be successful, the multiple types of associated electronic information has to be supplied in real-time to allow the electronic trader to make the appropriate decisions. Such electronic information is typically displayed in multiple windows on a display screen.

There are however a number of problems with displaying information necessary for electronic trading. One problem is that current Graphical User Interfaces (GUI) are proprietary and do not implement functionality that allow them to be publicly interfaced to existing electronic trading systems.

Another problem is that some current GUIs do not allow a user to subscribe to and receive real-time market data or enter futures orders to all supported exchanges and receive real-time order status updates.

Another problem is that current GUIs do not provide for multiple methods of order entry (e.g., Order Ticket and Aggregated Book View (ABV)).

Another problem is that current GUIs do allow display of a current position in a list of trades in a selected market (e.g., commodities futures, currencies, financial instruments, options, etc.) after an electronic trade has been placed or amended.

Another problems is that current GUIs do not allow trading and display of electronic options.

There have been attempts to solve some of the problems with GUIs used for electronic trading. For example, U.S. Pat. No. 7,243,083, entitled “Electronic spread trading tool” that issued to Burns, et al. teaches “A versatile and efficient electronic spread trading tool to be used when buying and selling comparable commodities either simultaneously or in conjunction with one another. The spread trading tool involves a method of displaying, on an electronic display device, the market depth of a plurality of commodities including an anchor commodity and a non-anchor commodity, where the method includes dynamically displaying a plurality of bids and asks in the market for the commodities, statically displaying prices corresponding to those plurality of bids and asks, where the bids and asks are displayed in alignment with the prices corresponding thereto, displaying an anchor visual indicator corresponding to and in alignment with a desired price level of the anchor commodity, displaying a price level indicator corresponding to and in alignment with a price level of the non-anchor commodity. Based on an unhedged position, and taking into account the parameters and spread price point values, as determined by the trader, price level indicators are calculated and displayed, which provide a visual representation of where the trader should buy and sell the applicable commodities. The price level for the price level indicator in the non-anchor commodity is determined based upon said desired price level of the anchor commodity. The price level indicator also includes a first visual indicator corresponding to and in alignment with a first price level of the non-anchor commodity and a second visual indicator corresponding to and in alignment with a second price level of the non-anchor commodity.”

U.S. Pat. No. 7,228,289, entitled “System and method for trading and displaying market information in an electronic trading environment,” that issued to Brumfield, et al. teaches “A system and method for trading and displaying market information along a static axis are described to ensure fast and accurate execution of trades. The static axis, whether is a straight axis or a curved one, can be oriented in any direction. Regardless of how the axis is oriented, a first region may display price levels that are arranged along the static axis. A second region, which overlaps the first region, may display one or more indicators for highlighting one of the price levels associated with the lowest offer and one of the price levels associated with the highest bid. Moreover, a third region, which overlaps the first region, may be included for initiating placement of an order to buy or an order to sell the tradeable object through an action of a user input device. Other overlapping regions may also be displayed so that additional market information may be viewed by a trader.

U.S. Pat. No. 7,218,325, entitled “Graphical display with integrated recent period zoom and historical period context data,” that issued to Buck teaches “A system and method are provided for displaying a data series. In one embodiment, a graphical interface is provided including at least one axis that is divided into a plurality of axis regions. Preferably, each axis region uses a different linear scale, and the plurality of axis regions forms a continuous non-linear scale. The graphical interface also displays the data series in relation to the plurality of axis regions, and the data series is plotted in relation to each axis region based on a scale resolution corresponding to each respective axis region.”

U.S. Pat. No. 7,212,999, entitled “User interface for an electronic trading system,” that issued to Friesen, et al. teaches “A user interface for an electronic trading exchange is provided which allows a remote trader to view in real time bid orders, offer orders, and trades for an item, and optionally one or more sources of contextual data. Individual traders place orders on remote client terminals, and this information is routed to a transaction server. The transaction server receives order information from the remote terminals, matches a bid for an item to an offer for an item responsive to the bid corresponding with the offer, and communicates outstanding bid and offer information, and additional information (such as trades and contextual data) back to the client terminals. Each client terminal displays all of the outstanding bids and offers for an item, allowing the trader to view trends in orders for an item. A priority view is provided in which orders are displayed as tokens at locations corresponding to the values of the orders. The size of the tokens reflects the quantity of the orders. An alternate view positions order icons at a location which reflects the value and quantity of the order. Additionally, contextual data for the item is also displayed to allow the trader to consider as much information as possible while making transaction decisions. A pit panel view is also provided in which traders connected to the pit are represented by icons, and are displayed corresponding to an activity level of the trader.”

U.S. Pat. No. 7,127,424, entitled “Click based trading with intuitive grid display of market depth and price consolidation” that issued to Kemp II, et al. teaches “A method and system for reducing the time it takes for a trader to place a trade when electronically trading on an exchange, thus increasing the likelihood that the trader will have orders filled at desirable prices and quantities. The “Mercury” display and trading method of the present invention ensure fast and accurate execution of trades by displaying market depth on a vertical or horizontal plane, which fluctuates logically up or down, left or right across the plane as the market prices fluctuate. This allows the trader to trade quickly and efficiently. The price consolidation feature of the present invention, as described herein, enables a trader to consolidate a number of prices in order to condense the display. Such action allows a trader to view a greater range of prices and a greater number of orders in the market at any given time. By consolidating prices, and therefore orders, a trader reduces the risk of a favorable order scrolling from the screen prior to filling a bid or ask on that order at a favorable price.”

U.S. Pat. No. 7,124,110, entitled “Method and apparatus for message flow and transaction queue management,” that issued to Kemp II, et al. teaches “Management of transaction message flow utilizing a transaction message queue. The system and method are for use in financial transaction messaging systems. The system is designed to enable an administrator to monitor, distribute, control and receive alerts on the use and status of limited network and exchange resources. Users are grouped in a hierarchical manner, preferably including user level and group level, as well as possible additional levels such as account, tradable object, membership, and gateway levels. The message thresholds may be specified for each level to ensure that transmission of a given transaction does not exceed the number of messages permitted for the user, group, account, etc.”

U.S. Pat. No. 7,113,924, entitled “System and method for electronic spread trading in real and synthetically generated markets” that issued to Fishbain teaches “A system and method are provided to analyze synthetic and real markets that offer interchangeable tradeable objects to find market opportunities that a trader may capitalize on. A synthetic market is an electronic market created out of real markets by a computer terminal or gateway. A real market is an electronic market that is offered by an electronic exchange. If a desirable market opportunity is found, the preferred embodiments can take action such as by sending orders to either one of the markets, or by sending orders to both markets. An advantage of the preferred embodiments, among many others, is that they can make “invisible” trading opportunities more readily apparent.”

U.S. Pat. No. 6,993,504, entitled “User interface for semi-fungible trading,” that issued to Friesen, et al. teaches “A user interface and method are disclosed for providing trading between a plurality of semi-fungible and non-fungible goods. A plurality of book axes are displayed in a single interface, each book axis representing a market for a particular good. Orders for goods are displayed as marks on the axes to display the relative value of the orders. A value axis is provided that relates the value of the goods from each market to each other. Thus, a single interface provides the means to relate the values of different semi-fungible goods. The value axis may be displayed in units of price, or a custom value designated by a user or pre-defined by the interface. Quantity information is represented in the interface through the display of a dimension of an order icon. Precise information about each order is displayed either in a panel view or a pop-up window.”

U.S. Pat. No. 6,938,01, entitled “Click based trading with market depth display” that issued to Kemp II, et al. teaches “A method and system for reducing the time it takes for a trader to place a trade when electronically trading commodities on an exchange, thus increasing the likelihood that the trader will have orders filled at desirable prices and quantities. Click based trading, as described herein and specifically the “Click” and “Dime” methods of the present invention, enables a trader to execute single mouse click trades for large volumes of commodities at a price within a pre-specified range.”

U.S. Pat. No. 6,772,132, entitled “Click based trading with intuitive grid display of market depth” that issued to Kemp et al. teaches “A method and system for reducing the time it takes for a trader to place a trade when electronically trading on an exchange, thus increasing the likelihood that the trader will have orders filled at desirable prices and quantities. The “Mercury” display and trading method of the present invention ensure fast and accurate execution of trades by displaying market depth on a vertical or horizontal plane, which fluctuates logically up or down, left or right across the plane as the market prices fluctuates. This allows the trader to trade quickly and efficiently.”

U.S. Pat. No. 6,766,304, entitled “Click based trading with intuitive grid display of market depth” that issued to Kemp et al. teaches “A method and system for reducing the time it takes for a trader to place a trade when electronically trading on an exchange, thus increasing the likelihood that the trader will have orders filled at desirable prices and quantities. The “Mercury” display and trading method of the present invention ensure fast and accurate execution of trades by displaying market depth on a vertical or horizontal plane, which fluctuates logically up or down, left or right across the plane as the market prices fluctuates. This allows the trader to trade quickly and efficiently.”

U.S. Pat. No. 6,408,282, entitled “System and method for conducting securities transactions over a computer network” that issued to Buist teaches “The system and method of the preferred embodiment supports trading of securities over the Internet both on national exchanges and outside the national exchanges. The preferred embodiment supports an improved human interface and a continuous display of real-time stock quotes on the user's computer screen. The ergonomic graphical user interface (GUI) of the preferred embodiment includes several functional benefits in comparison with existing on-line consumer trading systems. In the preferred embodiment, the users are subscribers to a securities trading service offered over the Internet. Preferably, each subscriber to this service is simultaneously connected from his own computer to a first system which provides user-to-user trading capabilities and to a second system which is a broker/dealer system of his/her choice. The system providing the user-to-user trading services preferably includes a root server and a hierarchical network of replicated servers supporting replicated databases. The user-to-user system provides real-time continuously updated stock information and facilitates user-to-user trades that have been approved by the broker/dealer systems with which it interacts. Users of the preferred system can trade securities with other users of the system. As part of this user-to-user trading, a user can accept a buy or sell offer at the terms offered or he can initiate a counteroffer and negotiate a trade.”

U.S. Pat. No. 5,297,031, entitled “Method and apparatus for order management by market brokers” that issued to Gutterman et al. teaches “There is provided a broker workstation for managing orders in a market for trading commodities, securities, securities options, futures contracts and futures options and other items including: a device for selectively displaying order information; a computer for receiving the orders and for controlling the displaying device; and a device for entering the orders into the computer; wherein the displaying device comprises a device for displaying selected order information about each incoming order, a device for displaying a representation of an order deck and a device for displaying a total of market orders. In another aspect of the invention, there is provided in a workstation having a computer, a device for entering order information into the computer and a device for displaying the order information entered, a method for managing orders in a market for trading commodities, securities, securities options, futures contracts and futures options and the like comprising the steps of: selectively displaying order information incoming to the workstation; accepting or rejecting orders corresponding to the incoming order information displayed; displaying accepted order information in a representation of a broker deck; and selectively displaying a total of orders at the market price.”

U.S. Published Patent Application US20020035534, entitled “Method and apparatus for auctioning securities,” that was published by Buist, et al. teaches “ The present invention is a system and method for conducting an on-line auction of securities. A preferred method of auctioning a security comprises the steps of: transmitting to a plurality of potential bidders information identifying the security, a price range having a maximum price and a minimum price, and a time for the auction; receiving from each bidder an offer price for a number of units of the security; transmitting to bidders information concerning the bids that are received; closing the auction either when offers are received for all units of the security at the maximum price or when a predetermined time has elapsed; and upon closing the auction, allocating units of the security so that all bids at a price in excess of the closing price are filled and all bids at the closing price or less are filled on a first-come, first-served basis.”

However, none of these attempts solves all of the problems associated with GUIs used for trading electronic options. Thus, it is desirable to solve some of the problems associated with problems associated with GUIs that provide electronic information for electronic options trading systems.

### SUMMARY OF THE INVENTION

In accordance with preferred embodiments of the present invention, some of the problems associated with GUIs that provide electronic information for electronic trading systems. A method and system for electronic trading from smart phones and tablet computers is presented.

The method and system for electronic trading from smart phones and tablet computers. A selection input (e.g., a bar code, alphanumeric form, etc.) is received from a camera component on a smart network device application on the smart phone or tablet including one or more trading orders to execute one or more electronic trades. The one or more trading orders are extracted from the selection input on the smart network device application. The one or more electronic trades are automatically executed using one or more electronic trading orders extracted from the selection input from an Ask Bid Volume/Aggregated Book View (ABV) window with a dynamic price column.

The foregoing and other features and advantages of preferred embodiments of the present invention are more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram illustrating an exemplary electronic trading system;

FIG. 2 is a block diagram illustrating an exemplary electronic trading display system;

FIG. 3 is a flow diagram illustrating a method for displaying electronic information for electronic trading;

FIG. 4 is a block diagram of a screen shot of an exemplary tools window;

FIG. 5 is a block diagram of a screen shot of an exemplary settings window;

FIG. 6 is a block diagram of a screen shot of an exemplary quotes and contracts window;

FIG. 7 is a block diagram of a screen shot of an exemplary order window;

FIG. 8 is a block diagram of a screen shot of an exemplary fill window;

FIG. 9 is a block diagram of a screen shot of an exemplary position and market data window;

FIG. 10 is a block diagram of a screen shot of an exemplary position and market data window for an order ticket from a sell position;

FIG. 11 is a block diagram of a screen shot of an exemplary position and market data window for a stop order;

FIG. 12 is a block diagram of a screen shot of an exemplary ABV window;

FIG. 13 is a block diagram of screen shot of an exemplary order ticket window;

FIG. 14 is a block diagram of a screen shot of an exemplary reports window;

FIG. 15 is a flow diagram illustrating a method for electronic trading; and

FIG. 16 is a flow diagram illustrating a method for display of an estimated market depth execution position;

FIG. 17 is a flow diagram illustrating a method for display of an estimated market depth execution position;

FIGS. 18A and 18B are a flow diagram illustrating a method for display of an estimated market depth execution position;

FIGS. 19A and 19B are a flow diagram illustrating a method for trading electronic options via graphical user interface;

FIG. 20 is a block diagram of a screen shot of an exemplary ABV window used to trade electronic options with a dynamic option strike price column;

FIG. 21 is a block diagram of a screen shot of an exemplary ABV window used to trade electronic options with a dynamic option strike price column and additional option Greek display information;

FIG. 22 is a block diagram of a screen shot of an exemplary ABV window used to trade electronic options with a dynamic delta column;

FIG. 23 is a block diagram of a screen shot of electronic option chain information in an exemplary graphical window;

FIG. 24 is a block diagram of a screen shot of electronic option Greek chain information in an exemplary graphical window;

FIG. 25 is a block diagram of screen shot of an exemplary order ticket window including electronic option order input information;

FIG. 26 is a block diagram illustrating an ABV window displayed on smart phone;

FIG. 27 is a block diagram illustrating an ABV window with options information displayed on a tablet computer;

FIG. 28 is a block diagram illustrating exemplary bar codes;

FIG. 29 is a block diagram illustrating display of an exemplary QR bar code on a display component;

FIG. 30 is a block diagram illustrating an exemplary alphanumeric trade layout; and

FIGS. 31A and 31B are a flow diagram illustrating a method for electronic trading via graphical user interface on a smart phone and/or tablet computer.

### DETAILED DESCRIPTION OF THE INVENTION

### Exemplary Electronic Trading System

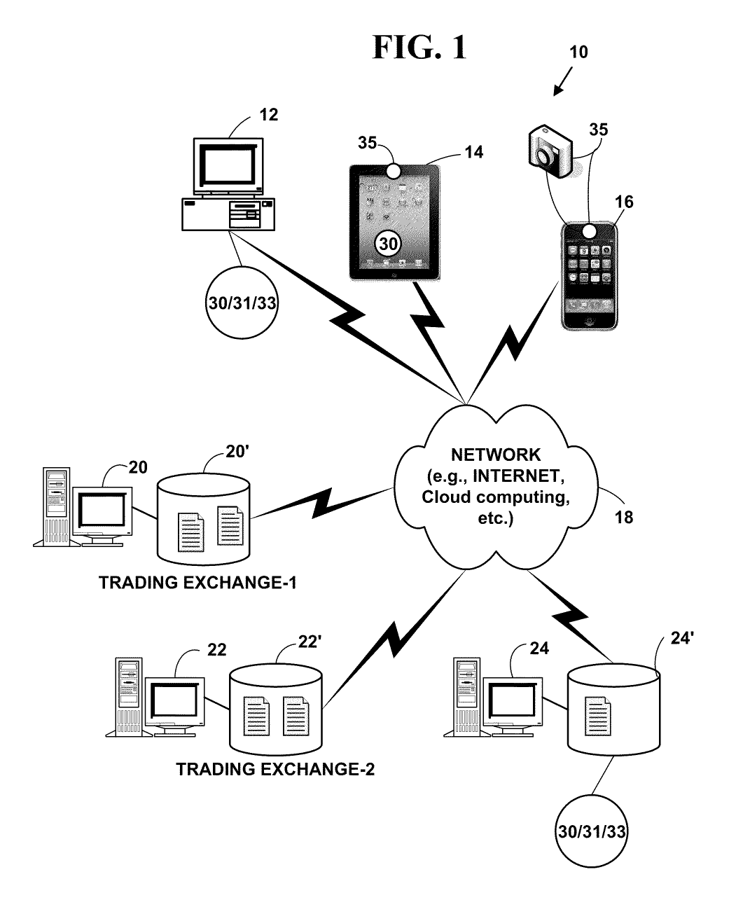

FIG. 1 is a block diagram illustrating an exemplary electronic trading system 10. The exemplary electronic information updating system 10 includes, but is not limited to, one or more target devices 12, 14, 16 (only three of which are illustrated). However, the present invention is not limited to these target electronic devices and more, fewer or others types of target electronic devices can also be used.

The target devices 12, 14, 16 are in communications with a communications network 18. The communications includes, but is not limited to, communications over a wire connected to the target network devices, wireless communications, and other types of communications using one or more communications and/or networking protocols.

Plural server devices 20, 22, 24 (only three of which are illustrated) include one or more associated databases 20′, 22′, 24′. The plural network devices 20, 22, 24 are in communications with the one or more target devices 12, 14, 16 via the communications network 18. The plural server devices 20, 22, 24, include, but are not limited to, World Wide Web servers, Internet servers, file servers, other types of electronic information servers, and other types of server network devices (e.g., edge servers, firewalls, routers, gateways, etc.).

The plural server devices 20, 22, 24 include, but are not limited to, servers used for electronic trading exchanges, servers for electronic trading brokers, servers for electronic trading information providers, etc.

The one or more target devices 12, 14, 16 may be replaced with other types of devices including, but not limited to, client terminals in communications with one or more servers, or with personal digital/data assistants (PDA), laptop computers, mobile computers, Internet appliances, two-way pagers, mobile phones, or other similar desktop, mobile or hand-held electronic devices. Other or equivalent devices can also be used to practice the invention.

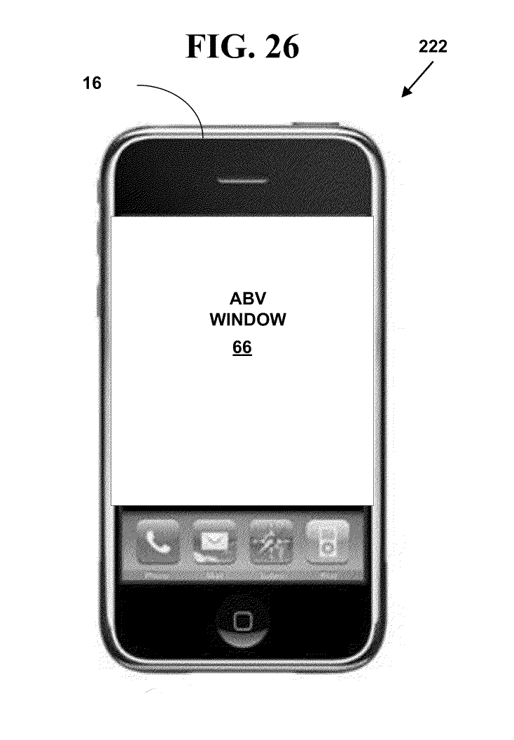

The one or more smart network devices 12, 14, 16 also include smart phones such as the iPhone by Apple, Inc., Blackberry Storm and other Blackberry models by Research In Motion, Inc. (RIM), Droid by Motorola, Inc. HTC, Inc. other types of smart phones, other types of mobile and non-mobile phones, etc. The Apple iPhone 16 is illustrated in FIGS. 1 and 26. However, the present invention is not limited to such devices, and more, fewer or other devices can be used to practice the invention.

A “smart phone” is a mobile phone that offers more advanced computing ability and connectivity than a contemporary basic feature phone. Smart phones and feature phones may be thought of as handheld computers integrated with a mobile telephone, but while most feature phones are able to run applications based on platforms such as Java ME, a smart phone usually allows the user to install and run more advanced applications. Smart phones and/or tablet computers run complete operating system software providing a platform for application developers.

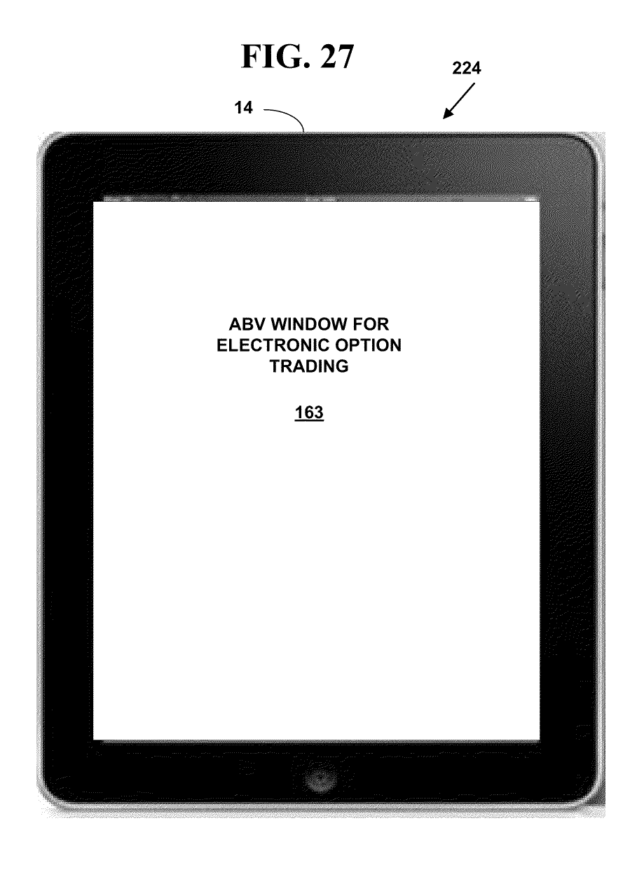

The operating systems include the iPhone OS, Android, Windows, etc. iPhone OS is a proprietary operating system for the Apple iPhone. Andriod is an open source operating system platform backed by Google, along with major hardware and software developers (such as Intel, HTC, ARM, Motorola and Samsung, etc.), that form the Open Handset Alliance. The Apple iPad 14 is illustrated in FIGS. 1 and 27.

The one or more smart network devices 12, 14, 16 also include tablet computers 16 such as the iPad, by Apple, Inc., the HP Tablet, by Hewlett Packard, Inc., the Playbook, by RIM, Inc., the Tablet, by Sony, Inc.

The communications network 18 includes, but is not limited to, the Internet, an intranet, a wired Local Area Network (LAN), a wireless LAN (WiLAN), a Wide Area Network (WAN), a Metropolitan Area Network (MAN), a Public Switched Telephone Network (PSTN) and other types of communications networks 18.

In one embodiment, the plural server network devices 20, 22, 24 include a connection to plural network interface cards (NICs) in a backplane connected to a communications bus. The NIC cards provide gigabit/second (1×10⁹ bits/second) communications speed of electronic trading information. This allows “scaling out” for electronic trading. The NICs are connected to the plural server network devices 20, 22, 24 and the communications network 18. However, the present invention is not limited to the NICs described and other types of NICs in other configurations and connections with or without a buse can also be used to practice the invention.

In one embodiment, devices and interfaces including the NICs include “4G” components. As is known in the art “4G” refers to the fourth generation of wireless communications standards. It is a successor to 3G and 2G standards. The nomenclature of the generations generally refers to a change in the fundamental nature of the service. The first was the move from analogue (1G) to digital (2G) transmission. This was followed by multi-media support, spread spectrum transmission and at least 200 kbits/second (3G). The 4G NICs include IP packet-switched NICs, wired and wireless ultra-broadband (i.e., gigabit speed) access NICs, Worldwide Interoperability for Microwave Access (WiMAX) NICs and multi-carrier transmission NICs. However, the present invention is not limited to this embodiment and 1G, 2G and 3G and/or any combination thereof, with or with 4G NICs can be used to practice the invention.

As is known in the art, WiMAX is an industry trade organization formed by leading communications component and equipment companies to promote and certify compatibility and interoperability of broadband wireless access equipment that conforms to the IEEE 802.16XX and ETSI HIPERMAN. HIPERMAN is the European standard for metropolitan area networks (MAN).

The IEEE The 802.16a and 802.16g standards are wireless MAN technology standard that provides a wireless alternative to cable, DSL and T1/E1 for last mile broadband access. It is also used as complimentary technology to connect IEEE 802.11XX hot spots to the Internet or other communications networks.

The IEEE 802.16a standard for 2-11 GHz is a wireless MAN technology that provides broadband wireless connectivity to fixed, portable and nomadic devices. It provides up to 50-kilometers of service area range, allows users to get broadband connectivity without needing direct line of sight with the base station, and provides total data rates of up to 280 Mbps per base station, which is enough bandwidth to simultaneously support hundreds of businesses with T1/E1-type connectivity and thousands of homes with DSL-type connectivity with a single base station. The IEEE 802.16g provides up to 100 Mbps.

The IEEE 802.16e standard is an extension to the approved IEEE 802.16/16a/16g standard. The purpose of 802.16e is to add limited mobility to the current standard which is designed for fixed operation.

The ESTI HIPERMAN standard is an interoperable broadband fixed wireless access standard for systems operating at radio frequencies between 2 GHz and 11 GHz.

The IEEE 802.16a, 802.16e and 802.16g standards are incorporated herein by reference. More information on WiMAX can be found at the URL “www.wimaxforum.org.” WiMAX can be used to provide a WLP.

The ETSI HIPERMAN standards TR 101 031, TR 101 475, TR 101 493-1 through TR 101 493-3, TR 101 761-1 through TR 101 761-4, TR 101 762, TR 101 763-1 through TR 101 763-3 and TR 101 957 are incorporated herein by reference. More information on ETSI standards can be found at the URL “www.etsi.org.” ETSI HIPERMAN can be used to provide a WLP.

In one specific exemplary embodiment, the communications network 18 includes a Microsoft® .NET framework. The .NET Framework and .NET Compact Framework offer a rich library of object classes that allow developers to create scalable applications both implicitly and explicitly. The .NET Framework also offers object classes that access, for example, Microsoft® Message Queuing (MSMQ) messaging services. The .NET Framework also allows building of desktop and Web applications and applications for handheld devices using the .NET Compact Framework or for cell mobile devices using the Mobile Internet Toolkit. However, the present invention is not limited to this embodiment and other scaling out frameworks can also be used to practice the invention.

In one embodiment, the communications network 18 includes a cloud computing network. A “cloud computing” is a model for enabling, on-demand network access to a shared pool of configurable computing resources (e.g., public and private networks, servers, storage, applications, and services) that are shared, rapidly provisioned and released with minimal management effort or service provider interaction.

Exemplary cloud computing essential characteristics appear in Table A. However, the present invention is not limited to these essential characteristics and more, fewer or other characteristics can also be used to practice the invention.

TABLE A
On-demand self-service. An electronic trader can unilaterally provision
computing capabilities, such as server time and network storage, as needed
automatically without requiring human interaction with each trading
exchange, broker, etc.
Broad network access. Electronic trading capabilities are available over a
communications network and accessed through standard mechanisms that
promote use by heterogeneous thin or thick client platforms (e.g., mobile
phones, smart phones, laptops, PDAs, etc.). The broad network access
includes high speed network access such as 4G wireless and broadband
network access.
Resource pooling. The brokers, trading exchanges, etc. computing
resources are pooled to serve multiple electronic traders using a multi-
tenant model, with different physical and virtual resources dynamically
assigned and reassigned according to trader demand. There is a sense of
location independence in that the electronic trader generally has no
control or knowledge over the exact location of the provided trading
resources but may be able to specify location at a higher level of
abstraction (e.g., country, state, or datacenter). Examples of pooled
resources include storage, processing, memory, network bandwidth, and
virtual machines.
Rapid elasticity. Capabilities can be rapidly and elastically provisioned,
in some cases automatically, to quickly scale out and rapidly released to
quickly scale in. To the electronic trader, the trading capabilities available
for provisioning often appear to be unlimited and can be used in any
quantity at any time.
Measured Service. Cloud computing systems automatically control and
optimize resource use by leveraging a metering capability at some level of
abstraction appropriate to the type of trading service (e.g., storage,
processing, bandwidth, active electronic trading accounts, etc.). Trading
resource usage can be monitored, controlled, and reported providing
transparency for both the provider and electronic trader of the utilized
electronic trading service.

Exemplary cloud computing service models appear in Table B. However, the present invention is not limited to these service models and more, fewer or other service models can also be used to practice the invention.

TABLE B
Cloud Computing Software Applications for an Electronic Trading Service
(SaaTS). The capability provided to the electronic trader is to use the
provider's applications running on a cloud infrastructure. The cloud
computing trading applications 30 are accessible from various client
devices 12, 14, 16 through a thin client interface such as a web browser,
etc.. The electronic trader does not manage or control the underlying
cloud infrastructure 18 including network, servers, operating systems,
storage, or even individual application capabilities, with the possible
exception of limited user-specific application configuration settings.
Cloud Computing Platform for the Electronic Trading Service (PaaTS))
The capability provided to the electronic trader is to deploy onto the cloud
infrastructure 18 electronic trader-created or acquired applications created
using programming languages and tools supported by the broker, trading
exchange, etc.. The electronic trader does not manage or control the
underlying cloud infrastructure including network, servers, operating
systems, or storage, but has control over the deployed applications and
possibly application hosting environment configurations.
Cloud Computing Infrastructure for the Electronic Trading Service
(IaaTS)) 1. The capability provided to the electronic trader is to provision
processing, storage, networks, and other fundamental computing
resources where the consumer is able to deploy and run arbitrary software,
which can include operating systems and applications. The electronic
trader does not manage or control the underlying cloud infrastructure 18
but has control over operating systems, storage, deployed applications,
and possibly limited control of select networking components (e.g.,
host firewalls, etc.).

Exemplary cloud computing deployment models appear in Table C. However, the present invention is not limited to these deployment models and more, fewer or other deployment models can also be used to practice the invention.

TABLE C
Private cloud network. The cloud network infrastructure is operated solely
for a trading organization. It may be managed by the trading organization
or a third party and may exist on premise or off premise (e.g., electronic
trading exchanges, brokers, etc.)
Community cloud network. The cloud network infrastructure is shared by
several trading organizations and supports a specific community that
has shared concerns (e.g., mission, security requirements, policy,
compliance considerations, etc.). It may be managed by the trading
organizations or a third party and may exist on premise or off premise.
Public cloud network. The cloud network infrastructure such as the
Internet is made available to the general public or a large industry
group (i.e., electronic trading exchanges, brokers, etc.) and is owned
by an organization selling cloud services.
Hybrid cloud network. The cloud network infrastructure is a composition
of two or more clouds (private, community and/or public) that remain
unique entities but are bound together by standardized or proprietary
technology that enables data and application portability (e.g., cloud
bursting for load-balancing between clouds, etc.)

Cloud software for electronic trading takes full advantage of the cloud paradigm by being service oriented with a focus on statelessness, low coupling, modularity, and semantic interoperability for electronic trading.

This exemplary cloud computing model for electronic trading promotes availability or shared resources for electronic trading and comprises: (1) cloud computing essential characteristics; (2) cloud computing service models; and (3) cloud computing deployment models. However, the present invention is not limited to this cloud computing model and other cloud computing models can also be used to practice the invention.

Cloud software for electronic trading takes full advantage of the cloud paradigm by being service oriented with a focus on statelessness, low coupling, modularity, and semantic interoperability for electronic trading. In one embodiment, devices and interfaces in the cloud computing network include “4G” components.

The communications network 18 may include one or more gateways, routers, bridges, switches. As is known in the art, a gateway connects computer networks using different network protocols and/or operating at different transmission capacities. A router receives transmitted messages and forwards them to their correct destinations over the most efficient available route. A bridge is a device that connects networks using the same communications protocols so that information can be passed from one network device to another. A switch is a device that filters and forwards packets between network segments. Switches typically operate at the data link layer and sometimes the network layer therefore support virtually any packet protocol.

The communications network 18 may include one or more servers and one or more web-sites accessible by users to send and receive information useable by the one or more computers 12. The one or more servers, may also include one or more associated databases for storing electronic information.

The communications network 18 includes, but is not limited to, data networks using the Transmission Control Protocol (TCP), User Datagram Protocol (UDP), Internet Protocol (IP) and other data protocols.

As is know in the art, TCP provides a connection-oriented, end-to-end reliable protocol designed to fit into a layered hierarchy of protocols which support multi-network applications. TCP provides for reliable inter-process communication between pairs of processes in network devices attached to distinct but interconnected networks. For more information on TCP see Internet Engineering Task Force (ITEF) Request For Comments (RFC)-793, the contents of which are incorporated herein by reference.

As is known in the art, UDP provides a connectionless mode of communications with datagrams in an interconnected set of computer networks. UDP provides a transaction oriented datagram protocol, where delivery and duplicate packet protection are not guaranteed. For more information on UDP see IETF RFC-768, the contents of which incorporated herein by reference.

As is known in the art, IP is an addressing protocol designed to route traffic within a network or between networks. IP is described in IETF Request For Comments (RFC)-791, the contents of which are incorporated herein by reference. However, more fewer or other protocols can also be used on the communications network 18 and the present invention is not limited to TCP/UDP/IP.

### Exemplary Electronic Trading Display System

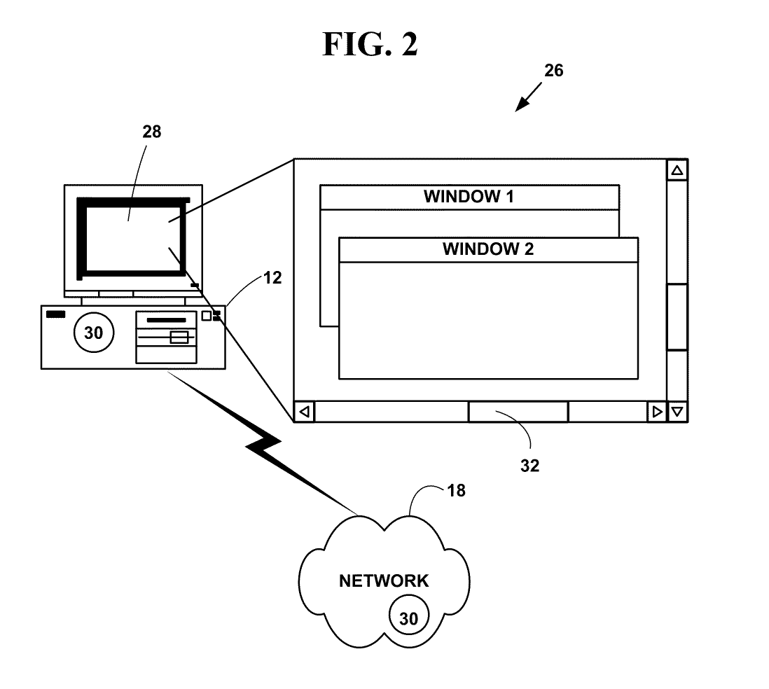

FIG. 2 is a block diagram illustrating an exemplary electronic trading display system 26. The exemplary electronic trading system display system includes, but is not limited to a target device (e.g., 12) with a display 28. The target device includes a trading application 30 that presents a graphical user interface (GUI) 32 on the display 28. The GUI 32 presents a multi-window interface to a user. In one embodiment, the trading application 30 is used to trade electronic options.

In one embodiment of the invention, the application 30 is a software application. However, the present invention is not limited to this embodiment and the application 30 can firmware, hardware or a combination thereof.

In one embodiment of the invention, the application 30 is an application for a smart phone. A smart network device application includes interactions with an operating system on a smart phone. The interactions are typically completed through an Application Programming Interface (API).

An operating environment for the devices of the electronic trading system 10 and electronic trading display system 26 include a processing system with one or more high speed Central Processing Unit(s) (“CPU”), processors and one or more memories. In accordance with the practices of persons skilled in the art of computer programming, the present invention is described below with reference to acts and symbolic representations of operations or instructions that are performed by the processing system, unless indicated otherwise. Such acts and operations or instructions are referred to as being “computer-executed,” “CPU-executed,” or “processor-executed.”

It is appreciated that acts and symbolically represented operations or instructions include the manipulation of electrical information by the CPU or processor. An electrical system represents data bits which cause a resulting transformation or reduction of the electrical information, and the maintenance of data bits at memory locations in a memory system to thereby reconfigure or otherwise alter the CPU's or processor's operation, as well as other processing of information. The memory locations where data bits are maintained are physical locations that have particular electrical, magnetic, optical, or organic properties corresponding to the data bits.

The data bits may also be maintained on a computer readable medium including magnetic disks, optical disks, organic memory, and any other volatile (e.g., Random Access Memory (“RAM”)) or non-volatile (e.g., Read-Only Memory (“ROM”), flash memory, etc.) mass storage system readable by the CPU. The computer readable medium includes cooperating or interconnected computer readable medium, which exist exclusively on the processing system or can be distributed among multiple interconnected processing systems that may be local or remote to the processing system.

### Exemplary Method for Processing Electronic Information for Electronic Trading

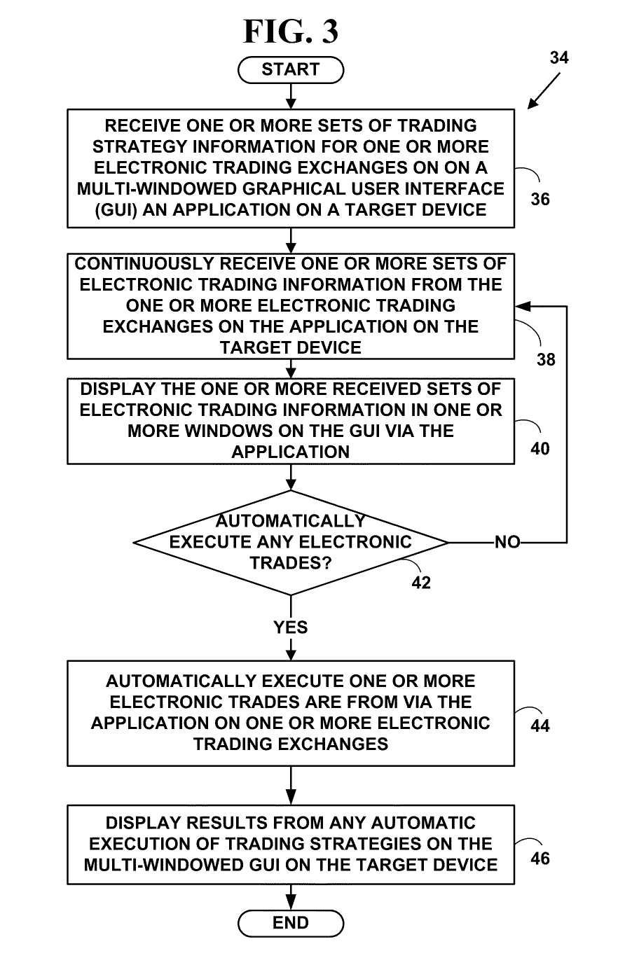

FIG. 3 is a flow diagram illustrating a Method 34 for processing electronic information for electronic trading. At Step 36, one or more sets of electronic trading strategy information is obtained via one or more windows on a application 30 on a target device 12, 14, 16 to automatically execute one or more electronic trades on one or more electronic trading exchanges 20, 22. At Step 38, one or more sets of electronic trading information are continuously received on the application 30 via one or more application program interfaces (API), fixed or dynamic connections from one or more electronic trading exchanges 20, 22. At Step 40, the one or more sets of electronic trading information are displayed in one or more windows on the GUI 32 via application 30. At Step 42, a test is conducted to determine if any electronic trades should be automatically executed based on the one or more sets of electronic trading strategy information. If any electronic trades should be automatically executed, at Step 44, one or more electronic trades are automatically electronically executed via application 30 an appropriate electronic trading exchange 20, 22. At Step 45, results from any automatic execution of any electronic trade are formatted and displayed in one more windows on a multi- windowed graphical user interface (GUI) 32.

In one embodiment the one or more sets of electronic trading strategy includes a pre-determined trading strategy created by a trader, if-then trading strategies, one-cancels-other (OCO) trading strategies and electronic trading strategies for real or synthetic instruments and/or real or synthetic contracts, or execution of strategies based on previously executed orders.

As is known in the art, the pre-determined strategy trading strategy is a pre-determined trading strategy developed by a trader to apply to a desired market (e.g., cash, futures, stocks, bonds, options, spreads, exchange traded funds, etc.)

As is known in the art, a “synthetic” instrument or contract includes an instrument or contract that does not really exist on any electronic trading exchange. A synthetic can be made up of one, or several contracts that trade on an exchange or multiple exchanges. For example, a synthetic contract may include automatically selling a call and buying a put. Such a synthetic contract does not exist on any trading exchange but is desirable to a selected group of traders.

As is known in the art, an API is set of routines used by an application program to direct the performance of actions by a target device. In the present invention, the application 30 is interfaced to one or more API.

In another embodiment, the application 30 is directly interfaced to a fixed or dynamic connection to one or more electronic trading exchanges without using an API.

In one exemplary embodiment of the invention, the application 30 interfaces with a Client API provided by Professional Automated Trading Systems (PATS) of London, England, or Trading Technologies, Inc. (TT) of Chicago, Ill. GL Multi-media of Paris, France, the Rosenthal Collins Group, LLC (RCG) of Chicago, Ill. and others. These APIs are intermediate APIs between the Application and other APIs provided by electronic trading exchanges. However, the present invention is not limited to such an embodiment and other APIs and other fixed or dynamic connections can also be used to practice the invention.

The application 30 presents a user a multi-windowed GUI 32 that implements the functionality exposed through API provided by electronic trading exchanges. The application 30 allows the user to subscribe to and receive real-time market data. Additionally, the application 30 allows the user to enter futures orders, cash orders, and other types of financial products orders to all supported exchanges and receive real-time order status updates. The application 30 supports at least two methods of order entry; Order Ticket and Aggregated Book View/Ask Bid Volume (ABV).

The application 30 provides flexibility to the user to configure the display of electronic information on the GUI 32. The application 30 and the GUI are now described in further detail.

### Desktop Layout Management

The application 30 provides the ability to manage Desktop Layouts. A Desktop Layout is a state of a GUI 32 as it appears to a user. This includes, but is not limited to, number of windows, types of windows, and the individual window settings. A user is able maintain a list of available Desktop Layouts. Each Desktop Layout has a unique name within the application 30. The user is able to create a new Desktop Layout and save it, giving it a unique name. When the user saves a Desktop Layout, it is not saved in a minimized state but is instead saved in an expanded state. The user is able to rename, copy, and delete a Desktop Layout. The user is able to load a saved desktop layout, replacing the currently displayed configuration. The application 30 receives and loads desktop layout templates from the communications network 18 upon user login. The user is able to export and import desktop layouts in order to port them from target device to target device. Desktop Layouts are saved on a user by user basis (e.g., by username). If two users access the application 30 from the same target device 12, each user sees their own list of layouts upon login.

The application 30 is launched from target device 12, 14, 16 or via the network 18 (e.g., the Internet, an intranet, etc.) The application 30 is installed on a target device 12, 14, 16 or the communications network 18. Upon startup, the application 30 detects if a new version is available. If the application 30 detects that an upgrade is warranted, a window appears, asking the user if they would like to install the latest version now. In one embodiment, if the user chooses not to install the latest version upon startup, the current (older) version of the application 30 is launched. In another embodiment, another prompt is displayed when the user logs off. In the case of a critical update, the user is not able to choose to run the application 30 without installing the update.

The application 30 is pushed information that determines which servers the application 30 is to connect to. IP addresses or Domain Name Servers (DNS) names are pushed to the client when upon login.

In one embodiment, the application 30 can be used by up to about 5,000 simultaneous users. Scalability allows the application 30 to be used by up to about 20,000 simultaneous users. However, the present invention is not limited to such an embodiment and other embodiments with other numbers of simultaneous users can also be used to practice the invention.

The application 30 indicates the status of a host connection 20, 22, 24 on the communications network 18. As a minimum, “Connecting,” “Connected” and “Not Connected” statuses are indicated. The application 30 indicates the status of an electronic trading exchange server connection 20, 22. As a minimum, “Connecting,” “Connected” and “Not Connected” statuses are indicated for the electronic trading exchange server connection.

If settings (e.g., accounts, contracts, etc.) change on a host system 20, 22, 24, the application 30 updates the settings. The user does not have to log back in to see the changes. The application 30 has the ability to detect if any changes to accounts or contracts have been made. The application 30 is able to detect when a system administrator has changed a network address (e.g., an Internet Protocol (IP) address, etc.) of the primary transaction server for a client.

The application 30 can log off of one network address and log onto another. Data integrity is maintained when a network address change has been made. The application 30 notifies the user of any working orders or open positions before closing. The user has the opportunity to cancel the logout if they would like to cancel working orders or close the open positions. The application 30 performs the normal logoff cycle when closed by the user. The application 30 saves all data needed to return it to the state it was in when the application 30 was closed. The application 30 saves all data necessary to restore it to the current state in the case of a catastrophic application 30 failure. If the user does not choose to download the most recent version of the application 30 upon startup, a message appears upon logoff asking the user if they would like to install the upgrade before closing.

The application 30 gracefully log users out at end of day. The user receives a warning message, stating that the session is about to be closed. The user needs to log back in to reestablish the connection. The application 30 allows the user to combine the display of data of different types. Data types include, but are not limited to, Orders, Fills, Positions and Market Data. The application 30 supports the functionality exposed through the current version of a client API.

The application 30 supports data format differences between exchanges that are not normalized by the client API. The application 30 supports differences between exchange order handling semantics that are not normalized by the client API. The application 30 gracefully handles spreads. The application 30 support systems with multiple monitors. All exchange contracts supported by a platform are considered by the application 30. Online user documentation is available to the user. The application 30 runs on Windows 2000, Windows XP operating systems and other windowed operating systems (e.g., Linux, etc.). The application 30 architecture is flexible in order to allow additional functionality to be added when needed.

### Standard Windows Grid

In a Standard Windows Grid, a user can select from a list of columns to display. The user is able to add or remove columns, but all columns may not be able to be removed and certain columns may need to be added in order to add other columns (if there are dependencies). Each window will have certain columns that appear in the grid by default. The grid has a column heading with a caption (column name).

The user can change an order of the displayed columns by dragging the column heading to a new position. The user can manually resize a column. The user can resize all columns to fit the screen. The user can resize all columns to fit their contents. The user can resize a selected column to fit the column's contents. This is accomplished by double clicking on the column heading's right border. The user can change the foreground and background colors of a column. The user can rename any grid column. The user can restore the default grid column names. The user can restore all default grid settings.

The user can change the font for all columns in the grid. This includes, but is not limited to font type, color and size. The user can change the font for an individual column. This includes, but is not limited to, font type, color and size. The user can sort the data in the grid by clicking on a column heading. The user can sort the data in ascending or descending order. The user can create multiple sort criteria. The user can create a filtered view of the information in a grid. The user can filter on multiple criteria for non-numeric columns. Filters can include more then one column. Multiple filters for numeric columns can be created (e.g., for an =, #, <, >, ≦ or ≧ operation, etc.). This functionality also allows the user to choose a range. The user can remove filters from a grid. Data in a grid will continue to be updated while a filter is applied.

### Login Window

A Login window will be launched via the application 30 when the application 30 is first accessed by the user. A user will enter a user name and password in order to log into the application 30. A successful login will allow the user full access to multi-windowed GUI 32 functionality. A failed login displays a message to the user, indicating that either the user name or password were invalid, but not which one. If Caps Lock is on, the failed login message the application 30 indicates this fact. The failed login message reminds the user about case sensitivity. The user is able to change passwords. The user does not have to be logged into the communications network 18 to change passwords.

The application 30 updates a database with the new password. All characters entered into a password field will be visible to the user as asterisks. A single login allows the user access to all supported and enabled exchanges.

### Application Manager Window

An Application Manager Window allows the user to access all of the functionality of the application 30. It is via these windows that other application windows are launched and managed. The GUI 32 windows are automatically launched once the user has successfully logged in. Only one Application Manager window is launched by the application 30.

The Application Manager Window, by default, is a member of every display layout on the GUI 32 and cannot be removed. The user is able to view a list of available Desktop Layouts and select one to work with.

The user can create a new Tools window, Settings window, Contact and Quotes Window, Orders and/or Fills window, Positions/Market Data window, Aggregated Book View window, Order Ticket window and Reports window from the Application Manager Window. The user can also open a saved window from the Application Manager Window.

The user can maintain Desktop Layouts from the Application Manager Window. The user can minimize all windows and restore all windows from the Application Manager Window.

### Client Messaging Window

A Client Message Window allows the user to view system messages, trading exchange messages and alerts. This window is automatically launched once the user has successfully logged in. In one embodiment, only one Client Messaging window may be launched by the application 30. In another embodiment, more than one Client Message windows may be launched by the application 30. The Message display, by default, is a member of every display layout and cannot be removed. Users who are logged on must be able to receive system messages, communications from office personnel, electronic trading exchange messages and alerts from various electronic trading exchanges 20, 22. Alert receipts are displayed for the user. The window displays the entry and cancellation of orders (as messages). Alerts are given a priority, including, but not limited to, of “Critical,” “High,” “Medium” or “Low.”

Alerts of a high priority are presented in a more intrusive manner than lower priority alerts. Upon login, users receive alerts from the current day that were sent while they were logged off. The user is able to turn off the display of alerts and are able to turn off the display of messages.

### Tools Window

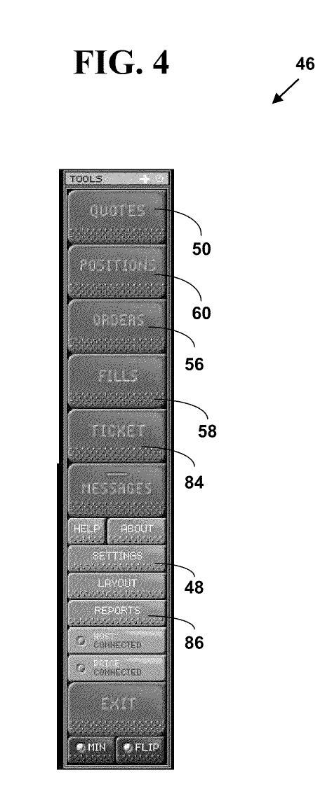

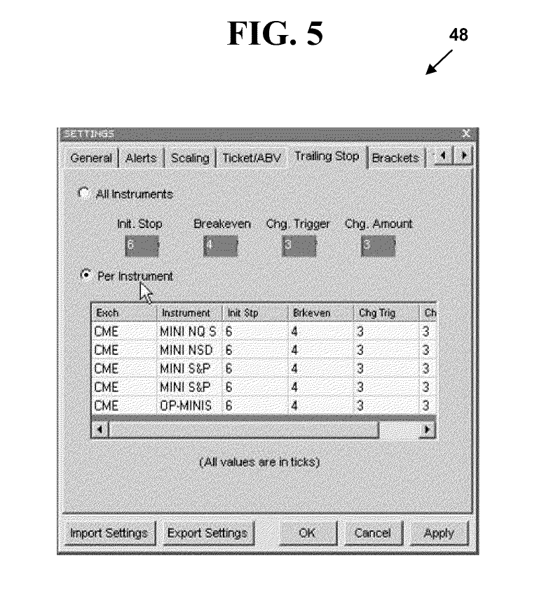

FIG. 4 is a block diagram of screen shot of an exemplary Tools window 46 produced by application 30 and displayed on the GUI 32. The Tools window 46 is used to launch other windows described herein on the GUI 32.

### Settings Window

FIG. 4 is a block diagram of screen shot of an exemplary Settings window 48 produced by application 30 and displayed on the GUI 32. The Settings window 48 allows the user to enter application-wide settings (such as defaults, etc.) This window 48 is accessible via the Manager window. The window 48 is different from any other window in the application. Multiple Settings windows cannot be opened, and this window is not part of a Desktop Layout.

The Settings window 48 displays network address (e.g., local and Internet IP addresses) of a target device 12, 14, 16. The Setting window 48 displays the Host and Price server IP addresses and ports that are being used by the application 30.

In one embodiment, the user loads settings from a settings file via the Settings window 48. The settings file contains information necessary to replicate the configuration of an application, including settings and desktop layouts. For audible alerts, each alert should have a different sound. The user can browse for sound files to assign to events. In another embodiment, settings are loaded from automatically from data structure within the application 30.

The user can turn on or off audible and/or visual alerts for the events listed below in Table 1. However, the present invention is not limited to these audible and/or visual alert events and more, fewer or other types of audible and/or visual alert events can be used to practice the invention.

TABLE 1

Logout
Login
Receipt of a fill
Entry of an order
Entry of an order amend
Entry of a cancel request
Receipt of an order
Receipt of a cancel
Receipt of an amend
Receipt of a reject
Receipt of a message
Order state timeouts
Loss of connection to the host server
Loss of connection to the price server
Reconnection to the host server
Reconnection to the price server
Receipt of SARA alerts
A different sound/visual alert is used for each priority level.
Limit breach
Contract breach
Exchange disabled
Stop price triggered for synthetic stops and stop limit orders
Pull all orders
End of day/End of market
By exchange
This information is downloaded on login if an update is needed.
Custom Reminders
OCO fill
OCO cancel
Parked order violated
If Then fill
If Then cancel
P/L bracket fill
P/L bracket cancel

The user can set the following defaults for an order ticket listed in Table 2. However, the present invention is not limited to these defaults and more, fewer or other types of defaults can be used to practice the invention.

```
TABLE 2
Default Account
Default Exchanges and Contracts
Default Order Type
    The user can set the default order type by exchange or to set the
    same default for all exchanges.
Default side
Default Quantity
    The user can set the default quantity by instrument or to set the same
    default for all instruments.
Close after order entry
    The user can determine whether or not the Order Ticket should close
    by default after an order has been entered.
Quantity set to zero after order entry
    The user can determine whether or not the order quantity should
    return to zero once an order has been placed.
Default price for limit orders - Sell
    The user can determine whether the price for sell limit orders should
    default to current bid, ask, or last.
Default price for limit orders - Buy
    The user can determine whether the price for buy limit orders should
    default to current bid, ask, or last.
Other Settings
Always on Top
    The user can set which window should stay on top by default (if any).
    This default may be overridden on a window by window basis.
Order State Timeouts
    The user can set the amount of time that an order can remain in a
    state of Sent, Queued, Cancel Pending or Amend Pending before an
    order state timeout alert is generated.
Custom Reminders
    The user can create and maintain a list of custom reminders, which
    will create an audible and visual alert at the set date and time.
    The user can assign a title, date, time and description to each
    reminder.
    Custom reminders are saved on the local machine.
ABV Market Depth
    The user can set the amount of market depth displayed on the
    ABV window.
    A Market Depth setting greater than the maximum depth
    disseminated by the exchange will be treated as the exchange
    maximum.
Hot Keys
    The user can assign program shortcuts to keyboard function keys.
Fonts
    The user can set a default font for all text on all windows.
    The user can restore all fonts to the font selected here (after
    changes have been made on individual windows).
Key Pad (for Quantity)
    The user can assign the values for keypad buttons.
    These values will be displayed on the key.
Order Quantity Limits (Fat Finger Rules)
    The user can set the maximum quantity that may be entered for
    an order.
    An order exceeding this limit will not be entered.
Commissions
    The user can enter commission amounts by exchange and/or
    by instrument.
    The commissions set here are used in the user's P&L calculations.
Print Reports
    The user can choose whether or not a window should appear upon
    logoff, asking if reports should be printed.
    From the window (if displayed), the user should be able to specify
    which reports are printed.
```

### Contracts and Quotes Window

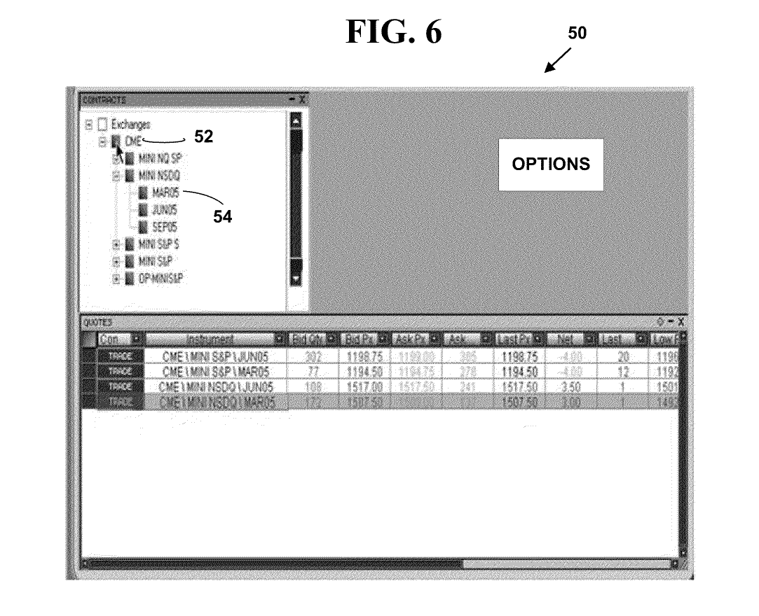

FIG. 6 is a block diagram of screen shot of an exemplary Quotes and Contracts window 50 produced by application 30 and displayed on the GUI 32. The user can select which exchange 52 (e.g., Chicago Mercantile Exchange (CME), Chicago Board of Trade (CBOT), New York Stock Exchange, etc.) and which instruments, contract and contract date combinations (e.g., Mini NSDQ March 2005) to display 54. Market data associated with a position by the unique instrument information is also displayed.

### Order and Fills Windows

The user is able to display any combination of order and fill information that they choose (although some information must be displayed in order for other information to be displayed) in Order and Fill windows respectively. The user is provided with an Orders template and a Fills template, which will each display different default data (and, therefore, provide different functionality based on user defined preferences set via the Settings window 48).

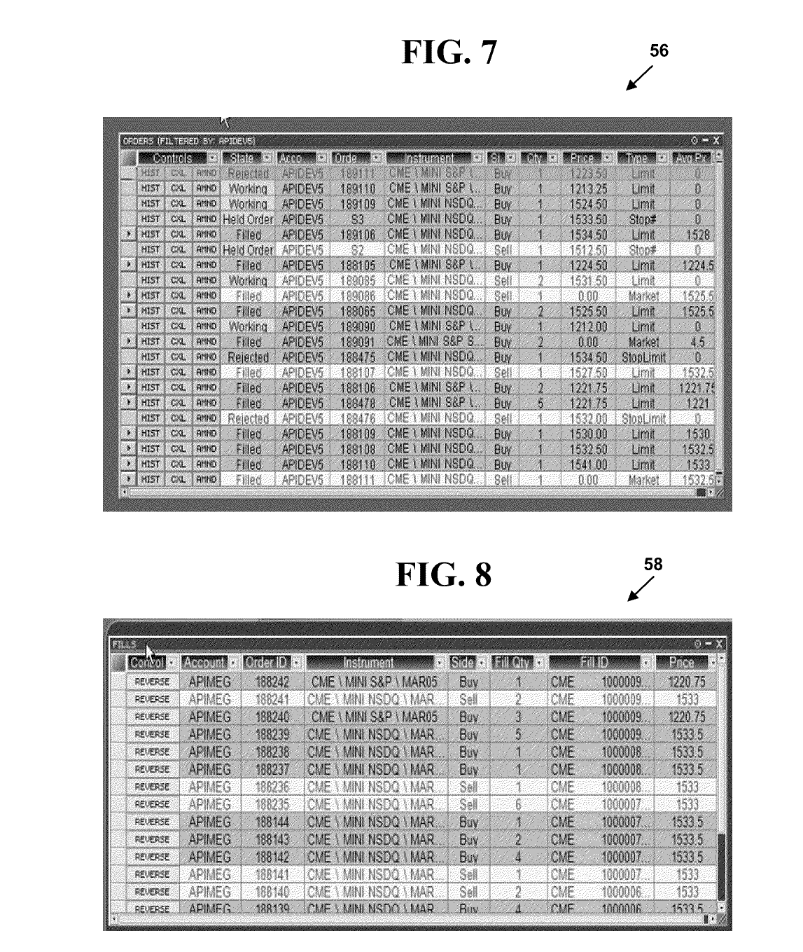

FIG. 7 is a block diagram of screen shot of an exemplary Order window 56 produced by application 30 displayed on GUI 32. Typically, an order is created by the user and submitted to an electronic trading exchange 20, 22 for possible execution. One exception to this is the Parked order. In this case, the application 30 saves the order until it is released by the user to the electronic trading exchange 20, 22.

In one embodiment, the Order window 56 displays, but is not limited to, a controls identifier, a state identifier (e.g., rejected, working, filled, held) an account identifier (e.g., APIDEV5), an order number, an instrument identifier (e.g., CME\MINI S&P), a side designation identifier (e.g., buy or sell), a quantity, a price, a type identifier (e.g., limit, pre-defined stop price, market price) an average price. However, the present invention is not limited to displaying these items and more, fewer or other items can be displayed in the Order window 56 to practice the invention.

FIG. 8 is a block diagram of screen shot of an exemplary Fills window 58 produced by application 30 displayed on GUI 32. Typically, a fill is an acknowledgment from an electronic trading exchange 20, 22 where the order was submitted that all or part of the order was executed. A special case is an external fill. An external fill is submitted manually by a system administrator.

In one embodiment, the Fills window 58 displays, but is not limited to, a control identifier, an order identifier, an instrument identifier, a side identifier, a fill quantity, a fill identifier and a fill price. However, the present invention is not limited to displaying these items and more, fewer or other items can be displayed in the Fills window 58 to practice the invention.

A new or saved Order and Fill windows 56, 58 can be launched from the Application Manager window. When the user creates and submits an order to an electronic trading exchange 20, 22, an order with a quantity greater then the maximum order limit will be rejected by the application 30. The user can create a trailing stop order against a filled order. The user is also able to create a Profit/Loss bracket around a filled order.

The user can also create a “Parked” order. A Parked order is an order that is created by the user but not submitted to an electronic trading exchange 20, 22. Parked orders are saved by the application 30 and made available to the user between application 30 launches. The user can change a working order to a parked order and visa versa. Changing a working order to a parked order, the application 30 sends a cancel to the selected electronic trading exchange 20, 22. On receipt of the cancel acknowledgement, the application 30 will change the order state to indicate that the order is parked.

The user can also submit a Parked order to an electronic trading exchange 30. The user can submit all parked orders at once. The user can select certain parked orders to submit (at once). The user can change the electronic trading exchange and/or contract for a parked order. If the user changes the contract, the application 30 will verify that the entered price is valid for the new contract. If the entered price is invalid for the new contract, the application 30 will prompt the user to change the price. The user can change the account for a parked order.

The user can cancel a working order. In one embodiment, a working order can be canceled with a single mouse click. In another embodiment a working order can be canceled with two mouse click, one to cancel the order and one to confirm cancellation. The user can cancel all working orders in a selected account, cancel all working buy orders in the selected account, all working sell orders in the selected account.

The user can delete a parked order. The use can delete a parked order with a single mouse click. The user can delete all parked orders in a selected account. The user can delete all parked orders in all accounts.

The user can change the following order information (for a working order) illustrated in Table 3. However, the present invention is not limited to this order information and more, fewer or other types of order information can be used to practice the invention.

```
TABLE 3
Prices (stop/limit/stop limit)
Quantity
    The user must be able to display the detailed order history for an
    order (both parked orders and those submitted to an exchange.
The order history includes orders that led to the current order if the order
was created by a cancel/replace or a parked order.
```

The user can also create a trailing stop order against a fill. The user can create a Profit/Loss bracket around a fill. The user can launch an Order Ticket window from a specific fill. When an Order Ticket is opened from a fill, the ticket is pre-populated with the data that corresponds to that fill (e.g., exchange, instrument, quantity, etc.)/ The side of the Order Ticket will be opposite that of the fill. Supported order types will be available to be created from the Order Ticket. Trailing stops and brackets can be linked to another order, such as a limit order. When this order is executed the Trailing Stop or bracket, etc. is then submitted to the market, or held “working” on the target device 12, 14, 16.

The Fills window 58 displays a detailed view of a fill. A fill detail includes all available fill information (including partial fills). The application 30 handles external fills. The application 30 uses separate display indicators if the fill is external (e.g., color difference, etc) on the GUI 32.

In one embodiment, Order and Fill information is displayed following standard window rules laid out by the Standard Window. The data in this Order and Fill window is displayed in the standard grid format, as described in the Standard Grid. This window will display order and fill data. The user chooses which fields should be displayed in the grid (some fields will appear by default) on the GUI 32.

Table 4 illustrates a list of order information that used in the Order and Fill windows 56, 58. Most of the information is exposed through the APIs used. However, in a few cases the information is calculated. These exceptions are indicated where they occur. However, the present invention is not limited to this order information and more, fewer or other types of order information can be used to practice the invention.

```
TABLE 4
Order ID
Display ID
Exchange Order ID
User Name
Trader Account
Order Type
Exchange Name
Contract Name
Contract Date
Buy or Sell
Price
Price2
Lots
Linked Order
Amount Filled
Number of Fills
Amount Open
    This field is calculated by the application 30 using contract lots
    minus amount filled.
Average Price
    This field (the average price of all fills that make up an order) is
    calculated by the application 30 because the API does not return
    the correct value if there is only one lot.
Status
Date Sent
Time Sent
Date Host Received
    This field will not displayed to the user, but is used for logging.
Time Host Received
    This field will not be displayed to the user, but is used for logging
Date Exchange Received
    This field will not be displayed to the user, but is used for logging.
Time Exchange Received
Date Exchange Acknowledged
Time Exchange Acknowledged
Non Execution Reason
Good-Till-Date
```

Table 5 illustrates a list of fill information that used in the Order and Fill windows 56, 58. Most of the information is exposed through the APIs used. However, in a few cases the information is calculated. These exceptions are indicated where they occur. However, the present invention is not limited to fill information and more, fewer or other types of fill information can be used to practice the invention.

```
TABLE 5
Display ID
Exchange Order ID
User Name
Trader Account
Order Type
Exchange Name
Contract Name
Contract Date
Buy or Sell
Lots
Price
Average Price
    This field will need to be calculated by the application because
    the API does not return the correct value if there is only one lot.
Date Filled
Time Filled
Date Host Received
    This field will never be displayed to the user, but is used for logging.
Time Host Received
    This field will never be displayed to the user, but is used for logging
Fill Type
Fill, External, Netted, Retained
```

### Positions/Market Data Window

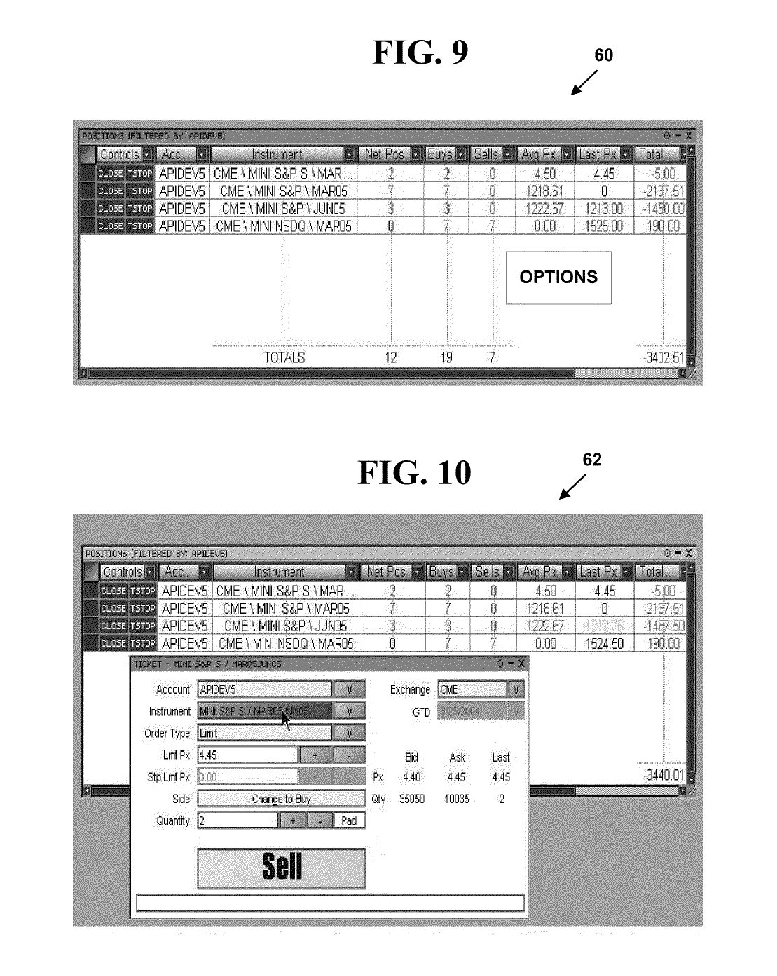

FIG. 9 is a block diagram of screen shot of an exemplary GUI 32 Position and Market Data window 60 produced by application 30 displayed on the GUI 32. The Positions and Market Data Window 60 provides representation and display of open positions and market data in the application 30.

In one embodiment, the Positions and Market Data window 60 includes, but is not limited to a display of a controls identifier, an account identifier, a net position, a number of buys, a number of sells, an average price, an last price and a total. However, the present invention is not limited to displaying these items and more, fewer or other items can be displayed in the Position and Market Data window 58 to practice the invention.

The user can display any combination of order and fill information that they choose (although some information must be displayed in order for other information to be displayed). The user is provided with an Orders template and a Fills template, which will each display different default data (and, therefore, functionality).

An “open position” is a long, short, or profit or loss in an instrument or contract in an account. This open position is the aggregation of all the fills received in the instrument. Market data is delivered to the application 30 in real-time through the APIs used. A new or saved Positions/Market window 60 can be launched from the Application Manager window. The user can launch an Order Ticket window 84 from a specific position.

FIG. 10 is a block diagram of screen shot of an exemplary Position and Market Data window for an Order Ticket from a sell position 62 produced by application 30 and displayed on the GUI 32. When a ticket is opened from a position, an Order Ticket window 84 is pre-populated with the data that corresponds to that position (e.g., exchange, instrument, quantity, etc.). For example in FIG. 10, an Order Ticket window includes data (e.g., APIDEV5, CME\MINI S&P, Limit, Limit Px 4.45, Quantity 2, etc.). The side of the Order Ticket will be opposite that of the position. The user can launch a window that will allow them to create a Profit/Loss (P/L) Bracket around an open position. The order sides default to opposite of the position. The order quantities default to the position quantity. The user can also launch a window that will allow them to create a Stop or Stop Limit order against an open position.

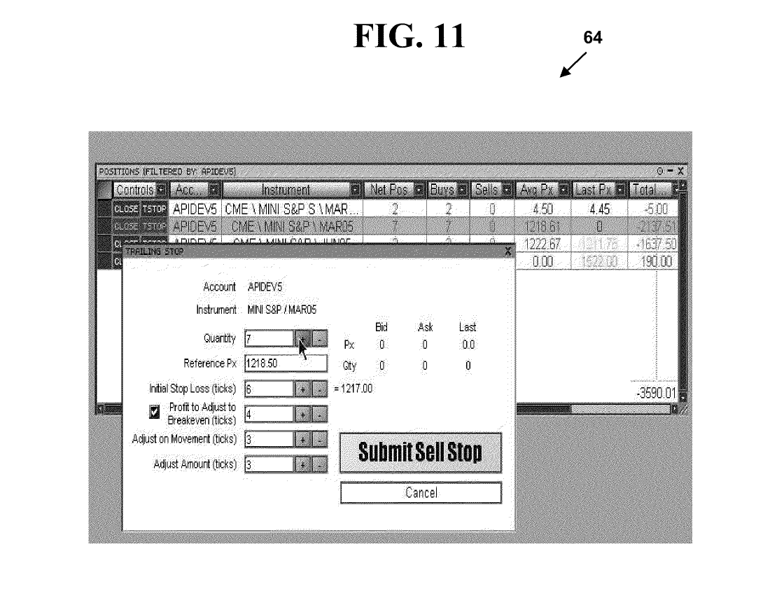

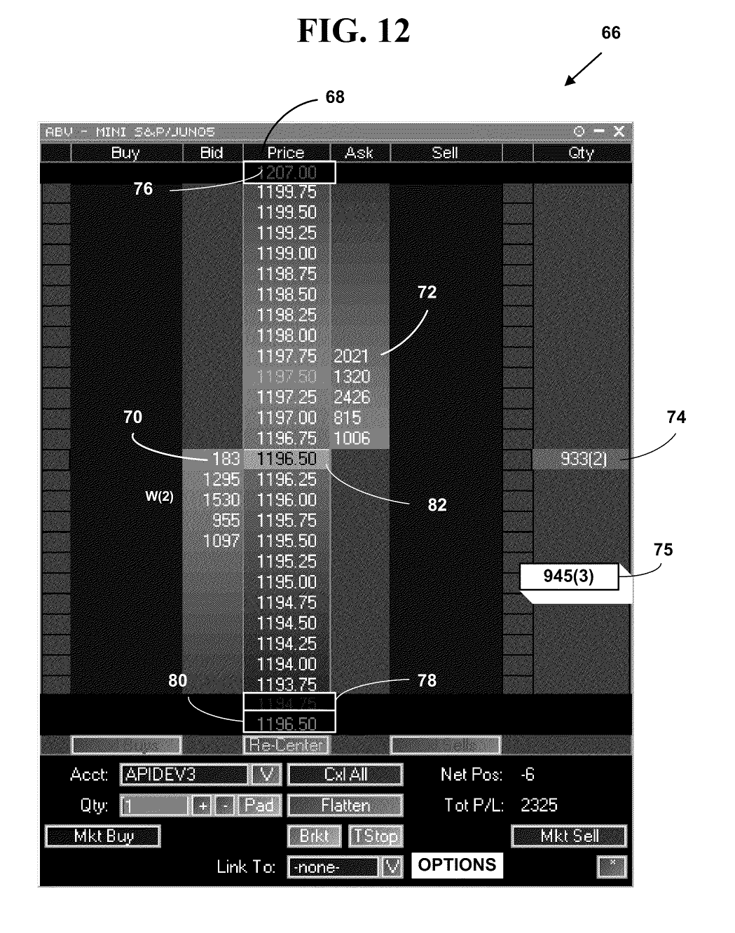

FIG. 11 is a block diagram of screen shot of an exemplary Position and Market Data window for a sell stop order 64 produced by application 30 displayed on the GUI 32. The order side defaults to opposite of the position. The order quantity defaults to the position quantity. The user can also launch a window that will allow them to create a Limit order against an open position. The order side defaults to opposite of the position. The order quantity defaults to the position quantity.

The user can display all of the fills that comprise a position. The user can flatten the open position in the instrument for the selected account. The window 60 includes a Flatten button for flattening a net position. When the user chooses to flatten, working orders for the instrument are canceled and an order is entered that flattens the net position (i.e., the quantity of the order will be equal to the net position and the order will be placed on the opposite side of the net position). The flattening is achieved with a single order (i.e., the user cannot enter more than one order to flatten).

Position information and Market Data is displayed following standard window rules laid out in the Standard Window. The data in this window 60 is displayed in the standard grid format, as described in the Standard Grid.

Table 6 illustrates a list of position information that is available from this window 60. However, the present invention is not limited to this position information and more, fewer or other types of position information can be used to practice the invention.

TABLE 6

Account
Exchange Name
Contract Name
Contract Date
Net Position
Avg. Price
Open P&L
Cumulative P&L
Total P&L
Commission

The GUI 32 will also show market data and position information. The user chooses which fields should be displayed in the grid (i.e., some market data fields will appear by default). Table 7 is a list of market data that is available from this window 60. However, the present invention is not limited to this market data more, fewer or other types of market data can be used to practice the invention.

TABLE 7

```
Exchange Name
Contract Name
Contract Date
Bid Price
Bid Size
Ask Price
Ask Size
Last Traded Volume
Net Price Change
Last Traded Price
High Price
Low Price
Opening Price
Closing Price
Total Traded Volume
Contract Status
    This is the status of the contract on the exchange
    (i.e. open, pre-open, trading, etc.)
```

### Agreated Book View/Ask Bid Volume (ABV) Window

The ABV Window allows the user to view bid size and offer size by price for a particular instrument in a market depth-type format. The window displays working orders for a selected account in a single instrument. The data on this window is displayed and updated in real-time. The window also allows the user to enter various order types. In one embodiment, two ABV widows are displayed by default. In another embodiment, one or more than two ABV windows are displayed by default.

FIG. 12 is a block diagram of screen shot of an exemplary ABV window 66 produced by application 30 displayed on GUI 32. The ABV window 66 includes a dynamically displayed Price column 68.

In one embodiment, the ABV window displays a buy column, a bid column, a dynamic price column, an ask column, a sell column, a quantity column, a re-center button, a cancel buy button, a cancel sell button, a cancel all button, a market buy button, a flatten button, a bracket button, a TStop button, a net position and a total P/L. However, the present invention is not limited to displaying these items and more, fewer or other items can be displayed in the ABV window 66 to practice the invention.

The user can select an instrument or contract to view in an ABV window 66, and can change the instrument or contract from this window 66. Changing the instrument or contract changes the data displayed to that of the selected instrument or contract. The user can select an account from available accounts. The window 66 displays the total quantity of orders working in the market at each price. Both buy and sell quantities are displayed. Quantities are updated as the instrument order book changes. The window 66 displays an indicator depicting the all of the user's open orders, for the selected account, at each price. The window 66 indicates a state of each order. Open order states include, but are not limited to: Queued, Sent, Working, Part Filled, Cancel Pending and Amend Pending, Held, Cancelled, Filled.

This window 66 indicates the order type for each order. The window 66 indicates the working quantity of each order. The window 66 displays parked orders for the selected instrument. The window 66 displays the user's net position in the selected instrument for the selected account. The window 66 displays the trade quantities for each corresponding price level. The user can select to view the total quantity currently trading at a price. This quantity is increased as each trade at a price occurs. The cumulative quantity remains in the window 66 until the price changes (at which time the cumulative trade quantity for the new price will be shown).

The user selects to view the last quantity currently trading at a price. This view shows the individual trade quantities. Only quantities for the current price are shown. The window 66 displays the total traded volume for the instrument. The window 66 displays all of the aforementioned data at once.

The user sets and adjusts the specified quantity for orders entered via this window 66. The quantity is set via a spinner, text entry or keypad entry. Each key-pad input increases a specified quantity by an amount displayed on the key (key value). The user selects to have the specified quantity set to zero after order entry. The user resets the quantity to zero (i.e., without entering an order). A right click on the mouse increases the quantity, left click decreases the quantity.

Orders entered via this window 66 will have a quantity equal to the quantity specified at time of entry. The default account for any orders entered from the ABV window 66 is the selected account. The can enter a limit order by clicking a cell in the bid quantity or offer quantity columns. Limit orders are default order type.

Order side will be set to BUY if the user clicks in the bid quantity column 70. Order side will be set to SELL if the user clicks in the offer quantity column 72. Orders will have a quantity equal to the specified quantity. Order limit price must equal the price corresponding to the clicked offer/bid quantity.

The user enters a stop order by clicking a cell in the bid or offer quantity columns 70, 72. Order side will be set to BUY if the user clicks in the bid quantity column 70. Order side will be set to SELL if the user clicks in the offer quantity column 72. Orders must have a quantity equal to the specified quantity. The order stop price will equal the price corresponding to the clicked offer/bid quantity. The order is entered for the selected account. The user is able to enter a buy stop below the market or a sell stop above the market. If the user does this, a window appears, warning the user that the buy or sell will be immediately executed.

The user can enter an OCO (One Cancels Other) pair of orders. The user can also enter a profit/loss bracket. The user can enter a trailing stop. The user can also enter an “If-Then Strategy.”

The user can change the limit price of a working limit order by dragging the working order indicator to a new price. The user can change the stop price of a working stop order by dragging the working order indicator to a new price. This will cause a cancel replace to be entered at the electronic trading exchange 20, 22. The user can change the quantity of a working order by right clicking in the cell displaying the working order. A right click on a mouse displays a context menu listing order quantities centered on the current quantity. The user can also adjust account number.

The user can cancel a working order with a single mouse click. The user can cancel all open orders in the instrument for the selected account. The can cancel all open buy orders in the instrument for the selected account. The user can cancel all open sell orders in the instrument for the selected account.

Users can have orders at a price displayed as a concatenated total, or displayed as each individual order. When the display of individual orders is to large for the display, individual orders will be displayed starting with the first order entered and then the remaining orders that do not fit in the display will be concatenated. Concatenated orders are indicated as such using a symbol that is attached to the total. Users can also adjust the display of the ABV by adding or removing columns, buttons and functions.

The user uses the open position in the instrument for the selected account. This window 66 includes a Flatten button for flattening the net position. When the user chooses to flatten, all working orders for the instrument are canceled and an order is entered that flattens the net position (i.e., the quantity of the order will be equal to the net position and the order will be placed on the opposite side of the net position). The flattening is achieved with a single order (i.e., the user cannot enter more than one order to flatten).

The user can center the dynamic Price column 68 on the current market. The user can scroll the dynamic Price column 68 to display prices above or below the current market. All data is displayed real-time. The dynamic Price column 68 is automatically and dynamically re-centered in the ABV window 66 upon a current last traded price that continuously and dynamically changes with price fluctuations in the current last traded price for a desired trading market.

This ABV window 66 follows the standard window rules laid out in the Standard Window. The data in this window is displayed in a grid, but this grid will not follow all of the standard grid rules.

The user can choose from a list of columns to display. Certain columns will be displayed by default. Certain columns will not be removable (price for example). The user can change the order of the displayed columns by dragging a column heading to a new position. The user can manually resize a column. The user can resize all columns to fit the screen. The user can resize all columns to fit the contents. The user can resize a selected column to fit the contents. Double clicking on the column heading border sizes a column so that data only is displayed with no redundant space.

The user can change the font for all columns in the grid. The user can change the font for an individual column. The user can change the foreground color of a column. The user can change the background color of a column. The user can restore the default grid settings.

The ABV window 66 is resizable. When it is resized, the columns expand and contract so that all data is still shown. However, after resizing the window, the user can resize the columns to get rid of wasted space and then change the font size (i.e., so it's more readable when the screen is small).

This ABV window 66 will display the following fields illustrated in Table 8 in a ladder format. However, the present invention is not limited there fields and more, fewer or other types of fields can be used to practice the invention.

TABLE 8
Price
Centered on the current market prices when launched.
Market Bid Quantity
Market Offer Quantity
Trade Quantity
Open Buy Orders indicating status, type and quantity for each order
Open Sell Orders indicating status, type and quantity for each order
Parked Orders

The ABV window 66 displays real-time data for a particular contract, allowing a user to get a current snapshot of the market. Thus, the ABV window 66 can also be considered an “Ask, Bid, Volume” window.

An instrument or contract can be added to an open ABV window 66 in the same way that a contract was added to the Quotes window 50. Simply select the contract that to display and then drag it into the ABV window 66. Contracts can be dragged from any of the windows displayed on the screen.

Once a contract has been added to the ABV window, the data illustrated in Table 9 is displayed on the ABV window.

TABLE 9
A current number of Bids 70 and Asks 72 on an electronic trading
exchange 20, 22 for particular price levels.
A total quantity currently trading at a certain price.
A number in parentheses 74 next to the total quantity is the last quantity
traded at that price.
A price in red is the daily high 76. A price shown in blue is the daily low
78. A last traded price is shown in gray 80.
The last traded price 82 is also highlighted on a dynamic price column 68.
When there has been an uptick in this price, this cell will be green. When
there has been a downtick, this cell will be red. If there has been no
change, this cell will appear yellow.
The Buy and Sell columns display a total number of open orders at each
particular price. For example, a “W2” in the Buy column indicates
that there are working orders with a total quantity of two at the
specified price.
Net Position and Total P/L on the ABV can be monitored by simply
referring to the lower right hand corner of the window.

On the ABV window 66, the price of any open Buy or Sell orders can be amended. To change the price of an order, a row selector that corresponds with the order to amend is selected buy left-clicking and holding down a left mouse button, dragging a cursor connected to the mouse up or down to a desired new price and releasing the mouse button. A white cursor arrow appears to indicate a change in price. The price amended will be submitted as soon as the mouse is released. If there multiple orders at the same price (and on the same side), all of the orders will be amended to the new price when dragging the concatenated order. The user can cancel a signal order at a price where multiple orders exist. They can also modify a single order at a price where multiple orders exist. They do this by selecting the individual order and dragging and dropping.

Another feature of the ABV window 66 is that a desired position on the dynamically displayed Price column 68 can be moved. If it is desired to scroll up or down on a market price on the dynamically displayed Price column 68, the dynamically displayed Price column 66 is hovered over with a mouse. A yellow cursor arrow will appear, pointing up if the mouse cursor is in the top half of the dynamic price column 68, or down, if the mouse cursor is in the bottom half of the dynamic Price column 68. Clicking on the cursor arrow will scroll the grid in the direction that the arrow points.

The ABV window 66 provides a dynamic Price column 68 centered upon the lasted traded price that continuously changes with fluctuations in the last traded price. To enter an order, a mouse cursor is hovered anywhere in the ABV window 66. This mouse hover puts a user in the “order entry mode.” In the order entry mode a trade near last traded price can be entered or prices on the dynamic price column can be manually adjusted away from the last traded price. To scroll up or down the market prices on the dynamic Price column 68 to enter a trade, the mouse cursor is hovered over the dynamic Price column 68. A large yellow arrow will appear, pointing up if the mouse curser is in the top half of the dynamic price column, or down, the mouse cursor is in the bottom half of the dynamic price column. Clicking on the large yellow arrow will scroll the prices in the dynamic price column in the direction that the large arrow points so a trade can be entered away from a current market price.

If the dynamic Price column 68 is scrolled up or down and the last traded price is not centered on your ABV, the dynamic price column will start to scroll until the last traded price is again centered in the ABV window 66. In addition, if there is no further activity from a mouse for a period of time the dynamic Price column 68 will also start to scroll. As a visual indication, just before the dynamic price column begins to scroll, the mouse cursor will turn yellow and start to flash. This is a warning that the ABV window is about to begin re-centering around the last traded price. If, at any time, the mouse cursor is moved out of the ABV window, you leave the order entry mode and the ABV will automatically re-center the dynamic price column on the last traded price the next time the market price changes.

Stop and limit orders can also be entered on the ABV window 66 with just a click of a mouse. Before entering limit or stop orders an account is chosen and a quantity is entered. If a user has access to multiple accounts, the user can select the desired account by using the Account drop down menu. The user can input a number of lots to trade by typing the number in, by using the + or − buttons, or by using a keypad. A default quantity can be set via the Settings window. After selecting an account and quantity, limit and stop orders can be placed.

To enter a Buy Limit order, the mouse is clicked in the Bid column next to the Price to enter the order for. A limit order to buy will be entered at that price for the quantity specified, and a new working order will be reflected in the Buy column. Likewise, to enter a Sell Limit order, the mouse is clicked in the Ask column next to the Price to enter the order for.

To enter a Buy Stop order, the mouse is right-clicked in the Bid column next to the Price to enter the order for. A stop order to buy will be entered at that price for the quantity specified, and a new order will be reflected in the Buy column. Similarly, to enter a Sell Stop order, the mouse is right-clicked in the Ask column next to the Price that you want to enter the order for.

In addition to Limit and Stop orders, Market orders can be executed on the ABV window 66 using the Market Buy and Market Sell buttons. The ABV window can also be set up so that a Bracket or Trailing Stop order will automatically be created any time an order entered via the ABV is filled. The Bracket and Trailing Stop parameters will default to the values set up on the Settings window. To link a Bracket or Trailing Stop order to all orders entered via the ABV, choose Bracket or TStop from the Link To drop down box. A small window pops up with the default parameters for a bracket. The bracket levels can be changed by typing in a desired number, or using the “+” and “−” buttons. A limit order will be the profit order type, and for a loss order type, either choose a stop or a trailing stop can be selected.

For example, if a stop order is chosen, as soon as the order was filled, two new orders were entered. A limit order was created at a price that is five ticks above the market order's price and a stop order was created at a price that is three ticks below the market order's price Both orders have the same quantity that the market order had. Because these orders were entered as part of a bracket, when one of these orders is filled, the other will automatically be cancelled. Likewise, TStop is chosen from the Link To drop down box, a small window will appear that allows you to view and change trailing stop parameters. Like the bracket, a trailing stop will be entered once an order entered via the ABV window 66 is filled.

The ABV also allows cancellation of some or all of working orders as well. To cancel a particular order, the mouse cursor is placed over that order in the Buy or Sell column, whichever applies, and a yellow X appears over the working order. A mouse click on the yellow X will cancel that particular order. If multiple orders are entered at the same price (and on the same side), they will all be cancelled.

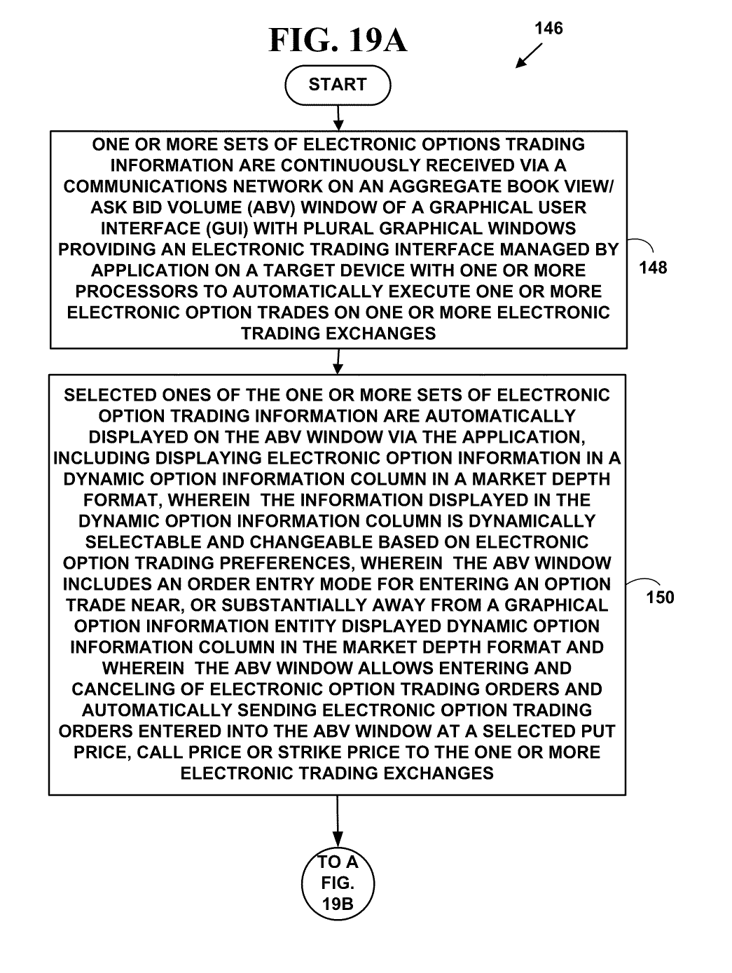

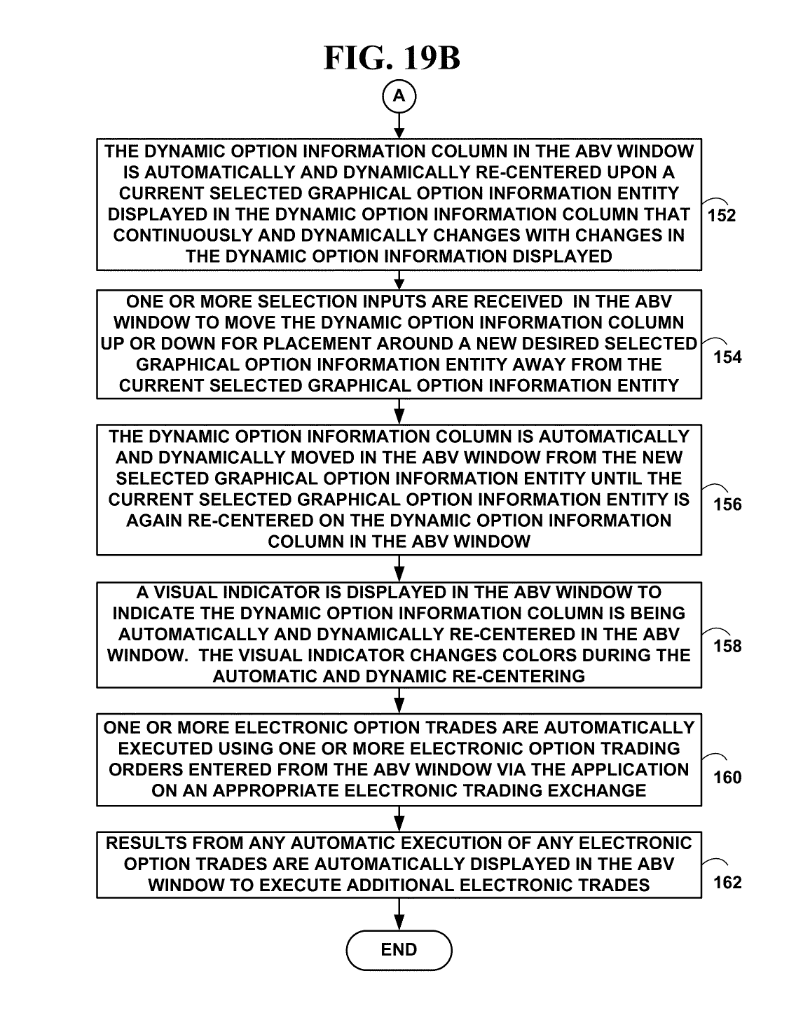

The ABV window 66 is also used for electronic option trading as is illustrated in FIGS. 19-24 below.

### Order Ticket Window

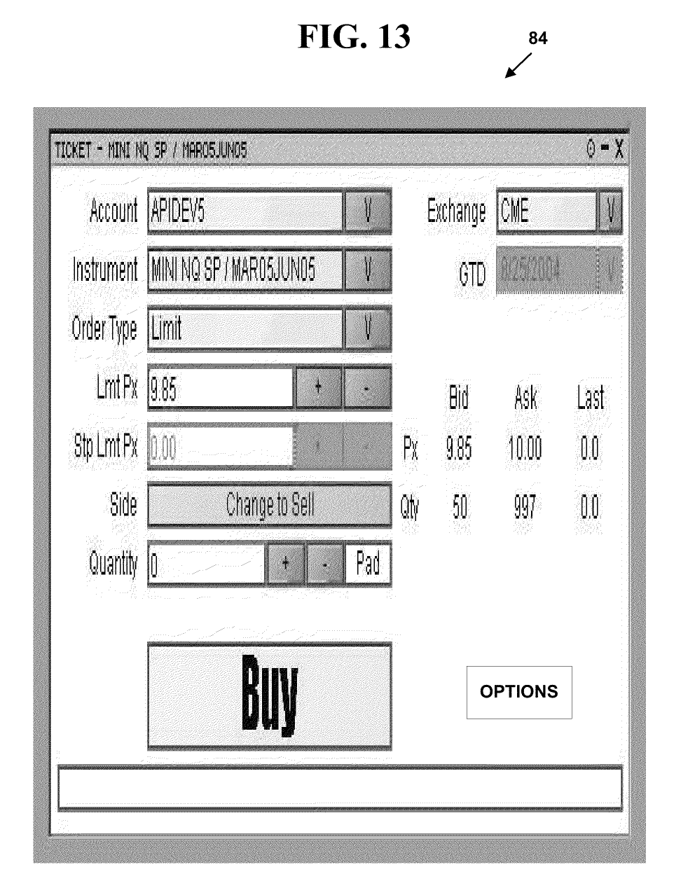

FIG. 13 is a block diagram of screen shot of an exemplary Order Ticket window 84 produced by application 30 and displayed on GUI 32. This window 84 allows the user to create and enter all types of orders supported by the application and the APIs used. This window 84 is accessible via all windows except for Login, Settings, Client Messaging and Reports windows. Multiple order tickets can be launched and multiple windows 84 will be created. The Order Ticket window 84 is a member of a Desktop Layout. Order types, including Synthetic order types can be entered from this window.

In one embodiment, the Order Ticket window 84 displays, but is not limited to, an account identifier, an instrument or contract identifier, an order type, a limit price, if any, a stop limit price if any, a side identifier, a quantity identifier, an exchange identifier a current bid, ask, and last traded price, a current bid, ask or last traded quantity and a buy or sell identifier. However, the present invention is not limited to displaying these items and more, fewer or other items can be displayed in the Order Ticket window 84 to practice the invention.

If necessary, the Order Ticket window 84 will change or launch supporting windows to accommodate more complex order types. In one embodiment, the Order Ticket window 84 displays, but is not limited to, an account identifier, an instrument or contract identifier, an order type, a limit price, if any, a stop limit price if any, a side identifier, a quantity identifier, an exchange identifier a current bid, ask, and last traded price, a current bid, ask or last traded quantity and a buy or sell graphical button. However, the present invention is not limited to this embodiment and other embodiments can be used to practice the invention.

The user can select the account that the order applies to. The user can change the side of the order. The ticket background color depends upon the side chosen. For example, the background is set to blue for buy orders and set to red for sell orders. The following market data is displayed, but is not limited to, on this window 84 for the selected instrument: bid price, bid size, ask price, ask size, and last traded price.

This window 84 also does follow the standard window rules laid out in the Standard Window. The window can also be resized. The user can select to have the order ticket always on top. The default for this functionality is determined in the Settings Window. The Order Ticket window 84 is member of a Desktop Layout window. The Order Ticket window 84 settings are saved when it is a member of a Desktop Layout.

This window 84 is comprised of all the fields necessary to enter an order. The field defaults are set in the Settings window 48, but this window 84 may display different defaults depending on where it was launched from (for example, if it was launched from a specific fill or position).

Table 10 illustrate a list of the fields that are used to create a standard order. Synthetic orders also created directly from this window 84. In another embodiment, a separate window may be launched, or there may be some other method of accessing synthetic order entry. However, the present invention is not limited to this order information and more, fewer or other types of order information can be used to practice the invention.

```
TABLE 10
Exchange
    The default value for this field is determined from the window
    where it was launched or in Settings.
Instrument
    This field is filtered to display valid instruments based on the
    exchange that is selected.
Contract Date
    This field is filtered to display valid contract dates based on the
    instrument that is selected.
Order Type
    This field is filtered to display valid order types based on the
    exchange that is selected.
Limit Price
    This field defaults to either the current bid, ask or last as
    determined by Settings and by the side.
    This price does not change once the order is open.
    This field is enabled only for stop, stop limit, MIT orders and
    the synthetic equivalents for those order types.
    The use is able to enter the price via keyboard entry or spinner,
Order Quantity
    The user is able to change the specified order quantity through a
    key-pad control.
    Each key-pad input increases the specified quantity by the amount
    displayed on the key (the key value).
    The user has ability to set the quantity back to zero.
    The user is able to select to have the specified quantity set to
    zero after order entry.
Secondary Price
    This field is enabled only for stop limit orders.
Good-Till-Date
    This field is enabled only for orders with TIF (Time in Force)
    of GTD.
    This field defaults to the current trade date.
```

### Reports Window

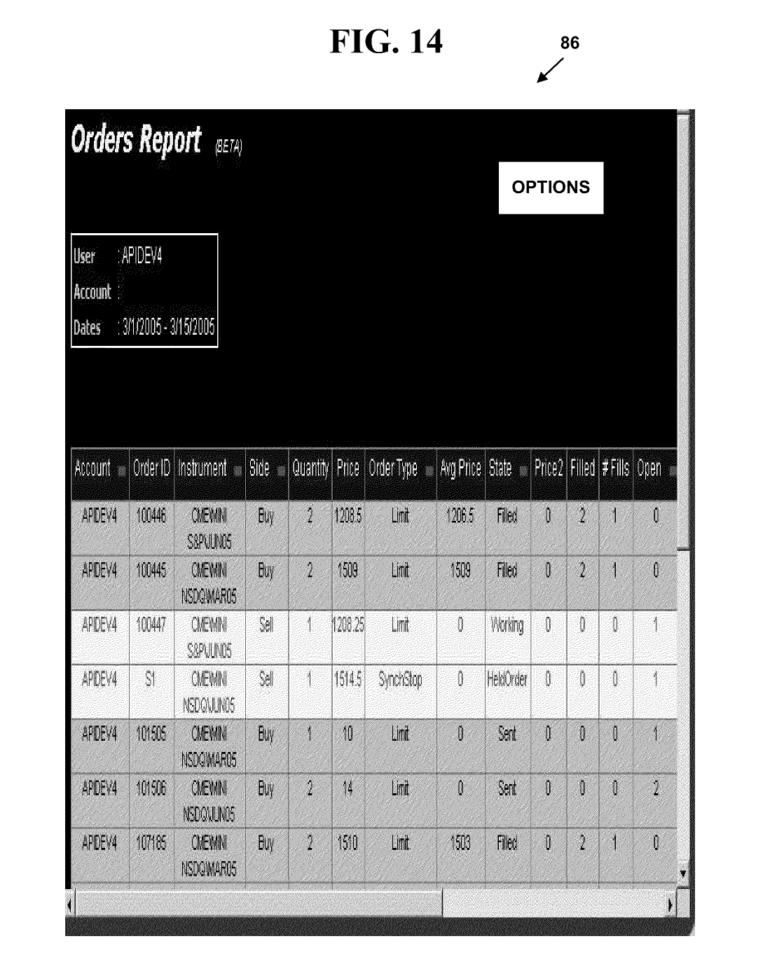

FIG. 14 is a block diagram of screen shot of an exemplary Reports window 86 produced by application 30 displayed by GUI 32. The Reports window 86 allows the user to create and enter all types of orders supported by the application 30 and APIs used. This window is accessible via all windows except for Login, Settings, Client Messaging and Reports. Multiple order tickets can be launched. The order ticket can be a member of a Desktop Layout window.

In one embodiment, the Reports window 86 displays, but is not limited to, an account identifier, an order identifier, an instrument identifier, a side identifier, a quantity, a price, an order type, an average price, a state, a price2, file, number of fills and an open column. However, the present invention is not limited to displaying these items and more, fewer or other items can be displayed in the Reports window 68 to practice the invention.

Order types, including synthetic order types are summarized from this window 86. If necessary, the Order Ticket window 84 changes or launches supporting windows to accommodate more complex order types. The user can select the account that the order applies to. The user changes the side of the order. Ticket background color depends upon the side chosen. For example, the background is blue for buy orders ant he background is red for sell orders.

Table 11 illustrates a list of the fields used to create a standard order report. However, the present invention is not limited to this order information more, fewer or other types of order information can be used to practice the invention.

```
TABLE 11
Exchange
    The default value for this field is determined from the window
    where it was launched or in Settings.
Instrument
    This field is filtered to display valid instruments based on the
    exchange that is selected.
Contract Date
    This field is filtered to display valid contract dates based on the
    instrument that is selected.
Order Type
    This field is filtered to display valid order types based on the
    exchange that is selected.
Limit Price
    This field defaults to either the current bid, ask or last as
    determined by Settings and by the side.
    This price does not change once the order is open.
    This field is enabled only for stop, stop limit, MIT orders and the
    synthetic equivalents for those order types.
    The user is able to enter the price via keyboard entry or spinner.
Order Quantity
    The user is able to change the specified order quantity through a
    key-pad control.
    Each key-pad input increases the specified quantity by the amount
    displayed on the key (the key value).
    The user has ability to set the quantity back to zero.
    The user is able to select to have the specified quantity set to zero
    after order entry.
Secondary Price
    This field is enabled only for stop limit orders.
Good-Till-Date
    This field is enabled only for orders with TIF (Time in Force)
    of GTD.
    This field defaults to the current trade date.
    This window allows the user to view and print reports.
Screen Access
    This window is accessed via the Manager window. Multiple report
    windows cannot be launched. The report window is not a member
    of any Desktop Layout.
Functional Requirements
    No trading functionality is available from this window.
Fill Report
    The user is able to view and print a fill report by account for the
    current day.
    The data for this report is saved on the client.
Order History Report
    The user is able to view and print an order history report for the
    current day or for any range of time up to 30 days.
    History includes parked orders.
    The data for this report should is on the client machine 30.
Orders Entered Report
    The user is able to view a report showing orders entered that were
    filled for the current day or for any range of time up to 30 days.
    The data for this report is saved on the client.
```

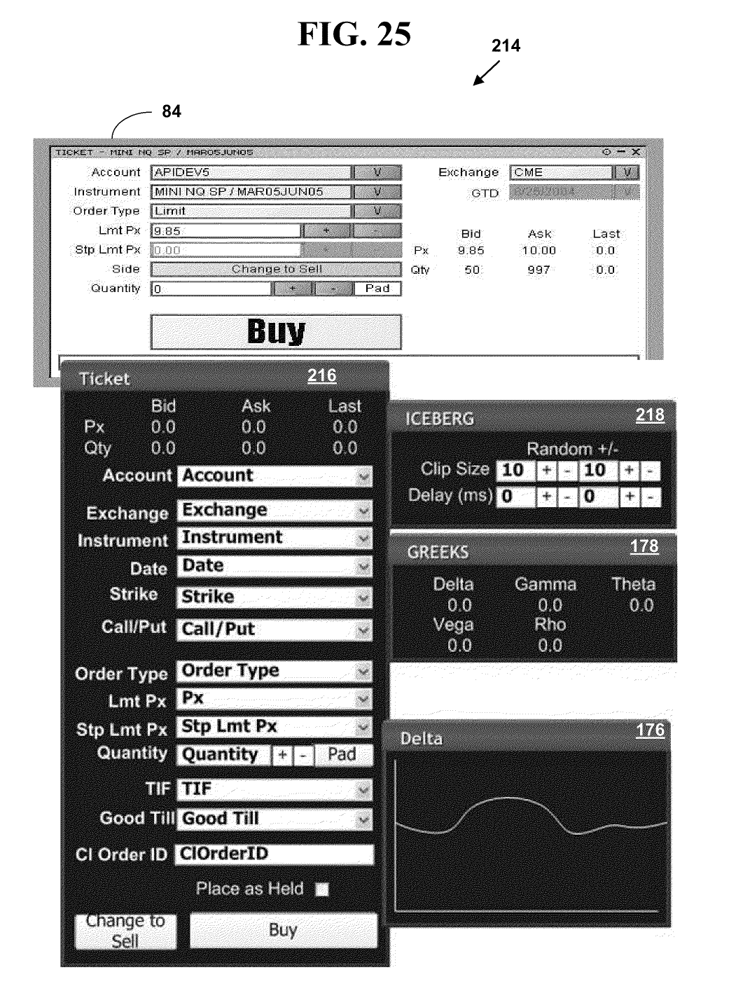

The Order Ticket window 84 is also used for electronic option trading as is illustrated in FIG. 25 below.

### Client Logs

This functionality allows the user to send error and audit logs. A log of application errors is maintained. Application error logs, created daily, are retained for ten trading days. The user does not have ability to view the application error log. Logs are stored on the client and are not be encrypted, but should not be easily accessible to the user. The user can send the application error log to another location from within the application 30.

An audit log is created. The audit log contains detailed order history, including all available times associated with the order. The log also contains fills associated with the order. The log contains messages pertaining to the application which indicate connection activities and statuses. Audit logs, created daily, are retained for ten trading days. The user does not have ability to view the audit log. Logs are stored on the application 30 and should not be encrypted, but should not be easily accessible to the user. The user can send the audit log to another location from within the network 18.

### Specialized Order Functionality

The application 30 also provides specialized order functionality. This functionality is available to the user wherever orders can be entered. The user creates one-cancels-other (OCO) order pairs. An OCO order is one that allows the user to have two working orders in the market at once With the execution of one order the other is canceled. The user can construct an OCO pair across different instruments traded on a single electronic exchange. The user can construct an OCO pair across different instruments on two electronic trading exchanges. The user can construct an OCO pair combining orders of any order type that is supported by the exchange (or supported synthetic order types).

The user cancels OCO orders before exiting the application 30. If the user has any open OCO's upon logoff, the GUI 32 warns the user that the orders will be cancelled and allow the user to cancel the logoff if desired. By default, entering a quantity for the OCO enters that same quantity for both sides of the OCO.

A complete fill of one order cancels the other order. If there is a partial fill on one leg of the OCO, the other side of the OCO is reduced by the amount that was filled. This functionality will only occur if both legs of the OCO are entered with the same quantity. The user has the ability to turn off this functionality, so that the order quantities don't automatically decrement and the orders are canceled only when one order is completely filled. If the user enters different quantities, this functionality are automatically turned off and disabled.

The user can cancel individual orders of the pair, leaving the remaining order in the market. The user can cancel both orders in the pair simultaneously. The user can change the price for an individual order of the pair. The user can create a profit/loss bracket order pair. A Profit/Loss bracket is a specific case of an OCO order pair. This order pair consists of a limit order to establish a profit and a stop loss order to limit loss. The stop loss portion of the bracket should be able to be a “trailing stop.” The use is able to create a profit/loss bracket around an existing position. The user is able to create a profit/loss bracket around a fill. The use can create a profit/loss bracket around an order in the filled state.

The user can create trailing stop orders. A trailing stop is an order that tracks a price of the instrument and adjusts the stop trigger price in accordance with a predefined rule (i.e., stop trigger is changed when the market changes a certain number of ticks).

Trailing stop orders can be either of type stop or stop limit. For stop limit orders, the limit price will be changed such that it keeps the same differential from the stop trigger price. In order to set up the trailing stop rule, the user must enter: the number of ticks that the market must change before the stop trigger price should be adjusted. The number of ticks that the stop trigger price should be adjusted when an adjustment is warranted. A trailing stop order is purely synthetic.

The stop order should only be known to the client until it is actually triggered. At that time either a market order (in the case of an order type of stop) or a limit order (in the case of a stop limit order) will be entered into the market. A trailing stop only adjusts the stop trigger price in the profitable direction of the trade. A trailing stop order to sell does not adjust the stop trigger price to a value less than the initial trigger value. A trailing stop order to sell only increases the stop trigger price. A trailing stop order to sell only adjusts the stop trigger price when new high prices are traded in the instrument. This will prevent adjusting the stop trigger price if the instrument price retraces a profitable move but does not trigger the stop.

A trailing stop order to buy does not adjust the trigger price to a value greater than the initial trigger value. A trailing stop order to buy only decreases the stop price. A trailing stop order to buy must adjusts the trigger price when new low prices are traded in the instrument. This will prevent adjusting the stop trigger price if the instrument price retraces a profitable move but does not trigger the stop. Trailing stops are only valid while the user is logged into the application 30. Application 30 exit will have the effect of the trailing stop not being in the market. On application exit, if the user has trailing stops entered, the user will be warned that the stop will not be worked while the application is closed.

The user is to choose to save trailing stops. On application 30 launch, the user is advised of any saved trailing stops and given the opportunity to reenter them.

The user is able to create parked orders. A parked order is an order that is created by the user but not submitted to the market. The user is able to release a parked order. Releasing a parked order submits it to the market. The user can change a working order to a parked order. This sends a cancel to the exchange. On receipt of the cancel acknowledgement, the application 30 changes the order state to indicate that the order is parked. Parked orders are saved on application exit. Parked orders are restored on application 30 launch.

### If-Then Strategies

The user can create an “If-Then Strategy.” With an If Then Strategy, an order is entered into the market. Upon receipt of a fill acknowledgement for the order, one or more other orders are automatically entered by the application 30 based on the If-Then strategy. Typically, the orders that are entered with If-Then Strategy will be orders to manage profit and loss expectations for the fill that was received on the original order. The user can create an If-Then strategy where on the receipt of the acknowledgement of an order fill, a profit/loss bracket is entered around the fill price for the filled quantity. The user can create an If-Then strategy where on the receipt of the acknowledgement of an order fill, a stop or stop limit order is entered at an offset from the fill price for the quantity of the fill. The user can create an If-Then strategy where on the receipt of the acknowledgement of an order fill, a trailing stop order is entered at an offset from the fill price for the quantity of the fill. The user can create an If-Then strategy where on the receipt of the acknowledgement of an order fill, a limit order is entered at an offset from the fill price for the quantity of the fill. The user can create an If-Then strategy where on the receipt of the acknowledgement of an order fill, an OCO order pair is entered.

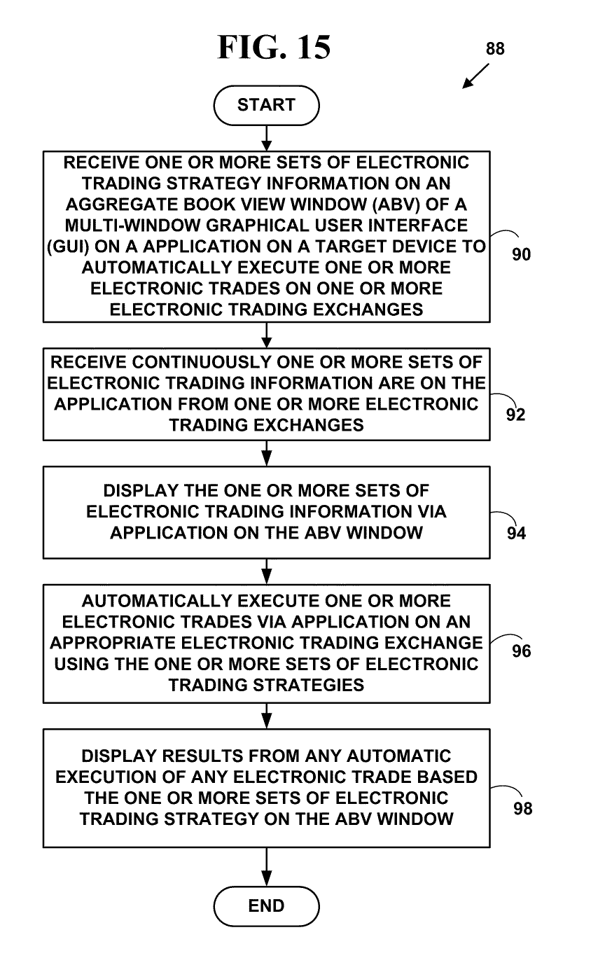

FIG. 15 is a flow diagram illustrating a Method 88 for electronic trading. At Step 90, one or more sets of If-Then electronic trading strategy information is obtained on an aggregate book view window 66 on a application 30 on a target device to automatically execute one or more electronic trades on one or more electronic trading exchanges. At Step 92, one or more sets of electronic trading information are continuously received on the application 30 from one or more electronic trading exchanges 20, 22. At Step 94, the one or more sets of electronic trading information are displayed via application 30 on the ABV window 66. At Step 96, one or more electronic trades are automatically electronically executed via application 30 on an appropriate electronic trading exchange 20, 22 using the one or more sets of If-Then electronic trading strategies. At Step 98, results from any automatic execution of any electronic trade are formatted and displayed on the ABV window.

In one embodiment, the electronic trading system 10 allows a trader to setup a strategy to trade two or more distinct markets (e.g., cash and futures) which have a predefined relationship (e.g., one-to-one) and automatically execute both markets simultaneously. In one embodiment, the integrated trading platform includes a configurable slippage factor that is predefined by the trader and allows the trader to safely execute a 2^{nd} leg, 3^{rd} leg, of the trade if the initial trade for the futures misses. In another embodiment, the electronic trading system 10 includes a one-to-one trade from either the cash side or the futures side first. In another embodiment, the electronic trading system 10 includes a best cash market to trade from.

The electronic trading system 10 also includes Duration functionality allows traders to enter in one-to-one strategies which are not in a one Cash to ten futures ratio. It also allows traders to enter in one-to-one ratios such as one Cash and twelve futures etc.

In another embodiment, the electronic trading system 10 also includes a graphical Profit and Loss (P&L) blotter provides risk monitoring at a firm, group, or trader level. The integrated trading system calculates P&L on a real-time basis with Mark to Market functionality. The electronic trading system 10 includes firm wide status messages that can be broadcast to all traders who are viewing a graphical blotter and it will illustrate actual P&L and not just intraday by including previous days total equity position.

The electronic trading system 10 also allows traders to receive futures and cash market data real-time into a spreadsheet (e.g., Excel, etc.) and allows traders to receive both cash and futures trades real-time into a spreadsheet.

The electronic trading system 10 also provides an electronic “black box” that allows a trader to enter a desired trading formula into the application 30, thereby allowing the GUI application 30 to automatically execute electronic trades via one or more electronic trading exchanges. The black box allows automatic tracking and execution of both actual and synthetic trading entities.

The electronic trading system 10 also provides synthetic trading, real and synthetic spread trading, real and synthetic yield curve trading and real and synthetic option trading and real and synthetic option spread trading and/or Exchange Traded Funds (ETF) trading and ETF spread trading.

As is known in the art, a “synthetic trading entity” is a virtual trading entity equivalent to real trading entity and is created with two or more real trading entities.

An “exchange-traded fund (ETF)” is an investment fund traded on stock exchanges, much like stocks. An ETF holds assets such as stocks, commodities, or bonds and trades at approximately the same price as the net asset value of its underlying assets over the course of the trading day. Most ETFs track an index, such as the S&P 500 or MSCI EAFE. ETFs may be attractive as investments because of their low costs, tax efficiency, and stock-like features. ETFs are one of the most popular type of exchange-traded product.

ETFs offer public investors an undivided interest in a pool of securities and other assets and thus are similar in many ways to traditional mutual funds, except that shares in an ETF can be bought and sold throughout the day like stocks on a securities exchange through a broker-dealer. Unlike traditional mutual funds, ETFs do not sell or redeem their individual shares at net asset value, or NAV. Instead, financial institutions purchase and redeem ETF shares directly from the ETF, but only in large blocks, varying in size by ETF from 25,000 to 200,000 shares, called “creation units”. Purchases and redemptions of the creation units generally are in kind, with the institutional investor contributing or receiving a basket of securities of the same type and proportion held by the ETF, although some ETFs may require or permit a purchasing or redeeming shareholder to substitute cash for some or all of the securities in the basket of assets.

The ability to purchase and redeem creation units gives ETFs an arbitrage mechanism intended to minimize the potential deviation between the market price and the net asset value of ETF shares. Existing ETFs have transparent portfolios, so institutional investors will know exactly what portfolio assets they must assemble if they wish to purchase a creation unit, and the exchange disseminates the updated net asset value of the shares throughout the trading day, typically at 15-second intervals.

If there is strong investor demand for an ETF, its share price will (temporarily) rise above its net asset value per share, giving arbitrageurs an incentive to purchase additional creation units from the ETF and sell the component ETF shares in the open market. The additional supply of ETF shares increases the ETF's market capitalization and reduces the market price per share, generally eliminating the premium over net asset value. A similar process applies when there is weak demand for an ETF and its shares trade at a discount from net asset value.

In the United States, most ETFs are structured as open-end management investment companies (the same structure used by mutual funds and money market funds), although a few ETFs, including some of the largest ones, are structured as unit investment trusts. ETFs structured as open-end funds have greater flexibility in constructing a portfolio and are not prohibited from participating in securities lending programs or from using futures and options in achieving their investment objectives.

There are many different types of real and synthetic spreads that are traded. A “futures spread” includes a purchase of one futures delivery month contract against the sale of another futures delivery month contract of the same commodity; the purchase of one delivery month contract of one commodity against the sale of that same delivery month contract of a different commodity; or the purchase of one commodity contract in one market against the sale of the commodity contract in another market, to take advantage of a profit from a change in price relationships. The term spread is also used to refer to the difference between the price of a futures month contract and the price of another month contract of the same commodity.

An “intra-commodity” spread (e.g., a calendar spread) is long at least one futures contract and short at least one other futures contract. Both have the same underlying futures contract but they have different maturities.

An “inter-commodity” spread is a long-short position in futures contracts on different underlying futures contracts. Both typically have the same maturity. Spreads can also be constructed with futures contracts traded on different exchanges. Typically this is done using futures on the same underlying contract, either to earn arbitrage profits or, in the case of commodity or energy underlying contracts, to create an exposure to price spreads between two geographically separate delivery points.

A “different commodities spread” is a spread between two or more different commodities contracts of any type of any maturity and any type of position. (e.g., (Mini S&P)/(Mini NSDAQ), or (Mini S&P)/(Mini DJ), etc.).

A “crack spread” is a commodity contract--commodity product contract spread involving the purchase of a commodity and the sale of a product. For example, the purchase of crude oil futures contracts and the sale of gasoline and/or heating oil futures contracts.

Spread trading offers reduced risk compared to trading futures contracts outright. Long and short futures contracts comprise a spread that correlated, so they tend to hedge one another. For this reason, exchanges generally have less strict margin requirements for future contract spreads.

A “butterfly spread” for futures contracts includes a spread trade in which multiple futures contract months are traded simultaneously at a differential. The trade basically consists of two or futures spread transactions with either three or four different futures months at one or more differentials.

Spread trading is also used for options. An option spread trade is when a call option is bought at one strike price and another call option is sold against a position at a higher strike price. This is a called a “bull spread.” A “bear spread” includes buying a put option at one strike price and selling another put option at a lower strike price.

A “butterfly spread” for options includes selling two or more calls and buying two or more calls on the same or different markets and several expiration dates. One of the call options has a higher strike price and the other has a lower strike price than the other two call options. If the underlying stock price remains stable, the trader profits from the premium income collected on the options that are written.

A “vertical spread” for options includes a simultaneous purchase and sale of options of the same class and expiration date but different strike prices. A vertical spread for futures contracts includes a simultaneous purchase and sale of futures contracts with the same expiration date but different prices.

A “horizontal spread” includes the purchase and sale of put options and call options having the same strike price but different expiration dates. A horizontal spread for futures contracts includes the purchase and sale of futures for the same purchase price but different expiration dates.

A “ratio spread” applies to both puts and calls, involves buying or selling options at one strike price in greater number than those bought or sold at another strike price. “Back spreads” and “front spreads” are types of ratio spreads.

A “back spread” is a spread which more options are bought than sold. A back spread will be profitable if volatility in the market increases. A “front spread” is a spread in which more options are sold than bought. A front spread will increase in value if volatility in the market decreases.

The purpose of an option spread trade is two-fold. First, it bets on the direction that a trader thinks a certain stock will go. And second, it reduces a trader's cost of the trade to the difference between what is paid for the option and what profit is obtained from selling the second option. An option profit is the spread, or the difference between the two strike prices, minus a cost of the spread.

An “inter-exchange” spread is a difference in a price of same security, instrument or contract traded on different exchanges. For examples, the price of a stock for a computer of brand-X on the New York Stork Exchange and the Tokyo Stock exchanges.

Various types of spreads (e.g., vertical, horizontal, ratio, back, front, etc.) are also used to trade futures contracts, stocks, bonds and other financial instruments and financial contracts in addition to options.

As is known in the electronic trading arts, a “black box trading entity” includes, but is not limited to, trading strategies developed by one or more traders for futures contracts, options contracts, or other instruments for differed shipment or delivery or otherwise, or other contracts or financial or other instruments traded electronically. The black box trading entity may be created only for sell-side trades, only for buy-sides trades, both buy and sell trades, spreads, and other types of real or synthetic trades that can be executed electronically.

As is known in the electronic trading arts, a “yield curve” is a chart in which a yield level is plotted on one axis (e.g., a vertical axis, etc.), and the term to maturity of debt instruments or other similar instruments are plotted on another axis (e.g., a horizontal axis, etc.). In general, when yields are falling, a yield curve will steepen. When yields are rising, a yield curve flatten.

In finance, a yield curve is a relationship between the cost of borrowing for a in a certain currency and the amount of time the money is being borrowed for. The yield of a debt instrument is an amount of money received per year by investing in that instrument. Investing for a period of time t gives a yield Y(t). This function Y is called the “yield curve.” The nomenclature “curve” is used rather than “yield function” because when plotted on a graph, the function is a curve. Yield curves are used by commodity and other financial instrument traders to seek trading opportunities. For commodities trading, market participants often sell short and buy long, or sell long and buy short using yield curves.

In one embodiment, yield curve electronic trading strategies are used with the electronic trading system described above. Yield curve trading permits electronic traders to price any commodity contract, financial instrument or security instrument off of any other security commodity contract, financial instrument or security instrument with a yield curve using a price, yield, or basis spread. The yield curve electronic trading strategies include electronic trading via multiple yield curves by asset class, curves off curve and curves on curve.

The application 30 also allows traders to receive futures and cash market data real-time into a spreadsheet (e.g., Excel, etc.) or from a spreadsheet and allows traders to receive both cash and futures trades real-time into and from a spreadsheet.

In another embodiment, the application 30 and the electronic trading system 10 includes only a few select trading features and does not include all the trading system features just described. In such an embodiment, an inexperienced electronic trader is allowed to execute simply and efficiently electronic trades at one or more electronic trading exchanges with little or no previous electronic trading experience.

Display of current position in market depth of trading market

As was described above, the ABV Window 66 allows an electronic trader to view bid size and offer size by price for a particular instrument being traded electronically in a market depth format. As is known in the electronic trading arts, “market depth” is a number of electronic trading instruments (e.g., contracts, financial instruments, etc.) required to move the electronic trading entity price by one “price tick” in a current market. An empirical difficulty using with the market-depth concept for electronic trading is separating empirically price changes due to shifts in trading fundamentals from those due to temporary order imbalances due to the buying or selling by of large numbers of trading instruments. Electronic trading systems usually provide knowledge of a depth of a market through an electronic open-order book via a graphical display of current market information (e.g., FIG. 12, Table 2, etc.) and current market positions.

When trying to measure and graphically display market depth for use with electronic trading, there are typically three important dimensions to consider: (1) speed of price changes; (2) magnitude of price changes; and (3) execution of other trades at selected price levels.

In one embodiment, application 30 via GUI 28 displays market depth information including plural price levels representing market prices for the one or more electronic trading entities represented by a graphical market depth representation.

In one embodiment, the market depth information is integrated into existing: graphical windows graphically displayed via the Order and Fills window 56, 58. In another embodiment, the market depth information is displayed via the ARV window 66 (See Table 2 and FIG. 12). In another embodiment, the market depth information is not integrated into any existing graphical windows and is displayed in a separate unique market depth trade estimated execution window (not illustrated in the figures). However, the present invention is not limited to the graphical window described and more, fewer or other types of graphical windows can be used to practice the invention.

In one embodiment, a market price level of a selected graphical market depth representation is selected through action of a user input device (e.g., mouse, keyboard, software function call, etc.) In response to this selection, an indicator of one or more correlated price levels is displayed on a graphical market depth representation displays real and synthetic electronic entities within a vertically oriented and/or horizontally oriented and/or other angle oriented display. In another embodiment, the market depth representation is displayed automatically without user input.

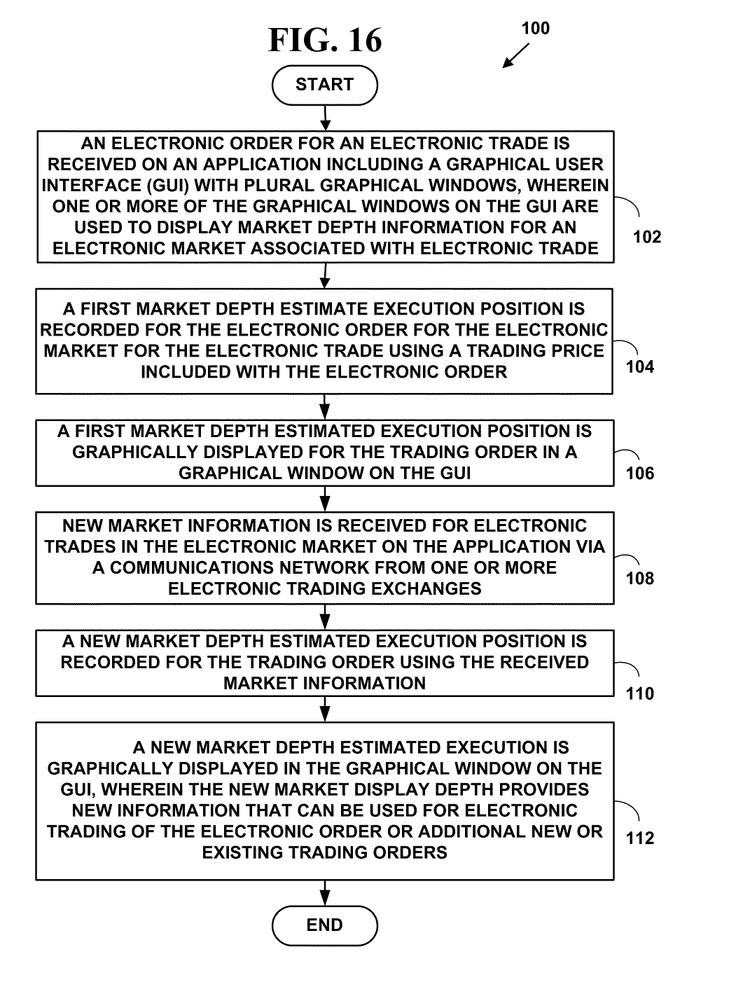

FIG. 16 is a flow diagram illustrating a Method 100 for display of an estimated market depth execution position. At Step 102, an electronic order for an electronic trade is received on an application including a graphical user interface (GUI) with plural graphical windows. One or more of the graphical windows on the GUI are used to display market depth information for an electronic market associated with the electronic trade. At Step 104, a first market depth position is recorded for the electronic using a trading price included with the electronic order. At Step 106, a first market depth estimated execution position is graphically displayed for the electronic order in a graphical window on the GUI. At Step 108, new market information is received for electronic trades in the electronic market on the application via a communications network from one or more electronic trading exchanges. At Step 110, a new market depth execution position is recorded for the electronic order using the received market information. At Step 112, a new market depth estimated execution position is graphically displayed for the electronic order in the graphical window on the GUI. The new market depth estimated execution position provides new information about a new estimated execution position that can be used for electronic trading of the electronic order or additional new or existing trading orders.

Method 100 is illustrated with one exemplary embodiment. However, the present invention is not limited to this exemplary embodiment, and other embodiments can also be used to practice the invention.

In such an exemplary embodiment at Step 102, an electronic order for an electronic trade is received on an application 30 including a graphical user interface (GUI) 32 with plural graphical windows. One or more of the graphical windows (e.g., 56, 58, 66, etc.) on the GUI are used to display market depth information for an electronic market associated with electronic trade.

Step 104, a first market depth estimated execution position is recorded for the electronic order for the electronic market for the electronic trade using a trading price included with the electronic order. In one embodiment, when an electronic order is first placed, a depth of market at a desired trading price is recorded. The electronic order is assumed to be placed in a last execution position at an end of the trading queue for the market. Thus, position of the electronic order in trading queue is equal to a first market depth when the electronic order was placed at a desired trading price. However, an actual position in an actual trading queue for the electronic market may be different than that displayed due to plural different asynchronous events taking place simultaneously in the electronic market on one or more electronic trading exchanges.

At Step 106, a first market depth estimated execution position is graphically displayed for the trading order in a graphical window (e.g., 56, 58, 66, etc.) on the GUI 32. This first market depth estimated execution position gives an electronic trader a graphical indication of an estimated execution position in the electronic market for the electronic trade.

In one embodiment, the execution position is a real-time estimate based on real-time data received from the one or more trading exchanges 20, 22. The execution position is a real-time estimate because many different types of asynchronous events can and do effect the actual execution order of electronic trades in the electronic market.

For example, a trader who placed the electronic order as well as hundreds, thousands or more other electronic traders may also have pending electronic trades awaiting execution. There is always some very small communications lag time between the application 30 and the one or more electronic trading exchanges via the communications network 18. The trader who placed the electronic order as well as the other traders can and do execute independent asynchronous actions that affect the market depth in the electronic market as well as its communications to/from electronic trading exchanges. For example, one or more electronic traders may be dynamically modifying a desired trading price level, dynamically modifying the number of trading entities (e.g., contracts, etc.) being traded, dynamically changing characteristics of an electronic order (e.g., change a buy order to a sell order and visa versa, put on, take off, change the legs of a spread, etc.), dynamically canceling a trading order, etc. all effect market depth in the electronic market.

At Step 108, new market information is received for electronic trades in the electronic market on the application via a communications network from one or more electronic trading exchanges 20, 22.

As market depth changes at a current trading price, the electronic order's estimated execution position is modified based on the new trading information received. In one embodiment, the electronic order's execution position becomes equal to the market depth if the market depth becomes less then the electronic order's estimated execution position. In one embodiment, the electronic order's estimated execution position remains unchanged if the market depth does not become less then the electronic order's estimated execution position. In one embodiment, the electronic order's estimated execution position is also modified as electronic trades occur at and/or near the electronic order's desired price level. For example, in one embodiment, for each electronic entity (e.g., contract, etc.) traded at the electronic order's desired price level, one execution position is subtracted from the electronic order's estimated execution position. A new estimated execution position is then dynamically and continually graphically displayed. However, the present invention is not limited to this estimated execution positions and other methods can also be used to estimate the execution position to practice the invention.

At Step 110, a new market depth estimated execution position is recorded for the electronic order using the received market information. The new market depth display estimated execution position is displayed in real-time to provide real-time updates for an electronic trader.

At Step 112, a new market depth estimated execution position is graphically displayed for the electronic order in the graphical window (e.g., 56, 58, 66, etc.) on the GUI 32. The new market depth display provides new information about a new estimated execution position that can be used for electronic trading of the electronic order, modifying or removing the electronic order, or adding additional electronic orders at the same or different price levels. Such information may also assist an electronic trader in developing and/or executing one or more different types of trading strategies for real and/or synthetic trading instruments.

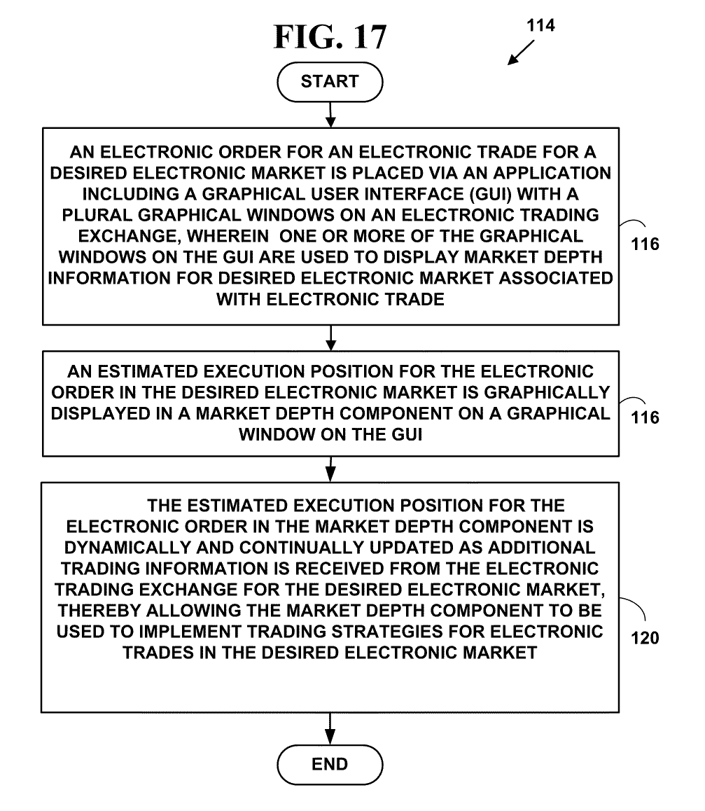

FIG. 17 is a flow diagram illustrating a Method 114 for display of an estimated market depth execution position. At Step 116, an electronic order for an electronic trade for a desired electronic market is displayed via an application including a graphical user interface (GUI) with plural graphical windows on one or more electronic trading exchanges. One or more of the graphical windows on the GUI are used to display market depth information for desired electronic market associated with electronic trade. At Step 118, an estimated execution position for the electronic order in the desired electronic market is displayed graphically in a market depth component on a graphical window on the GUI. At Step 120, the estimated execution position for the electronic order is dynamically and continually updated and graphically re-displayed in the market depth component as additional information is received from the one or more electronic trading exchanges for the desired electronic market, thereby allowing the market depth component to be used to implement a trading strategy for electronic trades in the desired electronic market.

Method 114 is illustrated with one exemplary embodiment. However, the present invention is not limited to this exemplary embodiment, and other embodiments can also be used to practice the invention.

In such an exemplary embodiment at Step 116, an electronic order for an electronic trade for a desired electronic market is graphically displayed via an application 30 including a graphical user interface (GUI) 32 with plural graphical windows (56, 58, 66, etc.) on one or more electronic trading exchanges 20, 22. One or more of the graphical windows on the GUI are used to display market depth information for desired electronic market associated with electronic trade.

At Step 118, an estimated execution position for the electronic order in the desired electronic market is displayed graphically in a market depth component on a graphical window (e.g., 56, 58, 66, etc.) on the GUI 32.

At Step 120, the estimated execution position for the electronic order is dynamically and continually updated and graphically re-displayed in the market depth component as additional information is received from the one or more electronic trading exchanges 20, 22 for the desired electronic market, thereby allowing the market depth component to be used to implement a trading strategy for electronic trades in the desired electronic market.

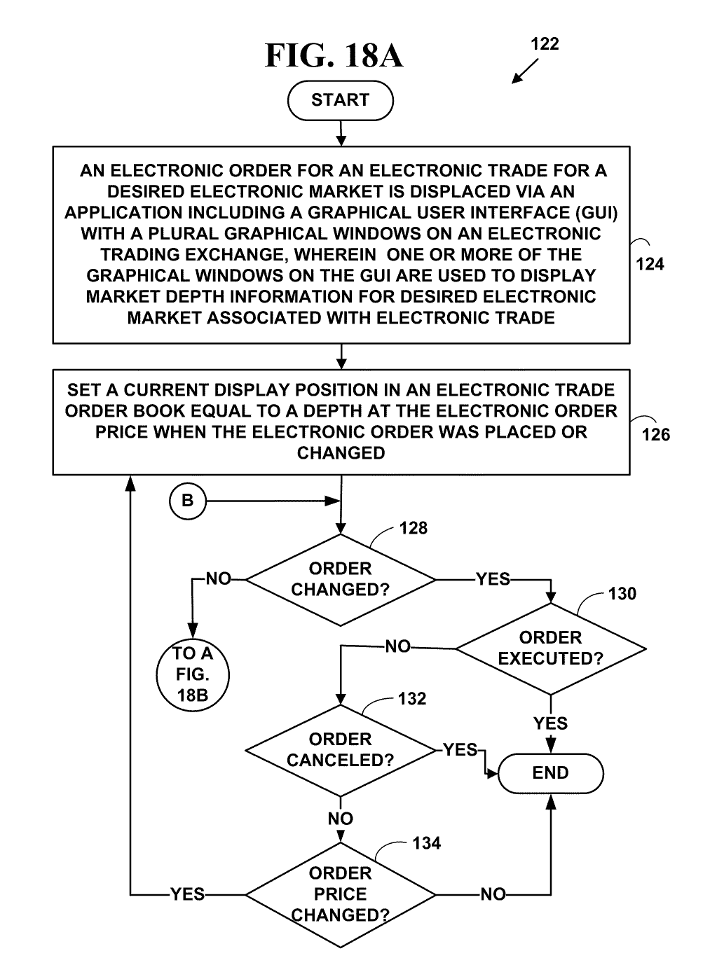

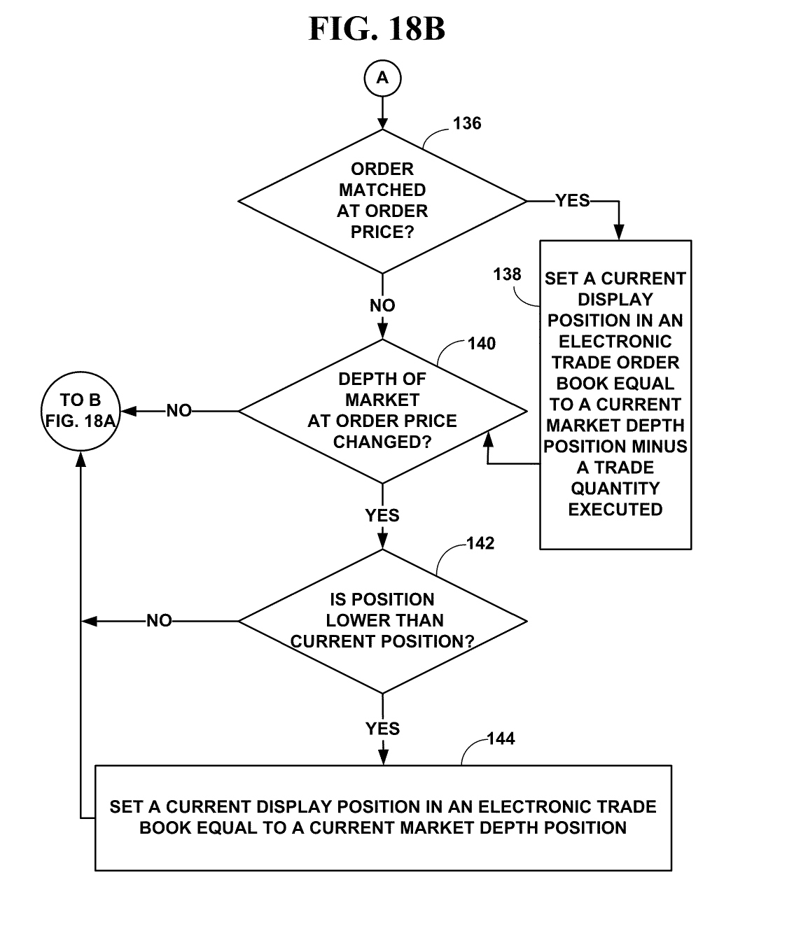

FIGS. 18A and 18B are a flow diagram illustrating a Method 122 for display of an estimated market depth execution position.

Method 122 illustrates one specific exemplary embodiment with specific exemplary display tests and display outputs to practice the invention. However, the present invention is not limited to this one specific exemplary embodiment, and other embodiments using other display tests and other display outputs can also be used to practice the invention.

In FIG. 18A at Step 124, an electronic order for an electronic trade for a desired electronic market is placed via an application including a graphical user interface (GUI) with plural graphical windows on an electronic trading exchange. One or more of the graphical windows on the GUI are used to display market depth information for desired electronic market associated with electronic trade. At Step 126, a current graphical display position in an electronic trade order book is set equal to a market depth at the electronic order price was placed or changed. At Step 128, at test is conducted to determine if the electronic order was changed. If so, at Step 130, a test is conducted to determine if the electronic order was executed. If not, at Step 132 a test is conducted to determine if the electronic order was canceled. If not, at Step 134, a test is conducted to determine if a desired execution price for the electronic order has changed. If so, a loop is executed to repeat Step 126.

Returning to Step 128, if the electronic order was not changed, in FIG. 18B at Step 136 a test is conducted to determine if a desired execution price for the electronic order was matched on an electronic trading exchange to execute the electronic order. If so, at Step 138, a current graphical display position in an electronic trade order book is set equal to a current market depth position minus a trade quantity matched and executed for the electronic trade. If not, at Step 140 a test is conducted to determine if a market depth at a desired execution price level for the electronic order has changed. If not, a loop is executed to repeat Step 128 of FIG. 18A. If so, a test is conducted at Step 142 to determine if a current graphical display position in an electronic trade order book is lower than a current display position. If not, a loop is executed to repeat Step 128 of FIG. 18A. If so, at Step 144, a current graphical display position in an electronic trade open order book is set equal to a current market depth position. A loop is executed to repeat Step 128 of FIG. 18A.

In one embodiment, the various estimated execution positions for the electronic order in the desired electronic market are displayed graphically in a market depth component on a graphical window with different colors. In another embodiment, the estimated execution positions for the electronic order in the desired electronic market are displayed graphically in a market depth component on a graphical window with a single color.

The method and system described herein provide a way of indicating a given trading order's position in a market depth queue. Using the information available when the trading order is placed it is possible to determine approximately where that trading order is in the trading queue. By updating this estimate as electronic trades are executed in the market place and the market depth at which the order's price changes a continual estimate of the approximate position of the trading order in a trading queue is provided.

### Trading Electronic Options

An option is the right, but not the obligation, to buy or sell a financial instrument, futures contract, etc. at a designated strike price. For trading purposes, options are purchase to bet on the price of a futures contract to go higher or lower. There are two main types of options—calls and puts.

A “call option” is purchased if the trader feels the underlying futures price will move higher. For example, if a trader expects soybean futures prices to move higher, the trader will buy a soybean call option.

A “put option” is purchased if the trader feels the underlying futures price will move lower. For example, if a trader expects soybean futures prices to move lower, the trader will buy a soybean put option.

Options have an expiration date and last for a pre-determined period of time, Options a futures contract end before the underlying futures contract expires. The “strike price” is the price at which a trader can actually buy or sell the underlying futures contract. For example, a November $3.60 soybean option call allows a trader to buy an actual November futures soybean contract at $3.60 anytime before the option expires.

Option “Greeks” are the quantities representing the sensitivities of the price of derivatives such as options to a change in underlying parameters on which the value of an instrument or portfolio of financial instruments is dependent. The name is used because the most common of these sensitivities are often denoted by Greek letters. Collectively these have also been called the risk sensitivities, risk measures, or hedge parameters. The most common of the Greeks are the first order derivatives: Delta, Vega, Theta and Rho as well as Gamma, a second-order derivative of a value function.

“Delta” measures the sensitivity of an option's price to a change in the price of an associated underlying instrument (e.g., stock, commodities futures contract, etc.). An options delta informs a trader how much money an option will rise or fall in value with a $1 rise or drop in the underlying instrument or contract, which also translates to the amount of profit the trader will make when the underlying instrument of contract rises. This means that the higher the delta value an option has, the more it will rise with every $1 rise in the underlying instrument or contract. An option with an options delta of 0.7 is expected to rise $0.70 with a $1 rise in the underlying instrument or contract.

“Vega” measures sensitivity to volatility. Vega is a derivative of an option value with respect to a volatility of the underlying instrument or contract. Vega is typically expressed as an amount of money, an option's value will gain or lose as volatility rises or falls by 1%.

“Theta” measures a sensitivity of a value of a derivative to a passage of time, that is, the “time decay.”

“Rho” measures sensitivity to an applicable interest rate. Rho is the derivative of the option value with respect to the risk free rate. Except under extreme circumstances, the value of an option is least sensitive to changes in risk-free-interest rates. For this reason, Rho typically is the least used of the first-order Greeks.

“Gamma” measures the rate of change in the delta with respect to changes in the underlying price. Gamma is the second derivative of the value function with respect to the underlying price. Gamma is important because it corrects for a convexity of value.

An option traded on a regulated exchange (e.g., CBOE, CME, etc.) includes a contract where the terms of each option are standardized by the exchange. An option contract is standardized so that underlying asset, quantity, expiration date and strike price are known in advance. Over-the-counter options are not traded on exchanges and allow for the customization of the terms of the option contract. Exchange-traded options are also known as “listed options.” The trading application 30 is used for trading listed and unlisted electronic options.

Trading Electronic Options from a Graphical User Interface

The trading application 30 and GUI 32 described above are also used to trade electronic options. The graphical windows 46, 48, 50, 56, 58, 60, 62, 64, 66, 84, 86 all include information and input/output fields that allow electronic options to be input and traded.

Tables 12 and 13 illustrate exemplary electronic option information include with trading application 30 and graphical windows 46, 48, 50, 56, 58, 60, 62, 64, 66, 84, 86. However, the present invention is not limited to this exemplary electronic option and more, fewer and other types of electronic option information can be used to practice the invention.

TABLE 12

| 1. | Display option quotes in the Quotes window 50 | |
|---|---|---|
| | Display options quotes in the Quotes window 50. Options contracts are dragged into the grid | |
| | should display prices as with futures. | |
| 2. | Display options positions in the Positions window 60 | |
| | Display options positions in the Positions window 60. Options positions are displayed in the | |
| | Positions window 60 as they are established (as with futures positions). | |
| 3. | Display options orders in the Orders window 56 | |
| | Display options orders in the Orders window 56. Options orders are displayed in the Orders | |
| | window 56 as with futures orders. | |
| 4. | Display options fills in the Fills window 58 | |
| | Display options fills in the Fills window 58. Options fills are displayed in the Fills window 58 as | |
| | with futures orders. | |
| 5. | Execute options trades from the Order Ticket window 84 | |
| | Option “Strike Price” and “Put/Call” fields are available in the Order Ticket window 84 | |
| | These fields are active for options contracts. | |
| | A trader is able to select these fields as with any other ticket fields | |
| | A trader is able to type in either field to select Put/Call and/or Strike Price | |
| | A trader is able to select from a pull down menu for these fields | |
| | A trader is able to drag an option instrument to the Order Ticket window 84 | |
| | When an option instrument is dragged to the Ticket window, the “Exchange”, | |
| | “Instrument”, “Date”, “Put/Call”, and “Strike Price” fields is set to reflect the | |
| | dragged instrument. | |
| | Option market data is displayed as with futures contracts. | |
| | A trader is able to execute options order from the Order Ticket window 84 | |
| | Execution of options orders are handled as with futures orders. | |
| 6. | Execute options from the ABV window 66 | |
| | A trader is able to drag an instrument to the ABV window 66 | |
| | When an option instrument is dragged to the ABV window 66 the ABV window 66 is set | |
| | and will be dragged as instrument as the selected active instrument. | |
| | Option market data is displayed as with futures contracts | |
| | Traders execute options orders from the ABV window 66 | |
| | A trader is able to select these fields as with any other ticket fields | |
| | A trader is able to type in either field to select Put/Call and/or Strike Price | |
| | A trader is able to select from a pull down menu for these fields | |
| | Executions of options orders are handled as with futures orders. | |
| 7. | Display options in the Contracts window 50 | |
| | A trader is able to select options instruments from the Contracts window 50 | |
| | A trader is able to select options and options strategies from the Contracts | |
| | window. | |
| 8. | Execution of synthetic orders using Options | |
| | Traders are able to execute brackets on options instruments | |
| | Traders are able to execute trailing stops on options instruments | |
| | Traders are able to execute icebergs orders on options instruments | |
| | Traders are able to execute spreader orders on options instruments. | |
| 9. | Display options in the “Contracts” tab 50 (FIG. 4) | |
| | A trader is able to select options instruments from the Contracts window | |
| | A trader is able to select options and options strategies from the Contracts | |
| | Window. | |
| 10. | Display of options positions in the “Positions” tab 60 (FIG. 4) | |
| | A trader is able to see options positions in the “Positions” tab 60 | |
| | Options positions are displayed in the positions grid as they are established | |
| | (as with futures positions). | |
| 11. | Display of options orders in the “Orders” tab 56 (FIG. 4) | |
| | A trader is able to see options orders in the “Orders” tab 58 | |
| | Options orders are displayed in the “Orders” tab as with futures orders. | |
| 12. | Display of options fills in the “Fills” tab 58 (FIG. 4) | |
| | A trader is able to see options fills in the “Fills” tab 58 | |
| | Options fills are displayed in the “Fills” tab as with futures orders. | |
| 13. | Execute options from “Ticket” tab 84 (FIG. 4) | |
| | “Strike Price” and “Put/Call” fields are available on the Ticket tab 84 | |
| | These fields are active only for options contracts. | |
| | A trader is able to select these fields as with any other ticket fields | |
| | A trader is able to type in either field to select Put/Call and/or Strike Price | |
| | A trader is able to select from a pull down for these fields | |
| | A user is able to click the “Trade” button on the “Quotes” tab to trade a given | |
| | Option instrument. | |
| | When the “Trade” button is pressed: (1) The “Ticket” tab will be displayed; and | |
| | (2) The selected instrument will be displayed in the “Ticket” tab | |
| | User is able to click the “Trade” button on the “Contracts” tab to trade a given | |
| | instrument | |
| | When the “Trade” button is pressed: (1) The “Ticket” tab will be displayed; and | |
| | (2) The selected instrument will be displayed in the “Ticket” tab | |
| | The trader is able to execute options from the “Ticket” tab | |
| | Executions of options should be handled as with futures. | |
| 14. | Charts are displayed for options | |
| | Traders are able to view charts for options | |
| | The options charts include bar charts. | |
| 15. | Account window displays data on options | |
| | Account balance displays data for options | |
| | Positions displays data for options | |
| | Positions/Position Inquiry Detail displays data for options | |
| | Positions/Position Inquiry Detail/Transaction Detail display data for | |
| | options | |
| | Transactions displays data for options | |
| | Statements displays data for options | |
| | Prelims display data for options | |
| | Reports display data for options. | |
| 16. | Trades section displays data on options | |
| | Options information displayed in the following windows: | |
| | a. | Orders |
| | b. | Fill Detail |
| | c. | Fill Summary |
| | d. | Fills |
| | e. | Fill History |
| | f. | Fills vs. Messaging |
| | Options “symbol” is displayed as symbol\expiry\strike price\put or call | |
| | All other information is displayed as with futures contracts. | |
| | Export to Excel and Export to CSV should include options in the exported files. | |
| 17. | Reports window 86 display limits on options | |
| | Limits on options instruments are displayed in a separate section | |
| | from limits on futures | |
| | All available limits on options are displayed in the Reports window 86. | |
| 18. | Reports/Help/Contract Info | |
| | Options standard margin costs are displayed on the Contract Info page. | |
| 20. | GMI Commodity Mappings maps options contracts | |
| | Map GMI -> contract associations for options. | |
| 22. | Risk Admin by Account sets options limits. | |
| | Limits for options are displayed in a separate section of the page from the futures limits. | |
| | The section is labeled “Options Limits” | |
| | The futures limits section is labeled “Futures Limits” | |
| | An trader is able to set limits for options contracts | |
| | A single “Save Lot Limits” button is used for both futures and options | |
| | limits. | |
| 23. | External fills is able to enter external fills on options | |
| | A trader is able to enter an external fill on an option | |
| | Call/Put and Strike Price in addition to existing information is provided. | |
| | External fills for options are handled as with external fills for | |
| | futures. | |
| 24. | Execution Reports/Position Admin displays options positions | |
| | “Symbol” for options is displayed as symbol\expiry\strike price\put or call | |
| | All other data is displayed as with futures contracts. | |
| 25. | Execution Reports/Position Summary Report include options | |
| | Option Put/Call and Strike Price are included in the reports displayed. | |
| 26. | Execution Reports/All Orders display options orders | |
| | Options “symbol” is displayed as symbol\expiry\strike price\put or call | |
| | All other information is displayed as with futures. | |
| 27. | Execution Reports/Order History display options orders history | |
| | Options “symbol” should be displayed as symbol\expiry\strike price\put or call | |
| | All other information is displayed as with futures. | |
| 28. | Execution Reports/All Fills displays options fills | |
| | Options “symbol” are displayed as symbol\expiry\strike price\put or call | |
| | All other information is displayed as with futures. | |
| 29. | Execution Reports/Fill History displays options fills | |
| | Options “symbol” should be displayed as symbol\expiry\strike price\put or call | |
| | All other information is displayed as with futures. | |
| 30. | Execution Reports/Fill volumes display fill volumes for options | |
| | Fill Volumes By Account | |
| | Options fills are counted the same as futures fills (creating a single number | |
| | made up of options fills + futures fills) | |
| | Fill Volumes By Username | |
| | Options fills are counted the same as futures fills (creating a single number | |
| | made up of options fills + futures fills) | |
| | Fill Volumes By Symbol | |
| | Options are separated from futures | |
| | Fill Volumes By Account/Symbol | |
| | Options are separated from futures | |
| | Fill Volumes By Account/Symbol/Expiry | |
| | Options are separated from futures | |
| | Fill Volumes By Account/Exchange | |
| | Options are separated from futures | |
| | Fill Volumes By Account/Exchange/Symbol | |
| | Options are separated from futures | |
| | Fill Volumes By Exchange | |
| | Options are separated from futures | |
| | Fill Volumes By Exchange/Symbol | |
| | Options are separated from futures | |
| | Fill Volumes Detail. | |
| 31. | Execution Reports/Order Ack Times display options orders | |
| | Options orders are displayed the same as futures orders. | |
| 31. | Risk Reports/Lot Limits display options limits | |
| | Options limits are displayed in a separate section from futures limits. | |
| 32. | Trader are able to execute exchange listed options for Globex based exchanges | |
| | Option trading is available on the following exchanges: | |
| | a. | CME |
| | b. | CBOT |
| | c. | NYMEX |
| | d. | COMEX |
| | e. | MGEX |
| | f. | KCBOT |
| | g. | DME |
| 33. | Traders able to execute exchange listed options for ICE based exchanges | |
| | Option trading is available on the following exchanges: | |
| | a. | ICE UK (IPE) |
| | b. | ICE US (NYBOT) |
| | c. | ICE CA (WCE) |
| 34. | Traders able to execute exchange listed options for Liffe Connect based exchanges | |
| | Option trading is available on the following exchanges: | |
| | a. | NYSE-Liffe metals |
| | b. | EuroNext-Liffe |
| | c. | EuroNext-Paris (Matif) |
| 35. | Traders able to execute exchange listed options for Eurex ETS based exchanges | |
| | Option trading is available on the following exchanges: | |
| | a. | Eurex |

| | |
|---|---|
| 36. | Traders using a API are able to execute options orders |
| | The API allows trader to execute options orders |
| | This includes the ability to execute options trading strategies. |
| 37. | Traders are able to receive positions on options positions |
| | The API allows traders to submit a position request and receive the accounts |
| | positions |
| | Provided positions include both futures and options. |

```
TABLE 13
Options Chain 192
ABV window 66
Allow user to choose the dynamic electronic option information column
(strike price 164, delta 182, gamma, etc)
    Ride off Quotes window
Greeks Chain: 210 Delta, Gamma, Rho, Theta, Vega, Implied Volatility
    Part of chain display and separate display
User defined: Fair value, variance, volatility
Options Skew
Options calculator
Multiple risk calculators:
    black-scholes, whaley, etc.
Sorting
Filtering
    Choose comparer, e.g. =, >=, <=
    e.g. Show me deltas greater than 0.45
Advanced parameters(I want to see only the 20 strikes around
at the money)
User-defined alerts/alarms basis all the above
Greeks in the ABV 66, 174, 180
Greek Spread Matrix
Strategy Builder
    N legs of option strategies
Live Links to Excel
    Prices
    Greeks
Greeks in charts
Triggers from Greeks for Order Ticket window 84, 216
Option Value finder
    User variance to sweep the option book looking for outlyers
```

FIGS. 19A and 19B are a flow diagram illustrating a Method 146 for trading electronic options via a graphical user interface.

In FIG. 19A at Step 148, one or more sets of electronic options trading information are continuously received via a communications network on an aggregate book view/ask bid volume (ABV) window of a graphical user interface (GUI) with plural graphical windows providing an electronic trading interface managed by application on a target device with one or more processors to automatically execute one or more electronic option trades on one or more electronic trading exchanges via a communications network. At Step 150, selected ones of the one or more sets of electronic option trading information are automatically displayed on the ABV window via the application, including displaying electronic option information in a dynamic option information column in a market depth format. The information displayed in the dynamic option information column is dynamically selectable and changeable based on electronic option trading preferences. The ABV window includes an order entry mode for entering an option trade near, or substantially away from a graphical option information entity displayed dynamic option information column in the market depth format. The ABV window allows entering and canceling of electronic option trading orders and automatically sending electronic option trading orders entered into the ABV window at a selected put price, call price or strike price to the one or more electronic trading exchanges. At Step 152, the dynamic option information column in the ABV window is automatically and dynamically re-centered upon a current selected graphical option information entity displayed in the dynamic option information column that continuously and dynamically changes with changes in the dynamic option information displayed. At Step 154, one or more selection inputs are received in the ABV window to move the dynamic option information column up or down for placement around a new desired selected graphical option information entity away from the current selected graphical option information entity. At Step 156, the dynamic option information column is automatically and dynamically moved in the ABV window from the new selected graphical option information entity until the current selected graphical option information entity is again re-centered on the dynamic option information column in the ABV window. At Step 158, a visual indicator is displayed in the ABV window to indicate the dynamic option information column is being automatically and dynamically re-centered in the ABV window. The visual indicator changes colors during the automatic and dynamic re-centering. At Step 160, one or more electronic option trades are automatically executed using one or more electronic option trading orders entered from the ABV window via the application on an appropriate electronic trading exchange. At Step 162, results from any automatic execution of any electronic option trades are automatically displayed in the ABV window to execute additional electronic option trades.

Method 148 is illustrated with one specific exemplary embodiment. However, the present invention is not limited to this one specific exemplary embodiment, and other embodiments using other display tests and other display outputs can also be used to practice the invention.

In such an exemplary embodiment at FIG. 19A at Step 148, one or more sets of electronic options trading information are continuously received via a communications network 18 on an aggregate book view/ask bid volume (ABV) window 66, 163, 172, 178 of a graphical user interface (GUI) 32 with plural graphical windows providing an electronic trading interface managed by application 30 on a target device 12, 14, 16 with one or more processors to automatically execute one or more electronic option trades on one or more electronic trading exchanges 20, 22 via a communications network 18.

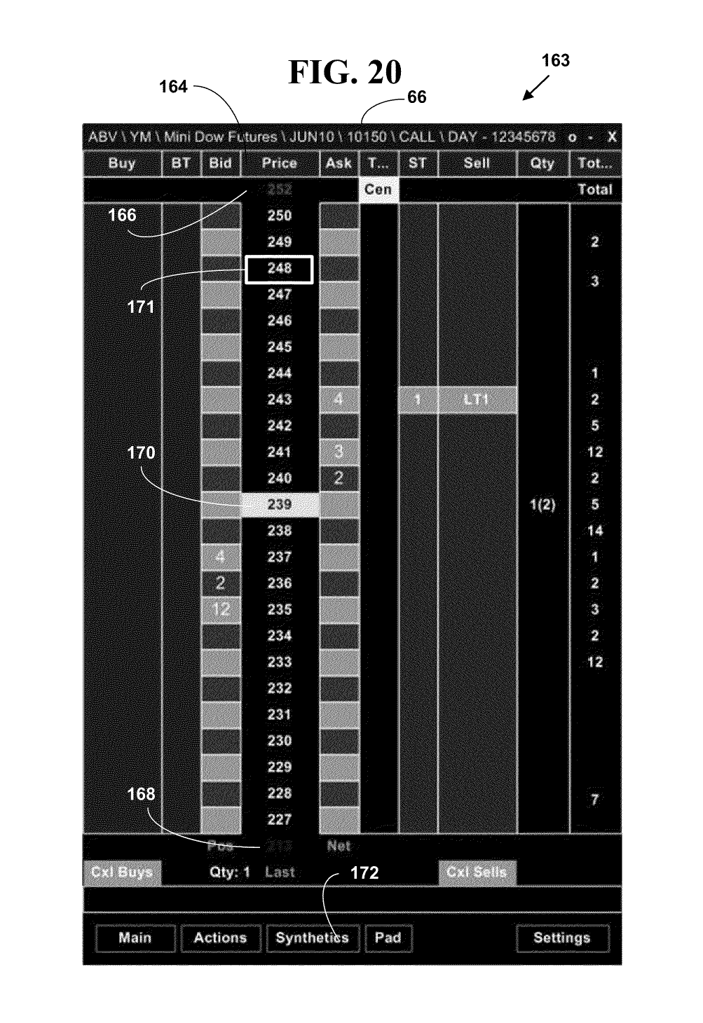

FIG. 20 is a block diagram of a screen shot 163 of an exemplary ABV window 66 used to trade electronic options with a dynamic option strike price column 164 in market depth format.

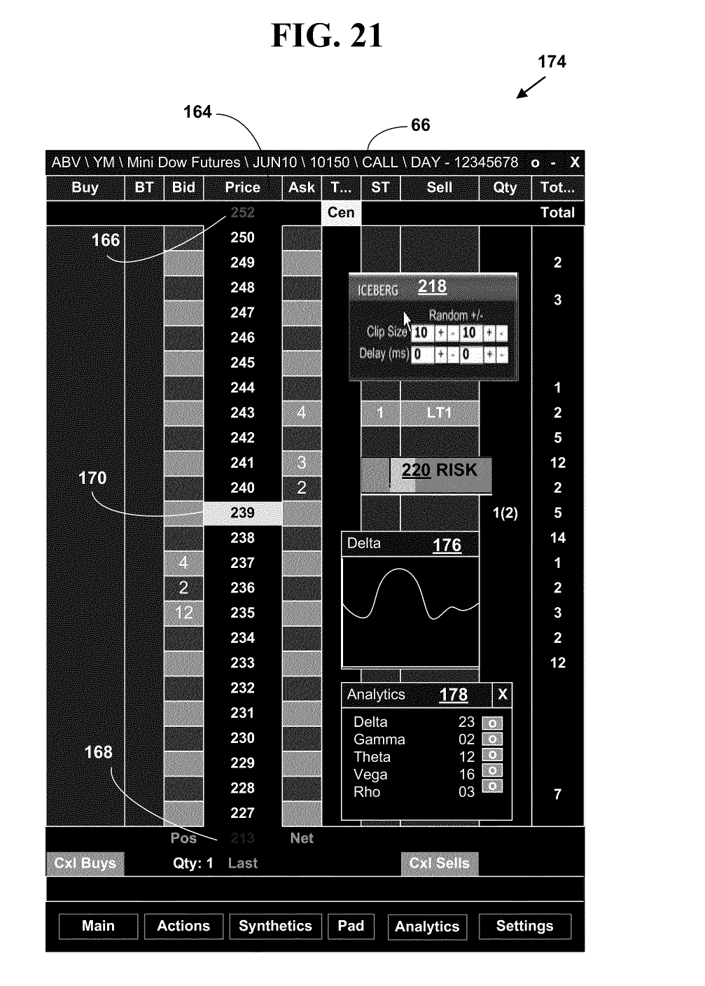

FIG. 21 is a block diagram of a screen shot 174 of an exemplary ABV window 66 used to trade electronic options with a dynamic option strike price column 164 and additional option Greek display information 176, 178.

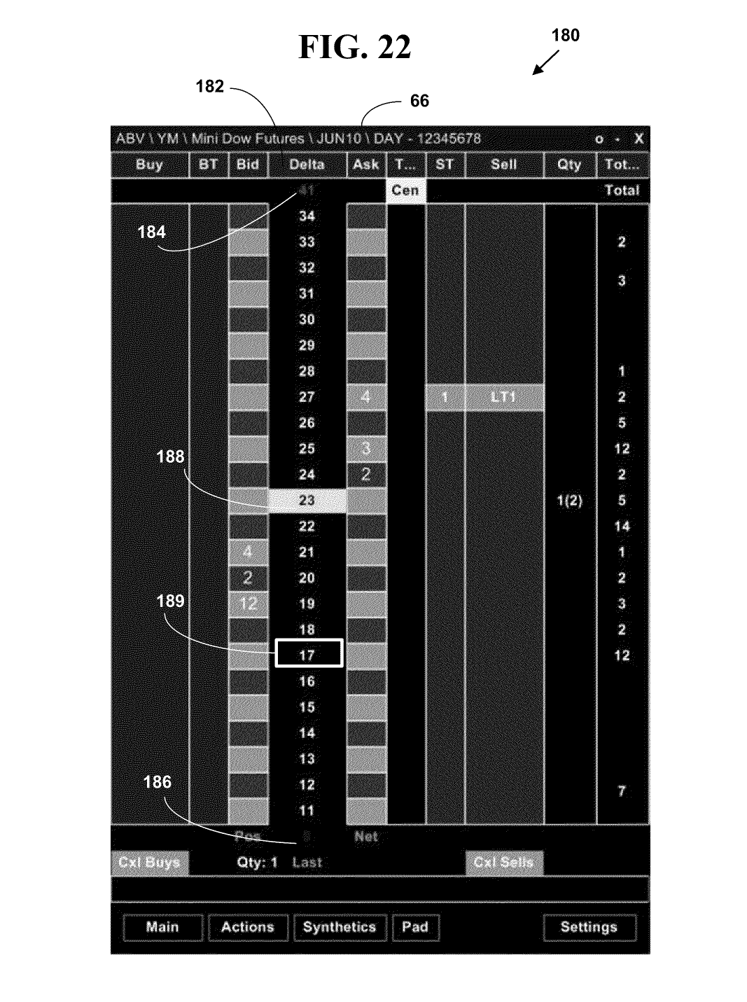

FIG. 22 is a block diagram of a screen shot 180 of an exemplary ABV window 66 used to trade electronic options with a dynamic delta column 182 in market depth format.

Returning to FIG. 19A at Step 150, selected ones of the one or more sets of electronic option trading information are automatically displayed on the ABV window 66, 164, 182 via the application 30, including displaying electronic option information in a dynamic option information column 68 in a market depth format.

The information displayed in the dynamic option information column 68, 164, 180, is dynamically selectable and changeable based on electronic option trading preferences.

In one embodiment of the invention, the dynamic option information column 68 164, 182 includes a dynamic strike price column 164, dynamic Greek option information column including a dynamic Delta 180, Vega, Theta, Rho or Gamma dynamic column. For simplicity, only an ABV window 66 with dynamic option Delta column 180 is illustrated in the figures. However, the other Greek option information is displayed in a similar format with a different name for the Greek option information displayed in the dynamic option information column.

The ABV window 66 includes an order entry mode for entering an option trade near, or substantially away from a graphical option information entity displayed dynamic option information column 68 in the market depth format. The ABV window 66 allows entering and canceling of electronic option trading orders and automatically sending electronic option trading orders entered into the ABV window 66 at a selected put price, call price or strike price to the one or more electronic trading exchanges 20, 22.

Returning to FIG. 19B at Step 152, the dynamic option information column 68, 164, 182 in the ABV window 66 is automatically and dynamically re-centered upon a current selected graphical option information entity (e.g., current strike price 170, Delta 188, etc. displayed in the dynamic option information column 68 that continuously and dynamically changes with changes in the dynamic option information displayed.

At Step 154, one or more selection inputs are received in the ABV window 66 to move the dynamic option information column 68, up or down for placement around a new desired selected graphical option information entity (e.g., cells 171, 189 FIGS. 20 and 22, etc.) away from the current selected graphical option information entity (e.g., cells 170, 188, FIGS. 20 and 22, etc.)

At Step 156, the dynamic option information column 68, 164, 182 is automatically and dynamically moved in the ABV window 66 from the new selected graphical option information entity 171, 189 until the current selected graphical option information entity 170, 188 is again re-centered on the dynamic option information column in the ABV window 66.

At Step 158, a visual indicator is displayed in the ABV window 66 to indicate the dynamic option information column is being automatically and dynamically re-centered in the ABV window 66. The visual indicator changes colors during the automatic and dynamic re-centering.

All of the functionality described for electronic trading for ABV 66 is also available for trading electronic options. FIG. 20 illustrates a dynamic price column 68, including a dynamic strike price column 164. A strike price in red is the daily high 166 for option trading. A strike price shown in blue is the daily low 168 for option trading. The last traded option strike price 170 is also highlighted on the dynamic strike price column 164. When there has been an uptick in this option strike price, this cell will be green. When there has been a downtick in this option strike price, this cell will be red. If there has been no change in the option trading strike price, this cell will appear yellow. Synthetic options can also be created and displayed with graphical button 172.

FIG. 22 illustrates a dynamic options delta column 182. An option delta in red is the daily high 184 for option trading. An option delta shown in blue is the daily low 186 for option trading. The last traded option delta 168 is also highlighted on the dynamic options delta column 182. When there has been an uptick in this option price, this cell will be green. When there has been a downtick in this option price, this cell will be red. If there has been no change in the option trading price, this cell will appear yellow.

Returning to FIG. 19B at Step 160, one or more electronic option trades are automatically executed using one or more electronic option trading orders entered from the ABV window 66, 163, 180 via the application 30 on an appropriate electronic trading exchange 20, 22.

At Step 162, results from any automatic execution of any electronic option trades are automatically displayed in the ABV window 66, 163, 180 to execute additional electronic option trades.

In one embodiment, electronic option Greek calculation information, including one or more of Vega, Theta or Rho and Gamma option information in one or more other graphical windows (e.g., FIG. 21, items 176, 178, etc.) associated with the ABV window 66, 163, 180. The electronic option Greek calculation information is displayed alpha numerically (e.g., item 178, etc.) and/or graphically (e.g., item 176, etc.). FIG. 21 illustrates a graphical display 176 of Delta values. However, the present invention is not limited to this embodiment and other electronic option Greek values can also be displayed. In addition, the additional graphical windows 176, 178 are displayed within the ABV window 66, 174. However, the present invention is not limited to such an embodiment and the additional graphical windows 176, 178 can be displayed or over layed upon other graphical windows 46, 48, 50, 56, 58, 60, 62, 64, 66, 84, 86 and/or in other portions of the GUI 32.

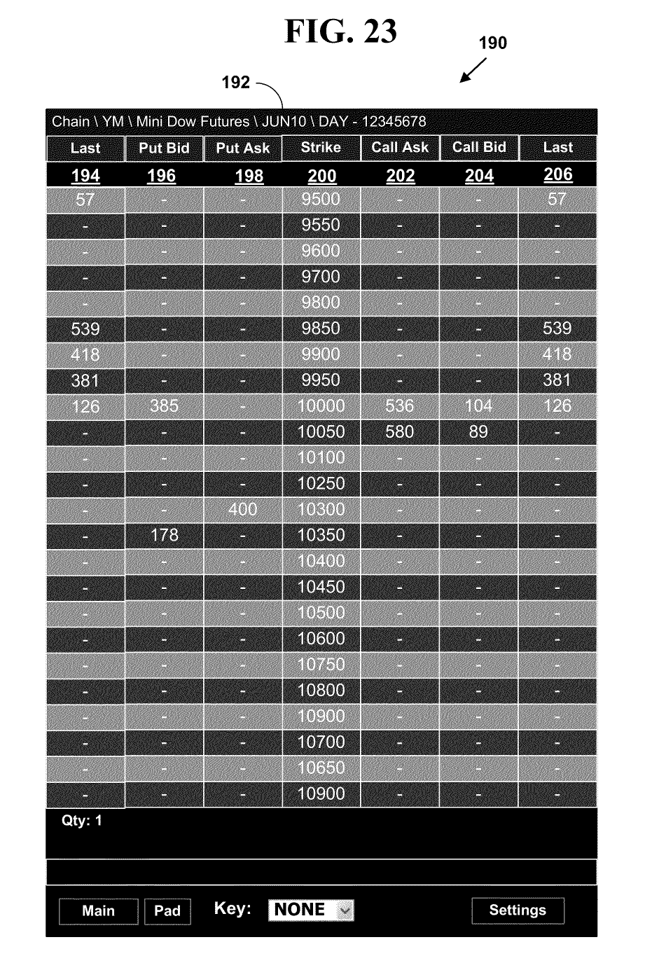

FIG. 23 is a block diagram of a screen shot 190 of electronic option chain information in an exemplary graphical window 192.

In one embodiment, the graphical window 192 is a separate graphical window. In another embodiment the graphical window 192 is integral to the ABV window 66, 163, 180. However, the present invention is not limited to such an embodiment and other embodiments can also be used to practice the invention.

In one embodiment, the ABV window 66, 163, 180 include a graphical window to display a “chain” of electronic option information. A chain of electronic option information comprises electronic option information, including, but not limited to, last traded bid price 194, put bid 196, put ask 198, option strike prices 200 in a dynamic price column, call ask 202, call bid 204 and a last traded call price 206.

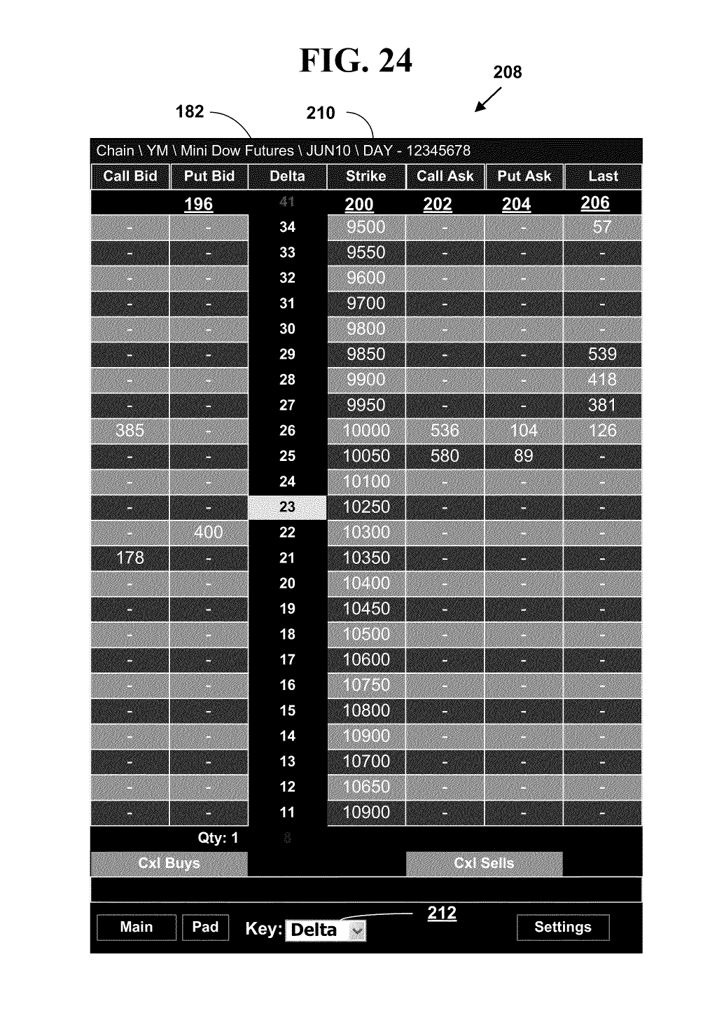

FIG. 24 is a block diagram of a screen shot 208 of electronic option Greek chain information in an exemplary graphical window 210.

In one embodiment, the graphical window 210 is a separate graphical window. In another embodiment the graphical window 210 is integral to the ABV window 66, 163, 180. However, the present invention is not limited to such an embodiment and other embodiments can also be used to practice the invention.

In one embodiment, the ABV window 66, 163, 180 displaying include a “chain” of electronic option Greek information comprising Greek calculation information including a Delta, Vega, Theta, Rho or Gamma option information. The electronic option Greek information displayed is dynamically selectable with a graphical button 212 based on electronic option trading preferences. In such an embodiment, the window 210 includes a dynamic electronic option information column. FIG. 24 illustrates only a dynamic electronic Greek Delta 184 information column. The dynamic electronic option information column, when selected with button 212 automatically and dynamically replaces one of the other columns 194-206. For example, the dynamic Greek Delta column 184 replaced the put ask column 198 when it was selected with button 212. However, the present invention is not limited to such an embodiment and the additional graphical windows 176, 178 can be displayed within and/or over layed upon other graphical windows 46, 48, 50, 56, 58, 60, 62, 64, 66, 84, 86 and/or in other portions of the GUI 32.

FIG. 25 is a block diagram of screen shot 214 of an exemplary Order Ticket window 84 including electronic option order input information.

FIG. 25 illustrates an electronic Option Order Ticket window 216 including a graphical window 176 for alpha numeric Greek information for electronic options trading, a graphical window 178 for graphically display Greek information (e.g., Delta 176) and a graphical window 218 for displaying electronic option Iceberg trading information. The display of windows 176, 178, 218 is dynamically selectable and configurable based on electronic trading preferences.

An “Iceberg trading order” is an order to buy or sell a large amount of options, securities, instruments or commodities futures contracts in smaller quantities. Iceberg orders are often executed using an application 30 that executes each tranche (i.e., a number of related securities or contracts offered as part of the same transaction) in a pre-determined order at certain pre-determined times. Institution investors and/or electronic traders may use Iceberg orders to hide a whole trading order so that other electronic traders do not see a sudden increase in trading activity for an option, security, instrument or contract, which would likely cause a fluctuation in price. The term comes from the observation of a tip of an iceberg above the water, which only reveals a small part of the full iceberg.

In another embodiment, the electronic Option Order Ticket window 216 is displayed in the ABV window 66, 163, 180.

In one embodiment, the ABV window 66, 163, 180 is replaced with a graphical Contracts 50, Order 56, Fills 58, Positions 60, 62, 64 and/or specialized Options graphical window 192, 210, 216 to conduct electronic option trading.

In one embodiment, electronic option trading preferences are dynamically selectable and configurable only from ABV window 66, 163, 180. In another embodiment, electronic option trading preferences are dynamically selectable and configurable based on electronic trading preferences from any graphical windows 46, 48, 50, 56, 58, 60, 62, 64, 66, 84, 86, 163, 174, 182, 192, 210, 216 described herein and displayed on the GUI 32.

In one embodiment, the Order Ticket window 84 is linked to the ABV window 66, 163, 180 and other electronic options windows 182, 192, 210, 216, etc. that when inform in change a first window, the changes are automatically updated in one or more or all other linked windows.

### Providing Risk Management Assessment for Electronic Option Trading

“Risk management” is the discipline of identifying, monitoring and limiting risks. Risk management methodologies typically consist of a number of analysis steps, including but not limited to, identifying critical assets, identifying, characterizing, and assessing threats to the identified assets, assessing the vulnerability of critical assets, identifying ways to reduce vulnerability of critical assets, creating a risk management strategy and prioritizing risk reduction measures.

The risk management strategies include, but are not limited to, transferring the risk to another party, avoiding the risk, reducing the negative effect of the risk, and accepting some or all of the consequences of an existing risk. In ideal risk management, a prioritization process is followed whereby the risks with the greatest loss and the greatest probability of occurring are handled first, and risks with lower probability of occurrence and lower loss are handled in descending order.

Once risks have been identified and assessed, techniques to manage the risk typically fall into one or more major categories including, but not limited to, risk avoidance, risk reduction, risk transfer and/or risk retention.

Risk management is used for electronic trading to identify and mitigate risks associated with electronic trading. Risk management is analyzed at plural levels, including but not limited to, a trader, broker, trading firm, fund manager, trading exchange level, etc.

For example, trading of commodities futures contracts is a zero sum transaction wherein there is a winner and a loser for every trade and trades are reconciled daily. An electronic trader typically opens a trading account (also called a “margin account”) with a certain minimum amount of trading capital with one or more brokers who provide the ability for the electronic trader to execute electronic trades on one or more trading exchanges.

A “margin” is collateral that the holder of a trading position (e.g., electronic trader, etc.) in securities, options, or futures contracts has to deposit to cover the credit risk of his/her broker. This risk can arise if the electronic trader has borrowed cash from the broker to buy securities or options, sold securities or options short, or entered into a futures contract, etc. Risk management typically includes evaluating not only electronic trading activities, but also margin values for one or more margin accounts held by the electronic trader.

If an electronic trader is trading a commodity contract, and has bought the contract expecting the price of the commodity to rise, the trader may lose money if the price of the commodity declines. Theoretically, the trader's risk of loss is limited only by the price of the commodity going to zero, the point at which the trader has lost all of his/her money.

If a trader sells a commodity contract short expecting the price of the commodity to decline, the trader will lose money if the price of the commodity goes up. The risk of loss is theoretically unlimited because there is no absolute ceiling on how high the price of the commodity can go.

Risk management is important not only for an electronic trader, but for brokers, trading firms, fund managers, trading exchanges and other entities involved in electronic trading and other types of electronic and non-electronic (e.g., open outcry, etc.) trading.

A “commodity broker” is a firm or individual who executes orders to buy or sell commodity contracts on behalf of clients and charges them a commission. A firm or individual who trades for his/her own account electronically via a commodity broker (or other broker) is called an “electronic trader.” Commodity contracts include futures, options, and similar financial derivatives. Clients who trade commodity contracts are either hedgers using the derivatives markets to manage risk, or speculators who are willing to assume that risk from hedgers in hopes of a profit.

Other types of brokers include Futures Commission Merchants (FCMs), Independent Introducing Brokers (IIBs), Guaranteed Introducing Brokers (GIBs), Foreign Introducing Brokers (FIBs), Commodity Trading Advisors (CTAs), Commodity Pool Operators (CPOs) Broker-Dealers (B/Ds) and other types of brokers.

The present invention presents a solution to manage risk for electronic option trading. One of the benefits of this solution is the ability to capture information about an options trade independent of the source of execution of the trade. The option trade execution could be electronic execution by the electronic trader, a broker executed trade, an open outcry trading floor based trade or a walk-in trade.

The present invention also provides risk management by looking at an electronic option's trader via an “integrated viewpoint.” The present invention aggregates an electronic option trader's activities across all their trading accounts, their current and historical trades and trade locations on all trading exchanges (e.g., Chicago Board of Trade (CBOT), New York Stock Exchange (NYSE), NASDAQ, Tokyo Stock Exchange (TSE), London International Financial and Futures Options Exchange (LIFFE), etc.) and values of all their margin capital accounts for both electronic option trades and non-electronic option trades.

In one embodiment, the integrated viewpoint is displayed graphically 220 (FIG. 21). In another embodiment, the integrated viewpoint is displayed other than graphically.

In one embodiment, the integrated viewpoint is displayed graphically 220 (FIG. 21) in an ABV 66, 163, 180 window. In another embodiment, the integrated viewpoint is displayed graphically 220 (FIG. 21) is displayed in other than an ABV window.

The graphical user interface includes various types of multi-color line graphs, bar graphs, 220 etc. all displaying risk assessments in various formats in multiple graphical user interface windows. In one embodiment, the graphical user interface may include a risk management graphical meter 220 wherein real-time risk assessments are displayed in green area when risk assessments are within less than some percentage of a pre-determined risk threshold (e.g., less than 10%, etc.), a yellow area when risk assessments are greater than some percentage of the pre-determined risk threshold (e.g., zero to 9%, etc.) and a red area when the pre-determined risk threshold has been exceeded and a risk trading alert has been issued. However, the present invention is not limited to this embodiment and other embodiments and other risk management and assessment displays can be used to practice the invention.

Electronic Trading with Smart Phones and Tablet Computers

The present invention includes electronic trading via smart phones and tablet computers 12, 14, 16. In one embodiment the trading application 30 is a smart network device application 30 and/or a smart phone application 30 that displays graphical windows 46, 48, 50, 56, 58, 60, 62, 64, 66, 84, 86, 163, 174, 182, 192, 210, 216 described herein on the GUI 32 on a smart phone display. The smart network device application 30 uses one or more APIs to interact with operating systems on the smart phone and/or tablet computers 12, 14, 16. In such an embodiment, an electronic trader can request execution of electronic trades directly from the smart phone and/or tablet computer 12, 14, 16. Smart network device application 30 is used on the tablet computers illustrated as well.

In another embodiment, the trading application 30 is a smart network device application 30 that interacts with a bar code reader application. In another embodiment the smart network device application 30 that interacts with an alphanumeric trade reader application. In on embodiment the bar code reader application and/or the alphanumeric trade reader application are integral to the smart network device application 30. In another embodiment, the bar code reader application 31 and/or the alphanumeric trade reader application 33 are separate applications. In one exemplary embodiment, a portion of the smart network device application 30 is executed on a server network device 24 with one or more processors using the communications network 18. However, the present invention is not limited to these embodiments and other embodiments may be used to practice the invention.

A “barcode” is an optical machine-readable representation of data, which shows data about the object to which it attaches. Originally, barcodes represented data by varying the widths and spacings of parallel lines, and may be referred to as linear or 1 dimensional (1D). Later they evolved into rectangles, dots, hexagons and other geometric patterns in 2 dimensions (2D). Although 2D systems use a variety of symbols, they are generally referred to as barcodes as well. Barcodes originally were scanned by special—optical scanners called barcode readers, scanners and interpretive software are available on devices including desktop printers and smart phones 12, 14, 16.

Table 14 illustrates exemplary linear barcodes, the standards of all of which are incorporated by reference. However, the present invention is not limited to the exemplary linear barcodes listed in Table 14, and more fewer and other linear barcodes can also be used to practice the invention.

TABLE 14
Linear Bar Codes

U.P.C.
Codabar
Code 25 - Non-interleaved 2 of 5
Code 25 - Interleaved 2 of 5
Code 39
Code 93
Code 128
Code 128A
Code 128B
Code 128C
Code 11
CPC Binary
DUN 14
EAN 2
EAN 5
EAN 8, EAN 13
Facing Identification Mark
GS1-128 (formerly known as UCC/EAN-128), incorrectly referenced
as EAN 128 and UCC 128
GS1 DataBar, formerly Reduced Space Symbology (RSS)
HIBC (HIBCC Health Industry Bar Code)
ITF-14
Latent image barcode
Pharmacode
Plessey
PLANET
POSTNET
Intelligent Mail barcode
MSI
PostBar
RM4SCC/KIX
JAN
Telepen

Table 15 illustrates exemplary matrix (2D) barcodes, the standards of all of which are incorporated by reference. However, the present invention is not limited to the exemplary matrix barcodes listed in Table 15, and more fewer and other matrix barcodes can also be used to practice the invention.

TABLE 15
Matrix Bar Codes

3-DI
ArrayTag
Aztec Code
Small Aztec Code
Chromatic Alphabet
Codablock
Code 1
Code 16K
Code 49
ColorCode
Compact Matrix Code
CP Code
CyberCode
d-touch
DataGlyphs
Datamatrix
Datastrip Code
Dot Code A
EZcode
Grid Matrix Code
High Capacity Color Barcode
HueCode
INTACTA.CODE
InterCode
JAGTAG
Lorem ipsum
MaxiCode
mCode
MiniCode
MicroPDF417
MMCC
Nintendo e-Reader#Dot code
Optar
PaperDisk
PDF417
PDMark
QR Code
QuickMark Code
SmartCode
Snowflake Code
ShotCode
SPARQCode
SuperCod
Trillcode
UltraCode
UnisCode
VeriCode, VSCode
WaterCode

In one embodiment, the smart network device application 30 interacts with a bar code reader application 31. However, the present invention is not limited to a bar code reader application 31 and other applications can also be used to practice the invention.

In such an embodiment, an electronic trader uses a bar code generator application to generate a bar code for a desired trade. For example, the electronic trader may generate a bar code to “buy 10 contracts of November soybeans at $15.83.” In another embodiment, the bar code is obtained from a web-site of a trading exchange, broker, etc. In another embodiment, one or more bar codes for one or more desired trades are displayed in the ABV window 66 on the smart phone target network device 12, 14, 16. However, the current invention is not limited to such embodiments and other embodiments can be used to practice the invention.

In one specific exemplary embodiment, the smart network device application 30 interacts with a QR code reader application 31. However, the present invention is not limited to a QR code reader application and other bar coder reader applications can also be used to practice the invention.

FIG. 26 is a block diagram 222 illustrating ABV window 66 displayed on smart phone 16 (e.g., Apple iPhone, etc.). Electronic trades are executed with smart network device application 30 from the ABV window 66 with the smart phone 16.

FIG. 27 is a block diagram 224 illustrating an ABV window 66 with options information 163 displayed on a tablet computer 14 (e.g., Apple iPad, etc.). Electronic option trades are executed with smart network device application 30 from the ABV window 66 on the tablet computer 14.

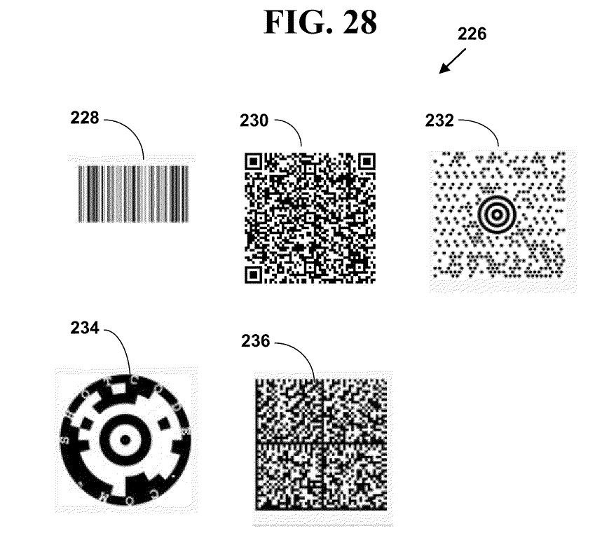

FIG. 28 is a block diagram 226 illustrating exemplary bar codes 228-236. These bar codes include a Code 93 barcode 228, a QR Code barcode 230, a Maxicode barcode 232, a ShotCode bar code 234 and a Lorem ipsum bar code 236. However, more fewer and other types of bar codes can be used to practice the invention.

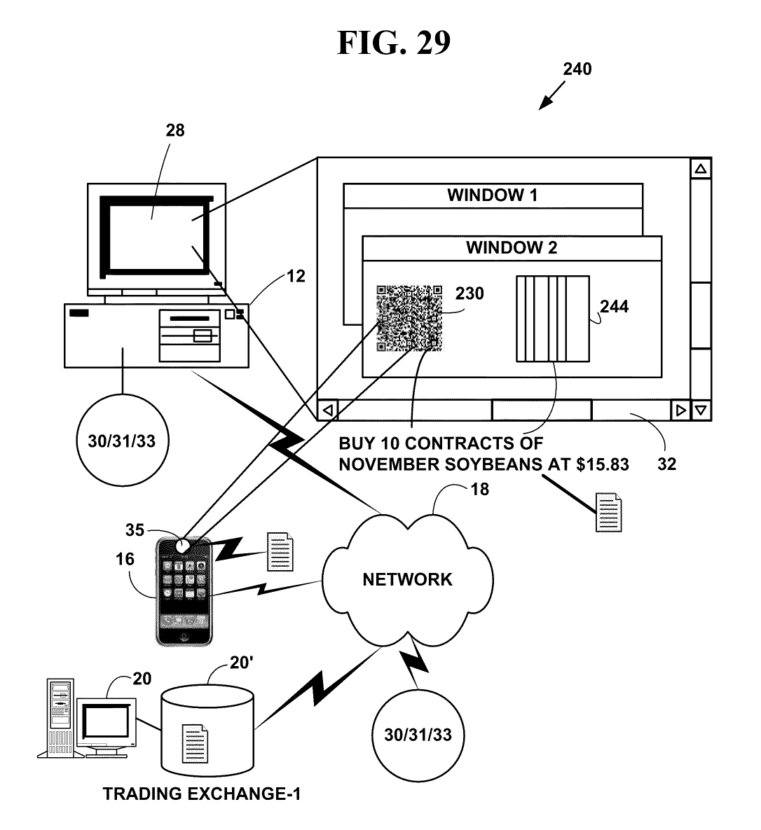

FIG. 29 is a block diagram 242 illustrating display of an exemplary QR bar code 230 on a display component 28. The QR bar code 230 is exemplary only and does not include any actual information related to electronic trading.

“A QR Code” 230 is a specific matrix barcode (or two-dimensional code), readable by dedicated QR barcode readers and camera phones. The code consists of black modules arranged in a square pattern on a white background. The information encoded can be text, URL or other data. QR codes are defined in ISO/IEC 18004:2006 Information technology—Automatic identification and data capture techniques—QR Code 2005 bar code symbology specification, 1-Sep.-2006, the contents of which are incorporated by reference.

Users with a camera equipped smart phone 16 (or tablet computer 14, etc.) with a the camera component, a bar code reader application 31 appropriate for the bar code processes the digital image of the QR Code 230 to extract one or more electronic trading orders.

QR codes can also be used to display text, contact information, connect to a wireless network, open a web page in the phone's browser or initiate a communications event over the communications network 18 (e.g., voice call, data call, etc.) This act of linking from physical world objects is known as a “hardlink” or “physical world hyperlinks.”

Google's smart phone Android operating system supports the use of QR codes by natively including the barcode scanner (e.g., Zxing, etc.) on some models, and the browser supports Uniform Resource Identifier (URI) redirection, which allows QR Codes to send metadata to existing applications on the device. Nokia's Symbian operating system is also provided with a barcode scanner, which is able to read QR codes, while mbarcode is a QR code reader for the Maemo operating system. In the Apple iOS, a QR code reader is not natively included, but hundreds of free applications available with reader and metadata browser URI redirection capability.

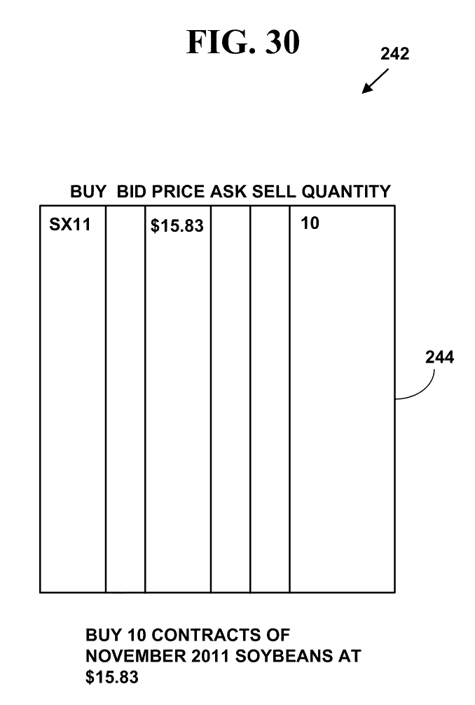

FIG. 30 is a block diagram 242 illustrating an exemplary alphanumeric trade layout 244. In one embodiment, the alphanumeric trade layout 244 is identical to the columns in the ABV window 66 or other trading window (e.g., order entry window 56, not illustrated in FIG. 29). In another embodiment, the alphanumeric trade layout 244 includes a layout used on cardboard cards by electronic traders in open outcry trading pits on a trading exchange. In such exemplary embodiments, the familiar layout 244 allows an electronic trader to quickly and efficiently write down on paper or on another electronic device or network device one more desired electronic trades. However, the present invention is not limited to such embodiments and other embodiments and layouts may be used to practice the invention.

In such exemplary embodiments, an electronic trader writes out a trading order for one or more electronic trades by hand using layout 244. A digital image of the alphanumeric trading layout 244 is obtained with the camera component 35 on the smart phone target network device 16. In another such exemplary embodiment, an electronic trader creates a digital image of one or more electronic trades from a display component of another network device (e.g., a display screen of a computer 12, another smart phone or another mobile phone, etc. However, the present invention is not limited to the exemplary layout presented and other layouts can be used to practice the invention and the layout can be obtained from other sources to practice the invention.

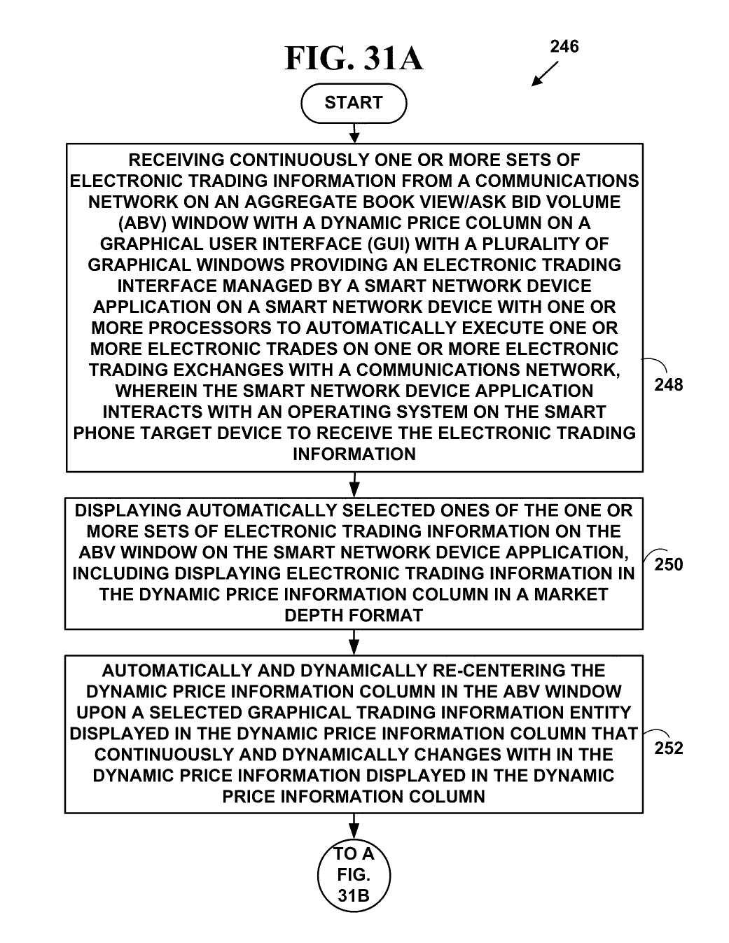

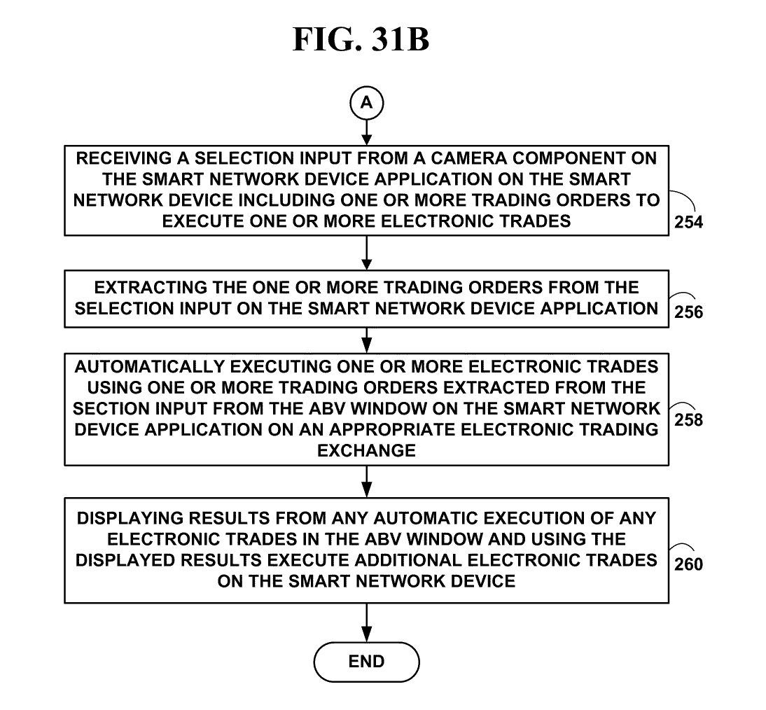

FIGS. 31A and 31B are a flow diagram illustrating a Method 246 for electronic trading options via a graphical user interface on a smart phone 16 and/or a tablet computer 14.

In FIG. 31A at Step 248, one or more sets of electronic trading information are continuously received from a communications network on an aggregate book view/ask bid volume (ABV) window with a dynamic price column on a graphical user interface (GUI) with plural graphical windows providing an electronic trading interface managed by a smart network device application on a smart phone target network device with one or more processors to automatically execute one or more electronic trades on one or more electronic trading exchanges with a communications network. The smart network device application interacts with an operating system on the smart phone target device to receive the electronic trading information. At Step 250, selected ones of the one or more sets of electronic trading information are automatically displayed on the ABV window on the smart network device application, including displaying electronic trading information in the dynamic price information column in a market depth format. At Step 252, the dynamic price information column is automatically re-centered in the ABV window upon a selected graphical trading information entity displayed in the dynamic price information column that continuously and dynamically changes with in the dynamic price information displayed in the dynamic price information column. In FIG. 31B at Step 254, a selection input is received from a camera component on the smart network device application on the smart phone target network device including one or more trading order to execute one or more electronic trades. At Step 256, the one or more trading orders are extracted from the selection input on the smart network device application. At Step 258, one or more electronic trades are automatically executed using the one or more trading orders extracted from the selection input from the ABV window on the smart network device application on an appropriate electronic trading exchange. At Step 260, results are displayed from any automatic execution of any electronic trades in the ABV window and displayed results are used to execute additional electronic trades on the smart phone target network device.

Method 246 is illustrated with one specific exemplary embodiment. However, the present invention is not limited to this one specific exemplary embodiment, and other embodiments using other display tests and other display outputs can also be used to practice the invention.

In such an exemplary embodiment at Step 248 in FIG. 31A, one or more sets of electronic trading information are continuously received from a communications network 18 on an aggregate book view/ask bid volume (ABV) window 66 with a dynamic price column 68 on a graphical user interface (GUI) 12 with plural graphical windows 46, 48, 50, 56, 58, 60, 62, 64, 66, 84, 86, 163, 174, 182, 192, 210, 216 providing an electronic trading interface managed by a smart network device application 30 on a smart network device 14, 16 with one or more processors to automatically execute one or more electronic trades on one or more electronic trading exchanges 20, 22 with the communications network 18. The smart network device application 30 interacts with an operating system on the smart phone target device 16 to receive the electronic trading information.

At Step 250, selected ones of the one or more sets of electronic trading information are automatically displayed on the ABV window 66 on the smart network device application 30, including displaying electronic trading information in the dynamic price information column 68 in a market depth format.

In one specific exemplary embodiment, the ABV window includes electronic option information 163, 174, 180, 190, 208 used to trade electronic options with a dynamic option strike price column in market depth format. the one or more electronic trades include one or more electronic option trades. However, the present invention is not limited to such an embodiment non-electronic option and other windows can also be used to practice the invention.

At Step 252, the dynamic price information column 68 is automatically re-centered in the ABV window 66 upon a selected graphical trading information entity displayed in the dynamic price information column 68 that continuously and dynamically changes with in the dynamic price information displayed in the dynamic price information column 68.

In FIG. 31B at Step 254, a selection input is received from a camera component 35 on the smart network device application 30 on the smart network device 14, 16 including one or more trading order to execute one or more electronic trades.

In one embodiment, the camera component 35 on the smart network device application 30 on the smart network device 14, 16 receives a digital image of a bar code (e.g., 230, etc.) or a digital image of an alphanumeric trading order (e.g., 242, etc.).

In one exemplary embodiment, the bar code includes a linear or a two-dimensional (2D) bar code. In one specific exemplary embodiment, the 2D bar code includes a QR bar code 230.

In one exemplary embodiment, the digital image of an alpha numeric trading order includes a digital image of an alphanumeric trading order in a pre-determined layout format 244. In another exemplary embodiment, the alphanumeric trading order includes an alphanumeric trading order on a piece of paper or an alphanumeric trading order on a display component (e.g., 28) of another network device (e.g. 12, etc.) (e.g., FIG. 30).

However, the present invention is not limited to these exemplary embodiments described for Step 254, and other embodiments can be used to practice the invention.

At Step 256, the one or more trading orders are extracted from the selection input on the smart network device application 30. In one exemplary embodiment, Step 256 includes determining whether the digital image in the selection input is a bar code or an alphanumerical trading order and extracting electronic trading information from the digital image including the bar code or alphanumerical trading order.

In one embodiment, the smart network device application 30 interacts with an external bar code reader application 31. In another embodiment the smart network device application 30 interacts with an external alphanumeric trade reader application 33. In on embodiment the bar code reader application 31 and/or the alphanumeric trade reader application 33 are integral to the smart network device application 33. However, the present invention is not limited to the application described and other applications and other combinations of applications can be used to practice the invention.

In another exemplary embodiment, the digital image may include other than a bar code or alphanumeric trading order in a pre-determined layout.

In one embodiment, Step 256 further includes entering an electronic trading order in the ABV window 66 with an order entry mode for entering a trade near, or substantially away from a graphical trading information entity displayed in the dynamic price information column 68 in the market depth format. The information displayed in the dynamic prince information column 68 is dynamically selectable based on electronic trading preferences, wherein the ABV window 66 allows entering and canceling of electronic trading orders and automatically sending electronic trading orders entered into the ABV window to the one or more electronic trading exchanges 20, 22. The dynamic price column 68 continuously and slowly moves in the order entry mode.

At Step 258, one or more electronic trades are automatically executed using the one or more electronic trading orders extracted from the selection input from the ABV window 66 on the smart network device application 30 on an appropriate electronic trading exchange 20, 22.

At Step 260, results are displayed from any automatic execution of any electronic trades in the ABV window 66 and the displayed results are used to execute additional electronic trades on the smart network device 14, 16.

In one embodiment a selection input is received on the smart network device application 30 on the smart network device 14, 16 including information for one or more trading orders to execute on one more electronic trading exchanges 20, 22. An electronic bar code (e.g., QR code 230) including the information for the one or more trading orders to automatically execute the one or more trading orders on one or more electronic trading exchanges 20, 22 when the bar code 230 is received on the on the smart network device application 30 on the smart network device 14, 16. The electronic bar code can be printed on bar, and/or sent to another network device via e-mail, text messaging, video, etc. from the smart network device 14, 16. The smart network device application 30 can receive the bar code 230 via the camera component 35 and automatically execute the one or more trading orders on one or more electronic trading exchanges. An electronic alphanumeric trading order 244 is created and used in a similar manner by smart network device application 30.

In another embodiment a selection input is received on the smart network device application 30 on a server network device 24 including information for one or more trading orders to execute on one more electronic trading exchanges 20, 22. An electronic bar code (e.g., QR code 230) including the information for the one or more trading orders to automatically execute the one or more trading orders on one or more electronic trading exchanges 20, 22 when the bar code 230 is received on the on the smart network device application 30 on the smart network device 14, 16. The electronic bar code can be printed on bar, and/or sent to another network device via e-mail, text messaging, video, etc. from the server network device 24. The smart network device application 30 can receive the bar code 230 via the camera component 35 and automatically execute the one or more trading orders on one or more electronic trading exchanges. An electronic alphanumeric trading order 244 is created and used in a similar manner by smart network device application 30.

In another embodiment, the ABV window 66 in the GUI 32 on a smart phone 16 or table computer 14 includes graphical windows with two-dimensional (2D) and three dimensional (3D) graphical objects (e.g., item 75, FIG. 12. etc.) displayed and/or a combination of 2D and 3D objects. When the 3D graphical objects are displayed on the GUI 32, they provide a more distinct graphical object that is more easily viewable and one that “pops” off the GUI 32 when viewed by a trader. The 3D objects allow a trader to more easily follow the object visually as the objects dynamically moves in the ABV window 66.

In one embodiment, 3D glasses are used to view the 3D graphical objects. In such an embodiment, the 3D graphical objects are displayed in a specialized 3D format using a 3D API. However, 3D glasses are not required to view the 3D graphical objects and the invention can be practiced without 3D glasses, the specialized 3D format or the 3D API. For example, 3D stereoscopy is used. As is known in the art, 3D stereoscopy (also called stereoscopic or 3-D imaging) is a technique capable of recording three-dimensional visual information and/or creating the illusion of depth in an image for 3D display. However, the present invention is not limited to such embodiments an 3D objects can be used without specialized 3D glasses, etc.

A method and system for electronic trading from smart phones and tablet computers is presented herein. A selection input (e.g., a bar code, alphanumeric form, etc.) is received from a camera component on a smart network device application on the smart phone or tablet including one or more trading orders to execute one or more electronic trades. The one or more trading orders are extracted from the selection input on the smart network device application. The one or more electronic trades are automatically executed using one or more electronic trading orders extracted from the selection input from an Ask Bid Volume/Aggregated Book View (ABV) window with a dynamic price column.

It should be understood that the architecture, programs, processes, methods and systems described herein are not related or limited to any particular type of computer or network system (hardware or software), unless indicated otherwise. Various types of general purpose or specialized computer systems may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams.

While various elements of the preferred embodiments have been described as being implemented in software, in other embodiments hardware or firmware implementations may alternatively be used, and vice-versa.

The claims should not be read as limited to the described order or elements unless stated to that effect. In addition, use of the term “means” in any claim is intended to invoke 35 U.S.C. §112, paragraph 6, and any claim without the word “means” is not so intended.

Therefore, all embodiments that come within the scope and spirit of the following claims and equivalents thereto are claimed as the invention.

I claim:

1. A method for electronic trading via a graphical user interface on a smart network device, comprising:
receiving continuously one or more sets of electronic trading information from a communications network on an aggregate book view/ask bid volume (ABV) window with a dynamic price column on a graphical user interface (GUI) with a plurality of graphical windows providing an electronic trading interface managed by a smart network device application on a smart network device with one or more processors to automatically execute one or more electronic trades on one or more electronic trading exchanges on the communications network, wherein the smart network device application interacts with an operating system on the smart network device to receive the electronic trading information;
displaying automatically selected ones of the one or more sets of electronic trading information on the ABV window on the smart network device application, including displaying electronic trading information in the dynamic price information column in a market depth format;
automatically and dynamically re-centering the dynamic price information column in the ABV window upon a selected graphical trading information entity displayed in the dynamic price information column that continuously and dynamically changes with in the dynamic price information displayed in the dynamic price information column;
receiving a selection input from a camera component on the smart network device application on the smart network device including one or more trading order to execute one or more electronic trades;
extracting the one or more electronic trading orders from the selection input on the smart network device application;
automatically executing one or more electronic trades using one or more electronic trading orders extracted from the selection input from the ABV window on the smart network device application on an appropriate electronic trading exchange; and
displaying results from any automatic execution of any electronic trades in the ABV window and using the display result to execute additional electronic trades on the smart network device.

2. One or more processors including a plurality of instructions in a non-transitory computer readable medium for executing steps of:
receiving continuously one or more sets of electronic trading information from a communications network on an aggregate book view/ask bid volume (ABV) window with a dynamic price column on a graphical user interface (GUI) with a plurality of graphical windows providing an electronic trading interface managed by a smart network device application on a smart network device with one or more processors to automatically execute one or more electronic trades on one or more electronic trading exchanges on the communications network, wherein the smart network device application interacts with an operating system on the smart network device to receive the electronic trading information;
displaying automatically selected ones of the one or more sets of electronic trading information on the ABV window on the smart network device application, including displaying electronic trading information in the dynamic price information column in a market depth format;
automatically and dynamically re-centering the dynamic price information column in the ABV window upon a selected graphical trading information entity displayed in the dynamic price information column that continuously and dynamically changes with in the dynamic price information displayed in the dynamic price information column;
receiving a selection input from a camera component on the smart network device application on the smart network device including one or more trading orders to execute one or more electronic trades;
extracting the one or more trading orders from the selection input on the smart network device application;
automatically executing one or more electronic trades using one or more trading orders extracted from the selection input from the ABV window on the smart network device application on an appropriate electronic trading exchange; and
displaying results from any automatic execution of any electronic trades in the ABV window and using the display result to execute additional electronic trades on the smart network device.

3. The method of claim 1, wherein the step of receiving a selection input from the camera component on the smart network device application on the smart network device further includes receiving a digital image of a bar code or a digital image of a trading order.

4. The method of claim 3 wherein the bar code includes a linear or a two-dimensional (2D) bar code.

5. The method of claim 4 wherein the 2D bar code includes a QR bar code.

6. The method of claim 3 wherein the digital image of an alphanumeric trading order includes a digital image of an alphanumeric trading order in a pre-determined layout format.

7. The method of claim 6 wherein the alphanumeric trading order includes an alphanumeric trading order on a piece of paper or an alphanumeric trading order on a display component of another network device.

8. The method of claim 1 wherein the smart network device includes a smart phone or a tablet computer.

9. The method of claim 1 when the step of extracting the one or more trading orders from the selection input on the smart network device application further includes:
determining whether the digital image in the selection input is a bar code or an alphanumerical trading order;
extracting electronic trading order information from the digital image from the bar code or alphanumerical trading order.

10. The method of claim 1 further comprising:
entering an electronic trading order in the ABV window with an order entry mode for entering a trade near, or substantially away from a graphical trading information entity displayed in the dynamic price information column in the market depth format, wherein the information displayed in the dynamic prince information column is dynamically selectable based on electronic trading preferences, wherein the ABV window allows entering and canceling of electronic trading orders and automatically sending electronic trading orders entered into the ABV window to the one or more electronic trading exchanges and wherein the dynamic price continuously and slowly moves in the order entry mode.

11. The method of claim 1 wherein the communications network is a cloud computing network.

12. The method of claim 1 wherein the communications network is a Worldwide Interoperability for Microwave Access (WiMAX) fourth generation (4G) communications network.

13. The method of claim 1 wherein the smart network device application is a smart network device application or a tablet computer application.

14. The method of claim 1 wherein the smart network device is a client network device.

15. The method of claim 1 wherein the one or more electronic trades include one or more electronic option trades.

16. The method of claim 15 wherein the ABV window includes electronic option information used to trade electronic options with a dynamic option strike price column or a dynamic option delta column market depth format.

17. The method of claim 1 wherein a portion of the smart network device application is executed on a server network device with one or more processors using the communications network.

18. The method of claim 1 further comprising:
receiving a selection input on the smart network device application on the smart network device including information for one or more trading orders to execute on one more electronic trading exchanges;
creating an electronic bar code including the information for the one or more trading orders to automatically execute the one or more trading orders on one or more electronic trading exchanges when the bar code is received on the on the smart network device application on the smart network device.

19. The method of claim 1 wherein The method of claim 1 wherein the one or more electronic trades include electronic trades for real trading instruments and contracts, synthetic trading instruments and contracts, spread trading, black box trading, yield curve trading and exchange traded funds (ETF) trading.

20. A system for electronic options trading via a graphical user interface, comprising in combination:
means for receiving continuously one or more sets of electronic trading information from a communications network on an aggregate book view/ask bid volume (ABV) window with a dynamic price column on a graphical user interface (GUI) with a plurality of graphical windows providing an electronic trading interface managed by a smart network device application on a smart network device with one or more processors to automatically execute one or more electronic trades on one or more electronic trading exchanges on the communications network, wherein the smart network device application interacts with an operating system on the smart network device to receive the electronic trading information;
means for displaying automatically selected ones of the one or more sets of electronic trading information on the ABV window on the smart network device application, including displaying electronic trading information in the dynamic price information column in a market depth format;
means for automatically and dynamically re-centering the dynamic price information column in the ABV window upon a selected graphical trading information entity displayed in the dynamic price information column that continuously and dynamically changes with in the dynamic price information displayed in the dynamic price information column;
means for receiving a selection input from a camera component on the smart network device application on the smart network device including one or more trading order to execute one or more electronic trades;
means for extracting the one or more electronic trading orders from the selection input on the smart network device application;
means for automatically executing one or more electronic trades using one or more electronic trading orders extracted from the selection input from the ABV window on the smart network device application on an appropriate electronic trading exchange;
means for displaying results from any automatic execution of any electronic trades in the ABV window and using the display result to execute additional electronic trades on the smart network device;
means for receiving another selection input on the smart network device application on the smart network device including information for one or more trading orders to execute on one more electronic trading exchanges; and
means for creating an electronic bar code including the information for the one or more trading orders from the another selection input to automatically execute the one or more trading orders on one or more electronic trading exchanges when the bar code is received on the on the smart network device application on the smart network device.
